(19) United States
(12) Patent Application Publication
(10) Pub. No.: US 2016/0178816 A1
(43) Pub. Date: Jun. 23, 2016

(54) NEAR-INFRARED-ABSORBING COMPOSITION, NEAR-INFRARED CUT FILTER OBTAINED USING SAME, PROCESS FOR PRODUCING SAID CUT FILTER, CAMERA MODULE AND PROCESS FOR PRODUCING SAME, AND SOLID PHOTOGRAPHING ELEMENT

(71) Applicant: FUJIFILM Corporation, Tokyo (JP)

(72) Inventors: Hidenori TAKAHASHI, Haibara-gun (JP); Takashi KAWASHIMA, Haibara-gun (JP); Takeshi INASAKI, Haibara-gun (JP); Seiichi HITOMI, Haibara-gun (JP)

(73) Assignee: FUJIFILM Corporation, Tokyo (JP)

(21) Appl. No.: 15/003,208

(22) Filed: Jan. 21, 2016

Related U.S. Application Data
(63) Continuation of application No. PCT/JP2014/069481, filed on Jul. 23, 2014.

(30) Foreign Application Priority Data
Jul. 24, 2013 (JP) 2013-153984

(51) Int. Cl. G02B 5/20; G03B 11/00; G02B 5/22

(52) U.S. Cl. CPC G02B 5/208; G02B 5/223; G03B 11/00

(57) ABSTRACT

Provided are a near-infrared-absorbing composition capable of forming a cured film having excellent heat resistance while maintaining high near-infrared-shielding properties, a near-infrared cut filter obtained using the same, a process for producing said cut filter, a camera module and a process for producing the same, and a solid photographing element.

The near-infrared-absorbing composition includes a near-infrared-absorbing compound (A1) obtained from a reaction between a low-molecular-weight compound which has two or more coordination sites to a metal component or a coordination site to a metal component and a cross-linking group and has a molecular weight of 1800 or lower or a salt thereof and the metal component and a near-infrared-absorbing compound (B) obtained from a reaction between a high-molecular-weight compound having a repeating unit represented by Formula (II) below or a salt thereof and a metal component.

In Formula (II), R² represents an organic group, Y¹ represents a single bond or a divalent linking group, and X² represents the coordination site to the metal component.

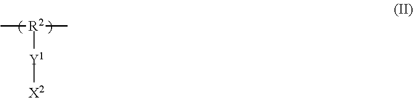

This application is a Continuation of PCT International Application No. PCT/JP2014/069481 filed on Jul. 23, 2014, which claims priority under 35 U.S.C §119(a) to Japanese Patent Application No. 2013-153984 filed on Jul. 24, 2013. Each of the above application(s) is hereby expressly incorporated by reference, in its entirety, into the present application.

### BACKGROUND OF THE INVENTION

1. Field of the Invention

The present invention relates to a near-infrared-absorbing composition, a near-infrared cut filter obtained using the same, a process for producing said cut filter, a camera module and a process for producing the same, and a solid photographing element.

2. Description of the Related Art

A CCD or CMOS imaging sensor that is a solid photographing element for color images has been used for video cameras, digital still cameras, mobile phones equipped with a camera function, and the like. In the solid photographing element, since a silicon photodiode having sensitivity to near-infrared rays is used in the light receiving section, it is necessary to correct the luminosity factor, and a near-infrared cut filter (hereinafter, also referred to as IR cut filter) is frequently used.

As a material for forming the near-infrared cut filter, JP2010-134457A discloses an infrared-shielding film including an infrared shielding resin formed by adding a metallic compound to a copolymer of a reactant between (meth)acrylamide and phosphoric acid or a hydrolysate thereof and a compound having an ethylenic unsaturated bond.

### SUMMARY OF THE INVENTION

Here, as a result of studying the infrared-shielding resin disclosed by JP2010-134457A, it has been found that near-infrared-shielding properties are insufficient, and heat resistance is also insufficient.

The present invention intends to solve such problems, and an object of the present invention is to provide a cured film having excellent heat resistance while maintaining high near-infrared-shielding properties.

The present inventors found that the above-described problems can be solved by formulating a near-infrared-absorbing compound (A1) and a near-infrared-absorbing compound (B) which will be described below and/or a near-infrared-absorbing compound (A2) described below into a near-infrared-absorbing composition.

Specifically, the problems have been solved using the following means <1>, preferably, means <2> to <18>.

<1> A near-infrared-absorbing composition including a near-infrared-absorbing compound (A1) obtained from a reaction between a low-molecular-weight compound which has two or more coordination sites to a metal component or a coordination site to a metal component and a cross-linking group and has a molecular weight of 1800 or lower or a salt thereof and the metal component; and

a near-infrared-absorbing compound (B) obtained from a reaction between a high-molecular-weight compound having a repeating unit represented by Formula (II) below or a salt thereof and a metal component:

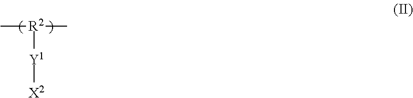

in Formula (II), R² represents an organic group, Y¹ represents a single bond or a divalent linking group, and X² represents the coordination site to the metal component.

<2> A near-infrared-absorbing composition including a near-infrared-absorbing compound obtained from a reaction between a low-molecular-weight compound which has two or more coordination sites to a metal component or a coordination site to a metal component and a cross-linking group and has a molecular weight of 1800 or lower or a salt thereof, a high-molecular-weight compound having a repeating unit represented by Formula (II) below or a salt thereof, and a metal component:

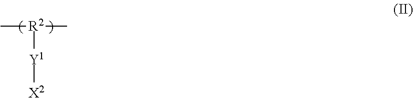

in Formula (II), R² represents an organic group, Y¹ represents a single bond or a divalent linking group, and X² represents the coordination site to the metal component.

<3> The near-infrared-absorbing composition according to <1> or <2>, in which the low-molecular-weight compound is a compound represented by Formula (I) below:

R¹(—X¹)ₙ₁ (I)

in Formula (I), R¹ represents an n1-valent group, X¹ represents the coordination site to the metal component, and n1 represents an integer from 2 to 6.

<4> The near-infrared-absorbing composition according to <1> or <2>, in which the low-molecular-weight compound is a compound represented by Formula (a1-i) below:

R¹⁰⁰-L¹⁰⁰-(X¹⁰⁰)ₙ (a1-i)

in Formula (a1-i), X¹⁰⁰ represents the coordination site to the metal component, n represents an integer from 1 to 6, L¹⁰⁰ represents a single bond or a linking group, and R¹⁰⁰ represents a cross-linking group.

<5> The near-infrared-absorbing composition according to any one of <1> to <4>, in which a weight-average molecular weight of the high-molecular-weight compound having the repeating unit represented by Formula (II) or a salt thereof is in a range of 2,000 to 2,000,000.

<6> A near-infrared-absorbing composition including a near-infrared-absorbing compound (A2) obtained from a reaction between a low-molecular-weight compound having a molecular weight of 1800 or lower which is represented by Formula (III) below or a salt thereof and a metal component:

R³(—X¹)ₙ₂ (III)

in Formula (III), R³ represents an n2-valent group, X¹ represents a coordination site to the metal component, and n2 represents an integer from 3 to 6.

<7> The near-infrared-absorbing composition according to any one of <1> to <6>, in which the metal component is a copper component.

<8> The near-infrared-absorbing composition according to any one of <1> to <7>, in which the coordination site to the metal component is an acid group.

<9> The near-infrared-absorbing composition according to any one of <1> to <5>, including a near-infrared-absorbing compound (C) having a partial structure represented by Formula (IV) below:

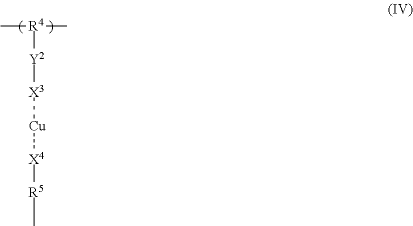

in Formula (IV), R⁴ represents an organic group, R⁵ represents a divalent group, Y² represents a single bond or a divalent linking group, each of X³ and X⁴ independently represents a site at which a coordinate bond is formed with copper, and Cu represents a copper ion.

<10> The near-infrared-absorbing composition according to <9>, in which the site at which a coordinate bond is formed with copper is an acid group ion site derived from an acid group.

<11> The near-infrared-absorbing composition according to any one of <1> to <10>, in which a content of copper in the near-infrared-absorbing composition is in a range of 2% by mass to 50% by mass of a total amount of solid contents in the near-infrared-absorbing composition.

<12> The near-infrared-absorbing composition according to any one of <1> to <11>, further including an organic solvent.

<13> A near-infrared cut filter obtained using the near-infrared-absorbing composition according to any one of <1> to <12>.

<14> The near-infrared cut filter according to <13>, in which a percentage of a change in absorbance at a wavelength of 400 nm and a percentage of a change in absorbance at a wavelength of 800 nm before and after heating of the near-infrared cut filter at 200° C. for five minutes are both 7% or lower.

<15> A process for producing a near-infrared cut filter including a step of forming a near-infrared cut filter by applying the near-infrared-absorbing composition according to any one of <1> to <12> to a light-receiving side of a solid photographing element.

<16> A solid photographing element including a near-infrared cut filter obtained using the near-infrared-absorbing composition according to any one of <1> to <12>.

<17> A camera module including a solid photographing element; and a near-infrared cut filter disposed on a light-receiving side of the solid photographing element, in which the near-infrared cut filter according to <14> is used.

<18> A process for producing a camera module including a solid photographing element; and a near-infrared cut filter disposed on a light-receiving side of the solid photographing element, including a step of forming a near-infrared cut filter by applying the near-infrared-absorbing composition according to any one of <1> to <12> to the light-receiving side of the solid photographing element.

According to the present invention, it has become possible to provide a cured film having excellent heat resistance while maintaining high near-infrared-shielding properties.

### BRIEF DESCRIPTION OF THE DRAWINGS

FIG. 1 is an imaginary view illustrating an example of a near-infrared-absorbing compound in the present invention.

FIG. 2 is an imaginary view illustrating another example of the near-infrared-absorbing compound in the present invention.

FIG. 3 is a schematic sectional view illustrating a constitution of a camera module including a solid photographing element according to an embodiment of the present invention.

FIG. 4 is a schematic sectional view of the solid photographing element according to the embodiment of the present invention.

FIG. 5 is a schematic sectional view illustrating an example of a periphery of a near-infrared cut filter in the camera module.

FIG. 6 is a schematic sectional view illustrating an example of the periphery of the near-infrared cut filter in the camera module.

FIG. 7 is a schematic sectional view illustrating an example of the periphery of the near-infrared cut filter in the camera module.

FIG. 8 is an imaginary view illustrating an example of the near-infrared-absorbing compound.

FIG. 9 is an imaginary view illustrating an example of the near-infrared-absorbing compound.

### DESCRIPTION OF THE PREFERRED EMBODIMENTS

Hereinafter, the contents of the present invention will be described in detail.

In the present specification, “to” used to express numerical ranges will be used with a meaning that numerical values before and after the “to” are included in the numerical ranges as the lower limit value and the upper limit value.

In the present specification, “(meth)acrylates” represent acrylates and methacrylates, “(meth)acrylic” represents acrylic and methacrylic, and “(meth)acryloyl” represents acryloyl and methacryloyl.

In the present specification, “monomers” and “monomers” refer to the same thing. In addition, “polymers” and “polymers” refer to the same thing.

In the present specification, regarding the denoting of a group (atomic group), a group not denoted with ‘substituted’ or ‘unsubstituted’ refers to both a group (atomic group) having no substituents and a group (atomic group) having a substituent.

A near-infrared ray in the present invention refers to a ray having a maximum absorption wavelength in a range of 700 nm to 2500 nm and particularly in a range of 700 nm to 1000 nm.

A near-infrared-absorbing property in the present invention refers to a property of having the maximum absorption wavelength in the near-infrared range.

The main chain of a polymer in the present invention refers to an atom or an atomic group required to form a skeleton (long chain) of the polymer, and, in a case in which part or all of the skeleton is a cyclic group (for example, an aryl group), the cyclic group is also a part of the main chain. In addition, an atom directly bonded to this main chain is also considered as a part of the main chain The side chain of the polymer in the present invention refers to a portion other than the main chain. Here, a functional group directly bonded to the main chain (for example, an acid group described below or a salt thereof) is also considered as the side chain.

Near-Infrared-Absorbing Composition

A near-infrared-absorbing composition of the present invention includes at least one of a near-infrared-absorbing compound (A1: low-molecular-weight type) obtained from a reaction between a low-molecular-weight compound which has two or more coordination sites to a metal component or a coordination site to a metal component and a cross-linking group and has a molecular weight of 1800 or lower or a salt thereof and the metal component, a near-infrared-absorbing compound (B: high-molecular-weight type) obtained from a reaction between a high-molecular-weight compound having a repeating unit represented by Formula (II) below or a salt thereof (hereinafter, also referred to as a compound represented by Formula (II)) and a metal component, and a near-infrared-absorbing compound (A2: low-molecular-weight type) obtained from a reaction between a metal component and a low-molecular-weight compound having a molecular weight of 1800 or lower which is represented by Formula (III) below or a salt thereof.

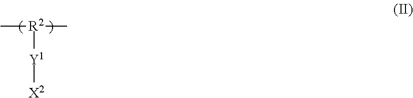

In Formula (II), R² represents an organic group, Y¹ represents a single bond or a divalent linking group, and X² represents a coordination site to the metal component.

The near-infrared-absorbing composition of the present invention may include a near-infrared-absorbing compound obtained from a reaction between a metal component, the low-molecular-weight compound or a salt thereof, and a high-molecular-weight compound having a repeating unit represented by Formula (II) below or a salt thereof.

R³(—X¹)ₙ₂ (III)

In Formula (III), R³ represents an n2-valent group, X¹ represents a coordination site to the metal component, and n2 represents an integer from 3 to 6.

<Near-infrared-absorbing composition including near-infrared-absorbing compound (A1: low-molecular-weight type) and near-infrared-absorbing compound (B: high-molecular-weight type)>

The composition of the present invention preferably includes at least the near-infrared-absorbing compound (A1) and the near-infrared-absorbing compound (B).

When the near-infrared-absorbing composition of the present invention includes at least one of the near-infrared-absorbing compound (A1) and the near-infrared-absorbing compound (B) and the near-infrared-absorbing compound (A2), it is possible to form a cured film having excellent heat resistance while maintaining high near-infrared-shielding properties. While being an assumption, the reason therefor is considered as follows.

In a case in which the near-infrared-absorbing composition of the present invention includes at least the near-infrared-absorbing compound (A1) and the near-infrared-absorbing compound (B), in the composition, the coordination site (for example, one or more sites selected from a coordination site to be coordinated with an anion (specifically an acid group or a salt thereof and more specifically an acid group ion site derived from an acid group) and a coordination site to be coordinated with an unshared electron pair) to the metal component in the compound represented by Formula (II) and a metal ion in the metal component (preferably a copper ion) are bonded to each other (for example, a coordinate bond). Furthermore, the metal ion bonded to the compound represented by Formula (II) is bonded to the coordination site (for example, an acid group ion site derived from an acid group) of the low-molecular-weight compound used in the near-infrared-absorbing compound (A1). When a plurality of the above-described bonds are generated, a structure in which the low-molecular-weight compound used in the near-infrared-absorbing compound (A1) crosslinks side chains of the compound represented by Formula (II) through the metal ion is formed. Consequently, it is possible to further increase the content of the metal ion in the composition and to achieve high near-infrared-shielding properties. In addition, when the near-infrared-absorbing compound (B) is formulated into the near-infrared-absorbing composition of the present invention, it is possible to form a cured film in which the cross-linking structure does not easily collapse even after being heated and, consequently, the heat resistance is excellent.

In addition, when the near-infrared-absorbing compound (A1) and the near-infrared-absorbing compound (B) are formulated into the near-infrared-absorbing composition of the present invention, it is possible to more easily adjust film properties to be desired, and thus, for example, it becomes possible to suppress cracking during formation of a film.

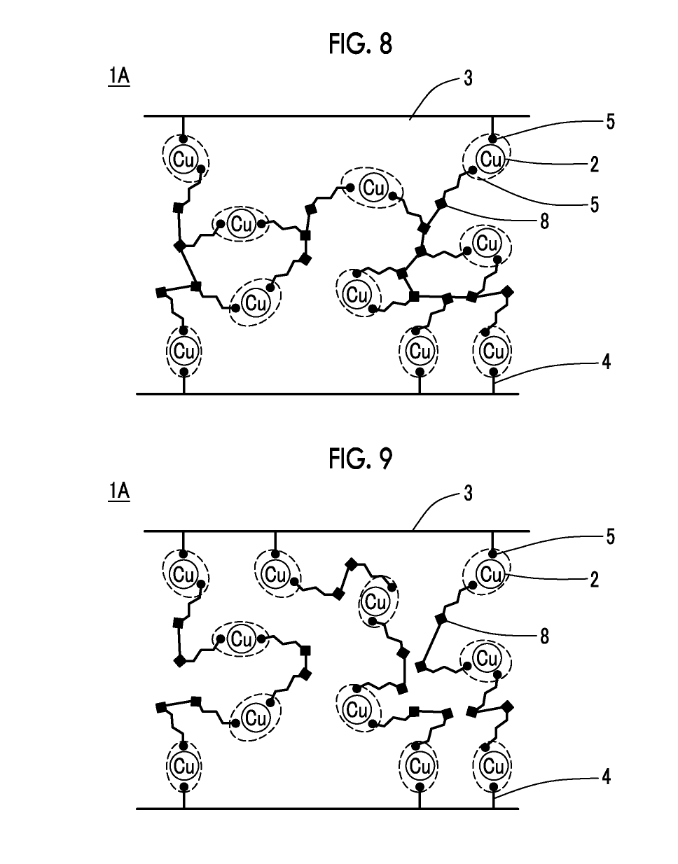

FIGS. 8 and 9 are imaginary views illustrating examples of a near-infrared-absorbing composition 1A including the near-infrared-absorbing compound (A1) and the near-infrared-absorbing compound (B). Reference sign “2” represents a copper ion, Reference sign “3” represents a main chain in the compound represented by Formula (II), Reference sign “4” represents a side chain in the compound represented by Formula (II), Reference sign “5” represents a site coordinated to copper, and Reference sign “8” represents a site at which the cross-linking groups in the low-molecular-weight compound are crosslinked with each other.

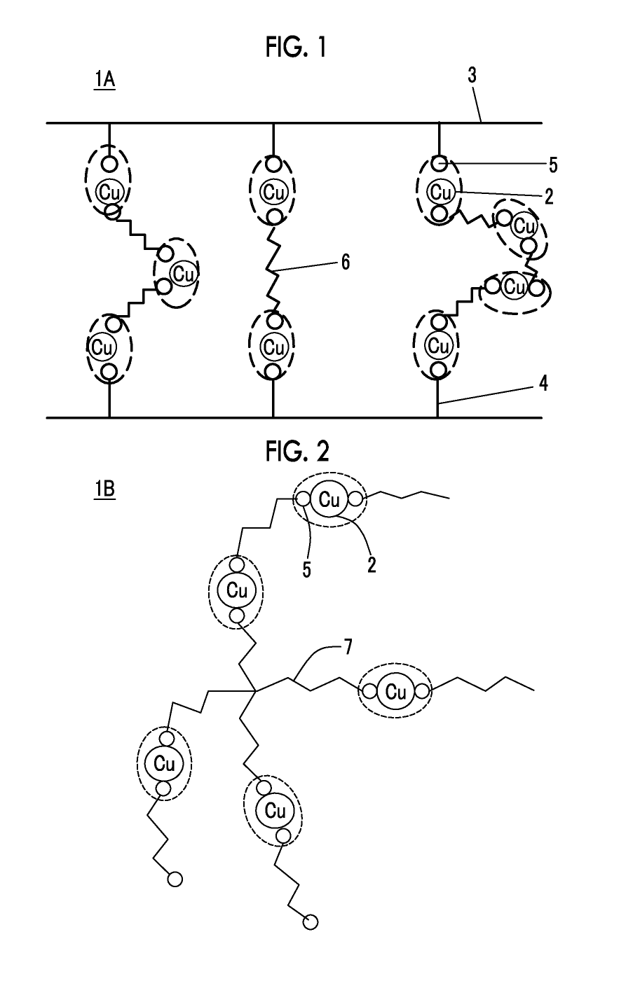

FIG. 1 is an imaginary view illustrating an example of the near-infrared-absorbing composition lA including the near-infrared-absorbing compound (A1) and the near-infrared-absorbing compound (B). Reference sign “2” represents a copper ion, Reference sign “3” represents a main chain in the compound represented by Formula (II), Reference sign “4” represents a side chain in the compound represented by Formula (II), Reference sign “5” represents a site coordinated to copper (for example, an acid group ion site derived from an acid group), and Reference sign “6” represents an n1-valent group in a compound represented by Formula (I) below. As described above, a structure in which the low-molecular-weight compound crosslinks the side chains of the compound represented by Formula (II) through the copper ion 2 is formed.

The ratio (mass ratio) between the near-infrared-absorbing compound (A1) and the near-infrared-absorbing compound (B) formulated into the composition of the present invention is preferably in a range of 3:97 to 70:30 and more preferably in a range of 5:95 to 50:50.

In addition, in a case in which the near-infrared-absorbing composition of the present invention includes at least the near-infrared-absorbing compound (A2), in the composition, the coordination site (for example, an acid group ion site derived from an acid group) to the metal component in the compound represented by Formula (III) is bonded to a metal ion in the metal component (preferably a copper ion) (for example, a coordinate bond). Furthermore, the metal ion bonded to the compound represented by Formula (III) is further bonded to the coordination site to a metal component in another compound represented by Formula (III) (for example, an acid group ion site derived from an acid group). When a plurality of the above-described bonds are generated, a structure in which the compounds represented by Formula (III) are crosslinked with each other through the metal ion is formed. Consequently, it is possible to further increase the content of the metal ion in the composition and to maintain high near-infrared-shielding properties. In addition, the formed cross-linking structure does not easily collapse even after being heated and, consequently, it is possible to form a cured film having excellent heat resistance.

FIG. 2 is an imaginary view illustrating an example of a near-infrared-absorbing composition 1B including at least the near-infrared-absorbing compound (A2). Reference sign “2” represents a copper ion, Reference sign “5” represents a site coordinated to copper (for example, an acid group ion site derived from an acid group), and Reference sign “7” represents an n1-valent group in the compound represented by Formula (III). As described above, a structure in which the compounds represented by Formula (III) are crosslinked with each other through the copper ion 2 is formed.

The content of copper in the near-infrared-absorbing composition of the present invention is preferably 2% by mass or higher and more preferably 5% by mass or higher of the total amount of solid contents in the composition. In addition, the content thereof is preferably 50% by mass or lower and more preferably 45% by mass or lower. Particularly, the content thereof is preferably in a range of 2% by mass to 50% by mass and more preferably in a range of 5% by mass to 45% by mass.

<<Near-Infrared-Absorbing Compound (A1: Low-Molecular-Weight Type)>>

The near-infrared-absorbing compound (A1: low-molecular-weight type) is obtained from a reaction between a metal component and a low-molecular-weight compound which has a coordination site to a metal component and a cross-linking group and has a molecular weight of 1800 or lower or a salt thereof or a low-molecular-weight compound which has two or more coordination sites to a metal component and has a molecular weight of 1800 or lower or a salt thereof.

<<<Metal Component>>>

The metal component is not particularly limited as long as the metal component reacts with the low-molecular-weight compound so as to be capable of Ruining a compound exhibiting near-infrared-absorbing properties, and a compound including a divalent metal is more preferred.

The metal component is preferably cobalt, iron, nickel, or a copper component and more preferably a copper component. As the copper component used in the present invention, copper or a compound including copper can be used. As the compound including copper, a copper oxide or a copper salt can be used. The copper salt is preferably monovalent or divalent copper and more preferably divalent copper. Examples of the copper salt include copper carboxylate (for example, copper acetate, copper ethylacetoacetate, copper formate, copper benzoate, copper stearate, copper naphthenate, copper citrate, copper 2-ethylhexanoate, and the like), copper sulfonate (for example, copper methanesulfonate and the like), copper phosphate, copper phosphoric acid ester, copper phosphonate, copper phosphonic acid ester, copper phosphinate, copper amide, copper sulfonamide, copper imide, copper acyl sulfonimide, copper bissulfonimide, copper methide, alkoxycopper, phenoxycopper, copper hydroxide, copper carbonate, copper sulfate, copper nitrate, copper perchlorate, copper chloride, copper bromide, copper (meth)acrylate, copper chlorate, copper pyrophosphate, and the like. Particularly, copper hydroxide, copper acetate, copper chloride, copper formate, copper stearate, copper benzoate, copper ethylacetoacetate, copper pyrophosphate, copper naphthenate, copper citrate, copper nitrate, copper sulfate, copper carbonate, copper chlorate, copper (meth)acrylate, and copper perchlorate are preferred, copper hydroxide, copper acetate, copper chloride, copper sulfate, copper benzoate, and copper (meth)acrylate are more preferred, and copper hydroxide, copper acetate, and copper sulfate are particularly preferred.

The content of metal in the metal component is preferably in a range of 2% by mass to 90% by mass and more preferably in a range of 10% by mass to 70% by mass. Only one metal component may be used or two or more metal components may be used. Particularly, since an increase in the content of copper as the metal component improves near-infrared-shielding properties, the content of copper in terms of an element is preferably 10% by mass or higher, more preferably 20% by mass or higher, and still more preferably 30% by mass or higher of all solid contents in the near-infrared-absorbing composition. The upper limit of the content of copper is preferably 70% by mass or lower and more preferably 60% by mass or lower.

The amount of the copper component that is reacted with the low-molecular-weight compound is preferably in a range of 0.01 equivalents to 1 equivalent, more preferably in a range of 0.1 equivalents to 0.8 equivalents, and still more preferably in a range of 0.2 equivalents to 0.6 equivalents with respect to 1 equivalent of the coordination site (for example, an acid group) in the compound. When the amount of copper in the copper component is set in the above-described range, there is a tendency that a cured film having more favorable near-infrared-shielding properties is obtained.

<<Low-Molecular-Weight Compound having Coordination Site to Metal Component and Cross-Linking Group and having Molecular Weight of 1800 or Lower (hereinafter, also Referred to as a Low-Molecular-Weight Compound (a1))>>

Examples of the coordination site to the metal component in the low-molecular-weight compound (a1) include coordination sites (for example, a coordination site to be coordinated with an anion (specifically an acid group or a salt thereof) and a coordination site to be coordinated with an unshared electron pair). The low-molecular-weight compound (a1) may have one or more coordination sites.

Any anion may be used as the anion as long as the anion includes an anion that can be coordinated to the metal component, and, for example, the anion preferably includes an oxygen anion, a nitrogen anion, or a sulfur anion.

The coordination site to be coordinated with an anion is preferably, for example, at least one site selected from Group (AN) below.

Group (AN)

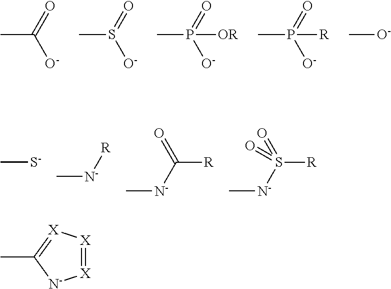

In Group (AN), X represents N or CR, and each of R's independently represents a hydrogen atom, an alkyl group, an alkenyl group, an alkynyl group, an aryl group, or a heteroaryl group.

The alkyl group represented by R may have a linear shape, a branched shape, or a cyclic shape, and preferably has a linear shape. The number of carbon atoms in the alkyl group is preferably in a range of 1 to 10, more preferably in a range of 1 to 6, and still more preferably in a range of 1 to 4. Examples of the alkyl group include a methyl group. The alkyl group may have a substituent, and examples of the substituent include a halogen atom, a carboxylic acid group, and a heterocyclic group. The heterocyclic group as the substituent may be a monocyclic ring or a polycyclic ring and may be an aromatic group or a non-aromatic group. The number of hetero atoms constituting a heterocycle is preferably in a range of 1 to 3 and preferably 1 or 2. The hetero atom constituting the heterocycle is preferably a nitrogen atom. In a case in which the alkyl group has a substituent, the alkyl group may include another substituent.

The number of carbon atoms in the alkynyl group represented by R is preferably in a range of 1 to 10 and more preferably in a range of 1 to 6.

The aryl group represented by R may be a monocyclic ring or a polycyclic ring and is preferably a monocyclic ring. The number of carbon atoms in the aryl group is preferably in a range of 6 to 18, more preferably in a range of 6 to 12, and still more preferably 6.

The heteroaryl group represented by R may be a monocyclic ring or a polycyclic ring. The number of hetero atoms constituting the heteroaryl group is preferably in a range of 1 to 3. The hetero atom constituting the heteroaryl group is preferably a nitrogen atom, an oxygen atom, or a sulfur atom. The number of carbon atoms in the heteroaryl group is preferably in a range of 6 to 18 and more preferably in a range of 6 to 12.

Examples of the coordination site to be coordinated with an anion also include a monoanionic coordination site. The monoanionic coordination site represents a site to be coordinated to a metal atom through a functional group having one negative charge. Examples thereof include an acid group having an acid dissociation constant (pKa) of 12 or lower, and specific examples thereof include an acid group having a phosphorus atom (a phosphate diester group, a phosphonate monoester group, or a phosphinic acid group), a sulfonic acid group, a carboxylic acid group, an imidic acid group, and the like. The monoanionic coordination site preferably includes at least one of a sulfonic acid group, a carboxylic acid group, an acid group having a phosphorus atom, and an imidic acid group and more preferably includes at least one of a sulfonic acid group, a carboxylic acid group, and an imidic acid group.

The coordination site to be coordinated with an unshared electron pair preferably includes, as a coordinating atom, an oxygen atom, a nitrogen atom, a sulfur atom, or a phosphorus atom, more preferably includes an oxygen atom, a nitrogen atom, or a sulfur atom, and still more preferably includes a nitrogen atom. In addition, an aspect in which a coordinating atom to be coordinated with an unshared electron pair is a nitrogen atom and an atom adjacent to the nitrogen atom is a carbon atom is preferred, and the carbon atom preferably has a substituent. When the above-described constitution is provided, the structure of a copper complex becomes more easily distorted, and thus it is possible to further improve color valency. The substituent is preferably an alkyl group having 1 to 10 carbon atoms, an aryl group having 6 to 12 carbon atoms, a carboxylic acid group, an alkoxy group having 1 to 12 carbon atoms, an acyl group having 2 to 12 carbon atoms, an alkylthio group having 1 to 12 carbon atoms, or a halogen atom.

The coordinating atom to be coordinated with an unshared electron pair may be included in a ring or may be included in at least one partial structure selected from Group (UE) below.

Group (UE)

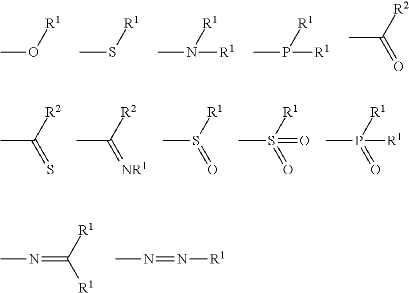

In Group (UE), each of R^{h}s independently represents a hydrogen atom, an alkyl group, an alkenyl group, an alkynyl group, an aryl group, or a heteroaryl group, and each of R²'s independently represents a hydrogen atom, an alkyl group, an alkenyl group, an alkynyl group, an aryl group, a heteroaryl group, an alkoxy group, an aryloxy group, a heteroaryloxy group, an alkylthio group, an arylthio group, a heteroarylthio group, an amino group, and an acyl group.

The alkyl group represented by R¹ is identical to the alkyl group described in the section of R in Group (AN), and the preferred range thereof is also identical.

The number of carbon atoms in the alkenyl group represented by R¹ is preferably in a range of 1 to 10 and more preferably in a range of 1 to 6.

The number of carbon atoms in the alkynyl group represented by R¹ is preferably in a range of 1 to 10 and more preferably in a range of 1 to 6.

The heteroaryl group represented by R¹ is identical to the heteroaryl group described in the section of R in Group (AN), and the preferred range thereof is also identical.

The alkyl group represented by R² is identical to the alkyl group described in the section of R¹ in Group (UE), and the preferred range thereof is also identical.

The number of carbon atoms in the alkenyl group represented by R² is preferably in a range of 1 to 10 and more preferably in a range of 1 to 6.

The number of carbon atoms in the alkynyl group represented by R² is preferably in a range of 1 to 10 and more preferably in a range of 1 to 6.

The aryl group represented by R² is identical to the aryl group described in the section of R¹ in Group (UE), and the preferred range thereof is also identical.

The heteroaryl group represented by R² is identical to the heteroaryl group described in the section of R¹ in Group (UE), and the preferred range thereof is also identical.

The number of carbon atoms in the alkoxy group represented by R² is preferably in a range of 1 to 12.

The number of carbon atoms in the aryloxy group represented by R² is preferably in a range of 6 to 18.

The heteroaryloxy group represented by R² may be a monocyclic ring or a polycyclic ring. A heteroaryl group constituting the heteroaryloxy group is identical to the heteroaryl group described in the section of R¹ in Group (UE), and the preferred range thereof is also identical.

The number of carbon atoms in the alkylthio group represented by R² is preferably in a range of 1 to 12.

The number of carbon atoms in the arylthio group represented by R² is preferably in a range of 6 to 18.

The heteroarylthio group represented by R² may be a monocyclic ring or a polycyclic ring. A heteroaryl group constituting the heteroarylthio group is identical to the heteroaryl group described in the section of and the preferred range thereof is also identical.

The number of carbon atoms in the acyl group represented by R² is preferably in a range of 2 to 12.

In a case in which the coordinating atom to be coordinated with an unshared electron pair is included in a ring, the ring including the coordinating atom may be a monocyclic ring or a polycyclic ring and may be aromatic or non-aromatic. The ring including the coordinating atom is preferably a 5- to 12-membered ring, more preferably a 5- to 7-membered ring, and still more preferably a 5- or 6-membered ring.

The ring including the coordinating atom to be coordinated with an unshared electron pair may have a substituent. Examples of the substituent include a linear, branched, or cyclic alkyl group having 1 to 10 carbon atoms, an aryl group having 6 to 12 carbon atoms, a halogen atom, a silicon atom, an alkoxy group having 1 to 12 carbon atoms, an acyl group having 1 to 12 carbon atoms, an alkylthio group having 1 to 12 carbon atoms, and a carboxylic acid group. The substituent may have another substituent. Examples of the substituent include a group formed of a ring including a coordinating atom to be coordinated with an unshared electron pair, a group having at least one partial structure selected from Group (UE) described above, an alkyl group having 1 to 12 carbon atoms, an acyl group having 1 to 12 carbon atoms, a hydroxy group, and the like.

The low-molecular-weight compound (a1) may include one or more cross-slinking groups. The cross-linking group is not particularly limited, but is preferably one or more groups selected from a (meth)acryloyloxy group, an epoxy group, an oxetanyl group, an isocyanate group, a hydroxyl group, an amino group, a carboxyl group, a thiol group, an alkoxysilyl group, a methylol group, a vinyl group, a (meth)acrylamide group, a sulfo group, a styryl group, and a maleimide group, and more preferably one or more groups selected from a (meth)acryloyloxy group and a vinyl group. The number of the cross-linking groups may be one or more.

The low-molecular-weight compound (a1) is preferably a compound represented by General Formula (a1-i) below.

R¹⁰⁰-L¹⁰⁰-(X¹⁰⁰)ₙ (a1-i)

In Formula (a1-i), X¹⁰⁰ represents a coordination site to the metal component, n represents an integer from 1 to 6, Coo represents a single bond or a linking group, and R¹⁰⁰ represents a cross-linking group.

In Formula (a1-i), X¹⁰⁰ is preferably one or more sites selected from a coordination site to be coordinated with an anion (for example, an acid group or a salt thereof) and a coordination site to be coordinated with an unshared electron pair.

In General Formula (a1-i), n represents an integer from 1 to 6, and is preferably an integer from 1 to 3 and more preferably an integer of 1 or 2.

In General Formula (a1-i), L¹⁰⁰ represents a single bond or a linking group. The linking group is preferably an organic group or a group formed of a combination of an organic group and —O—, —SO—, —SO₂—, —NR^{N1}—, —CO—, or —CS—. Examples of the organic group include a hydrocarbon group, an oxyalkylene group, and a heterocyclic group. In addition, the linking group may be a group having at least one coordination site selected from Group (AN-1) below, a ring having a coordinating atom coordinated with an unshared electron pair, or a group having at least one partial structure selected from Group (UE-1) below.

The hydrocarbon group is preferably an aliphatic hydrocarbon group or an aromatic hydrocarbon group. The hydrocarbon group may have a substituent, and examples of the substituent include an alkyl group, a halogen atom (preferably a fluorine atom), a polymerizable group (for example, a vinyl group, a (meth)acryloyl group, an epoxy group, an oxetane group, or the like), a sulfonic acid group, a carboxylic acid group, an acid group having a phosphorus atom, a carboxylic acid ester group (for example, —CO₂CH₃), a hydroxyl group, an alkoxy group (for example, a methoxy group), an amino group, a carbamoyl group, a carbamoyloxy group, a halogenated alkyl group (for example, a fluoroalkyl group or a chloroalkyl group), and a (meth)acryloyloxy group. In a case in which the hydrocarbon group has a substituent, the hydrocarbon group may have another substituent, and examples thereof include an alkyl group, the above-described polymerizable group, and a halogen atom.

In a case in which the hydrocarbon group is monovalent, an alkyl group, an alkenyl group, or an aryl group is preferred, and an aryl group is more preferred. In a case in which the hydrocarbon group is divalent, an alkylene group, an arylene group, or an oxyalkylene group is preferred, and an arylene group is more preferred. In a case in which the hydrocarbon group is trivalent, groups corresponding to the monovalent hydrocarbon group or the divalent hydrocarbon group are preferred.

The alkyl group and the alkylene group may have any of a linear shape, a branched shape, and a ring shape. The number of carbon atoms in the linear alkyl or alkylene group is preferably in a range of 1 to 20, more preferably in a range of 1 to 12, and still more preferably in a range of 1 to 8. The number of carbon atoms in the branched alkyl or alkylene group is preferably in a range of 3 to 20, more preferably in a range of 3 to 12, and still more preferably in a range of 3 to 8. The cyclic alkyl or alkylene group may be either a monocyclic ring or a polycyclic ring. The number of carbon atoms in the cyclic alkyl or alkylene group is preferably in a range of 3 to 20, more preferably in a range of 4 to 10, and still more preferably in a range of 6 to 10.

The number of carbon atoms in the alkenyl group and the alkenylene group is preferably in a range of 2 to 10, more preferably in a range of 2 to 8, and still more preferably in a range of 2 to 4.

The number of carbon atoms in the aryl group or the arylene group is preferably in a range of 6 to 18, more preferably in a range of 6 to 14, and still more preferably in a range of 6 to 10.

Examples of the heterocyclic group include a group having a hetero atom in an alicyclic group and an aromatic heterocyclic group. The heterocyclic group is preferably a 5-membered ring or a 6-membered ring. In addition, the heterocyclic group is a monocyclic ring or a fused ring, is preferably a monocyclic ring or a fused ring having 2 to 8 fused portions, and more preferably a monocyclic ring or a fused ring having 2 to 4 fused portions. The heterocyclic group may have a substituent, and the substituent is identical to the substituent that the above-described hydrocarbon group may have.

In —NR^{N1}—, R^{N1} represents a hydrogen atom, an alkyl group, an aryl group, or an aralkyl group. The alkyl group as R^{N1} may have any of a linear shape, a branched shape, and a ring shape. The number of carbon atoms in a linear or branched alkyl group is preferably in a range of 1 to 20 and more preferably in a range of 1 to 12. The cyclic alkyl group may be either a monocyclic ring or a polycyclic ring. The number of carbon atoms in the cyclic alkyl group is preferably in a range of 3 to 20 and more preferably in a range of 4 to 14.

The number of carbon atoms in the aryl group as R^{N1} is preferably in a range of 6 to 18 and more preferably in a range of 6 to 14. Specific examples thereof include a phenyl group and a naphthyl group. The aralkyl group as R^{N1} is preferably an aralkyl group having 7 to 20 carbon atoms and more preferably an unsubstituted aralkyl group having 7 to 15 carbon atoms.

Group (UE-1)

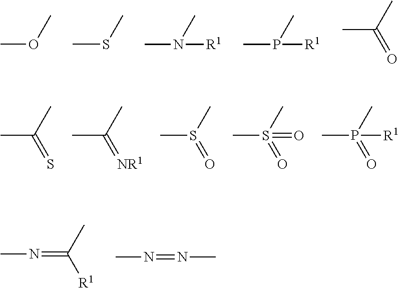

In Group (UE-1), R¹ is identical to R¹ in Group (UE).

Group (AN-1)

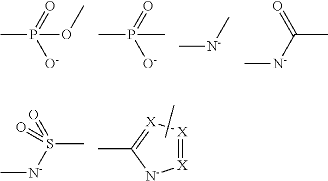

In Group (AN-1), X represents N or CR, and R is identical to R described in the section of CR in Group (AN) described above.

In General Formula (a1-i), R¹⁰⁰ represents a cross-linking group and is identical to the above-described cross-linking group, and the preferred range thereof is also identical.

Examples of the low-molecular-weight compound (a1) include the following compounds. In specific examples below, n represents an integer from 1 to 90.

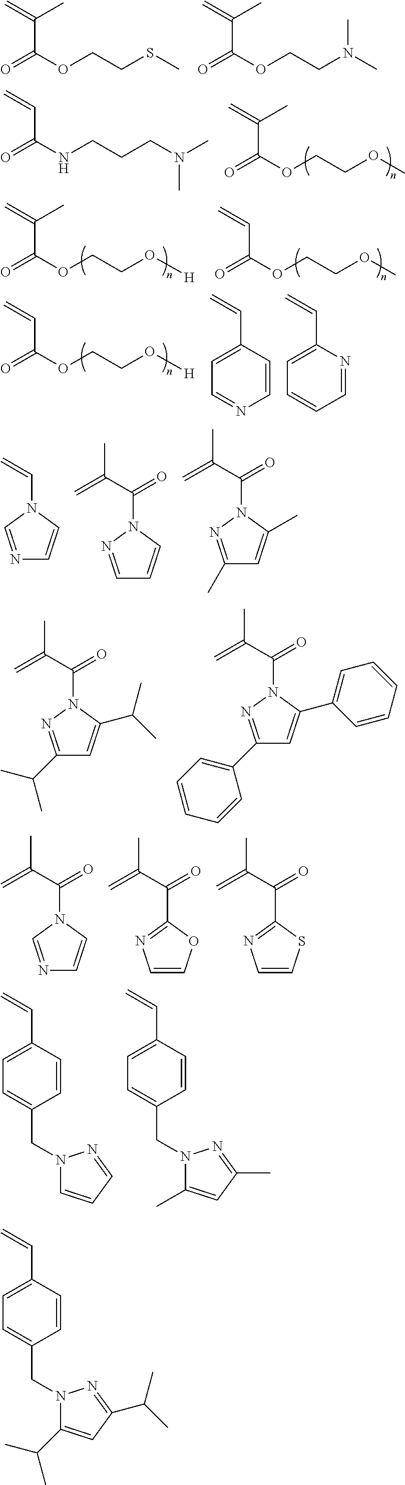

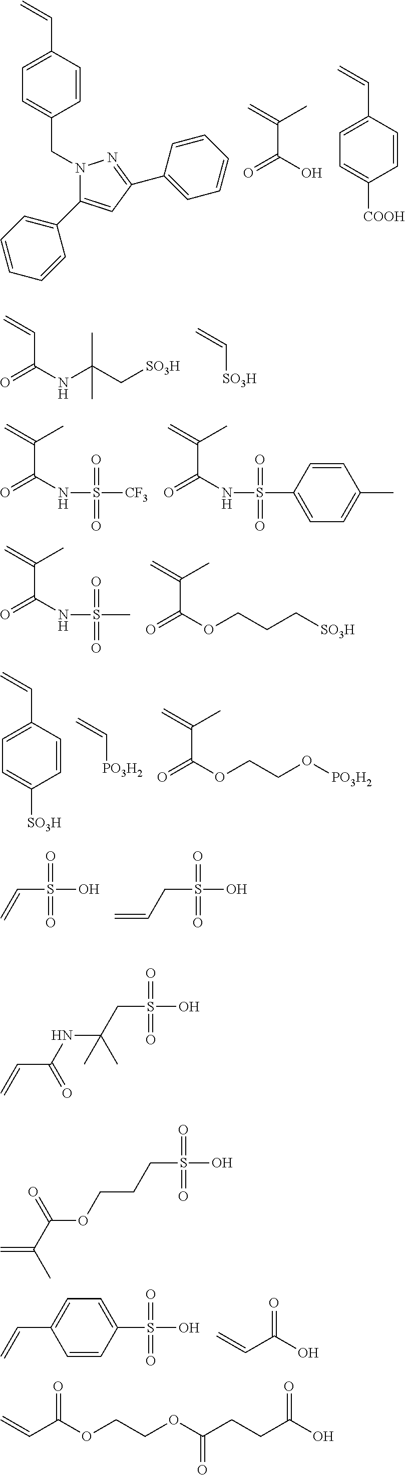

In the following Table, for example, a compound L-1 represents a compound represented by the following general formula, R represents a group including a cross-linking group shown in the vertical column, and Y represents a coordination site to be coordinated to a metal component shown in the horizontal row. In addition, * represents a bonding site.

TABLE 1

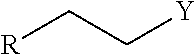

| | | Y | | | |
|---|---|---|---|---|---|
| | | 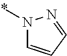 | 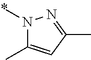 | 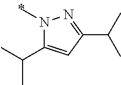 | 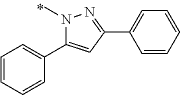 [SMILES: Cn1nc(-c2ccccc2)cc1-c1ccccc1] |
| R | 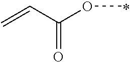 | L-1 | L-8 | L-15 | L-22 |
| | 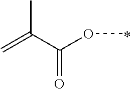 | L-2 | L-9 | L-16 | L-23 |
| | 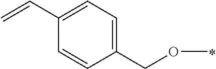 | L-3 | L-10 | L-17 | L-24 |
| | 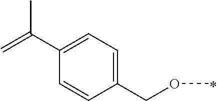 | L-4 | L-11 | L-18 | L-25 |
| | 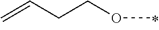 | L-5 | L-12 | L-19 | L-26 |
| | 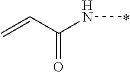 | L-6 | L-13 | L-20 | L-27 |
| | 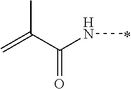 | L-7 | L-14 | L-21 | L-28 |

TABLE 2

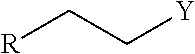

| | | Y | | |
|---|---|---|---|---|
| | | 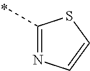 | 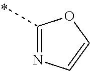 | 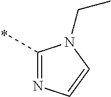 |
| R | 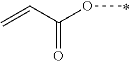 | L-29 | L-36 | L-43 |
| | 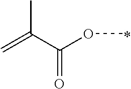 | L-30 | L-37 | L-44 |
| | 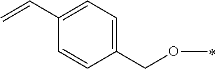 | L-31 | L-38 | L-45 |
| | 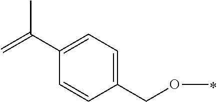 | L-32 | L-39 | L-46 |
| | 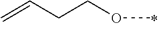 | L-33 | L-40 | L-47 |
| | 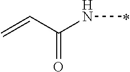 | L-34 | L-41 | L-48 |
| | 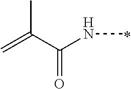 | L-35 | L-42 | L-49 |

TABLE 3

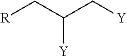

| | | Y | | | |
|---|---|---|---|---|---|
| | | 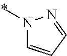 | 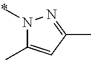 | 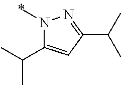 | 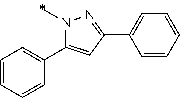 [SMILES: Cn1nc(-c2ccccc2)cc1-c1ccccc1] |
| R | 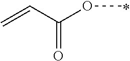 | L-50 | L-57 | L-64 | L-71 |
| | 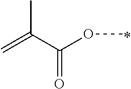 | L-51 | L-58 | L-65 | L-72 |
| | 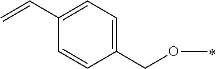 | L-52 | L-59 | L-66 | L-73 |
| | 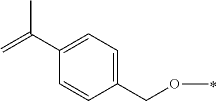 | L-53 | L-60 | L-67 | L-74 |
| | 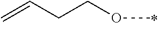 | L-54 | L-61 | L-68 | L-75 |
| | 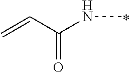 | L-55 | L-62 | L-69 | L-76 |
| | 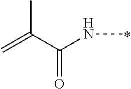 | L-56 | L-63 | L-70 | L-77 |

TABLE 4

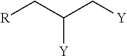

| | | Y | | |
|---|---|---|---|---|
| | | 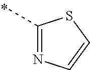 | 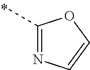 | 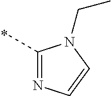 |
| R | 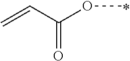 | L-78 | L-85 | L-92 |
| | 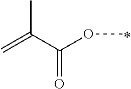 | L-79 | L-86 | L-93 |
| | 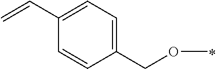 | L-80 | L-87 | L-94 |
| | 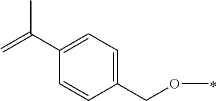 | L-81 | L-88 | L-95 |
| | 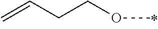 | L-82 | L-89 | L-96 |
| | 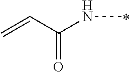 | L-83 | L-90 | L-97 |
| | 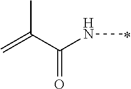 | L-84 | L-91 | L-98 |

TABLE 5

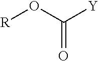

| | | Y | | | | |
|---|---|---|---|---|---|---|
| | | 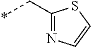 | 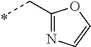 | 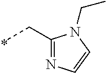 | 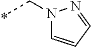 | 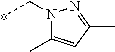 |
| R | 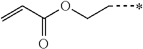 | L-99 | L-106 | L-113 | L-120 | L-127 |
| | 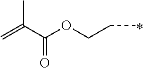 | L-100 | L-107 | L-114 | L-121 | L-128 |
| | 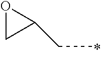 | L-101 | L-108 | L-115 | L-122 | L-129 |
| | 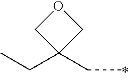 | L-102 | L-109 | L-116 | L-123 | L-130 |
| | 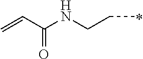 | L-103 | L-110 | L-117 | L-124 | L-131 |
| | 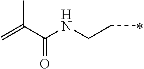 | L-104 | L-111 | L-118 | L-125 | L-132 |
| | 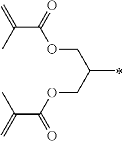 [SMILES: C=C(C)C(=O)OCC(C)COC(=O)C(=C)C] | L-105 | L-112 | L-119 | L-126 | L-133 |

TABLE 6

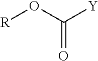

| | | Y | | | | |
|---|---|---|---|---|---|---|
| | | 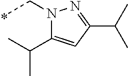 | 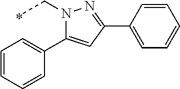 | 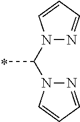 | 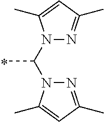 | 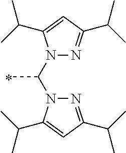 |
| R | 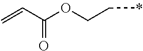 | L-134 | L-141 | L-148 | L-155 | L-162 |
| | 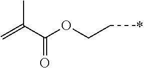 | L-135 | L-142 | L-149 | L-156 | L-163 |
| | 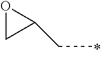 | L-136 | L-143 | L-150 | L-157 | L-164 |
| | 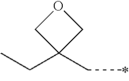 | L-137 | L-144 | L-151 | L-158 | L-165 |
| | 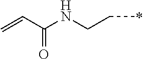 | L-138 | L-145 | L-152 | L-159 | L-166 |
| | 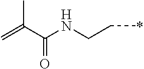 | L-139 | L-146 | L-153 | L-160 | L-167 |
| | 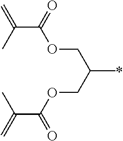 [SMILES: C=C(C)C(=O)OCC(C)COC(=O)C(=C)C] | L-140 | L-147 | L-154 | L-161 | L-168 |

TABLE 7

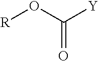

| | | Y | | |
|---|---|---|---|---|
| | | 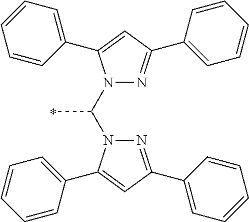 | 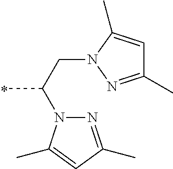 [SMILES: Cc1cc(C)n(C[C@@H](C)n2nc(C)cc2C)n1] | 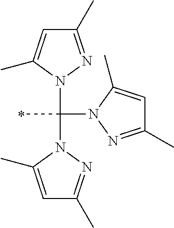 |
| R | 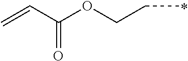 | L-169 | L-176 | L-183 |
| | 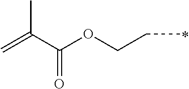 | L-170 | L-177 | L-184 |
| | 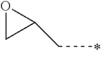 | L-171 | L-178 | L-185 |
| | 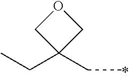 | L-172 | L-179 | L-186 |
| | 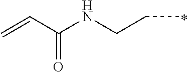 | L-173 | L-180 | L-187 |
| | 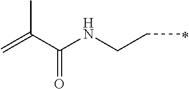 | L-174 | L-181 | L-188 |
| | 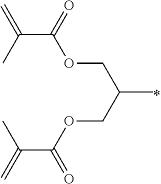 [SMILES: C=C(C)C(=O)OCC(C)COC(=O)C(=C)C] | L-175 | L-182 | L-189 |

TABLE 8

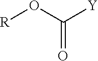

| | Y | | |
|---|---|---|---|
| R | 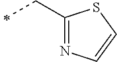 | 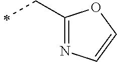 | 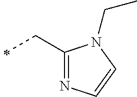 |
| 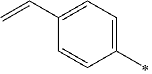 | L-190 | L-194 | L-198 |
| 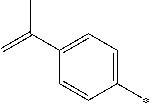 | L-191 | L-195 | L-199 |
| 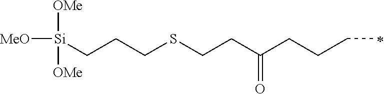 | L-192 | L-196 | L-200 |
| 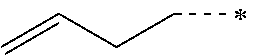 | L-193 | L-197 | L-201 |

| | Y | |
|---|---|---|
| R | 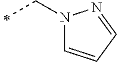 | 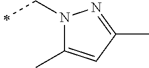 |
| 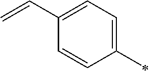 | L-202 | L-206 |
| 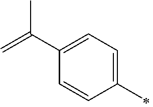 | L-203 | L-207 |
| 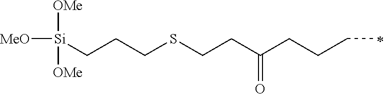 | L-204 | L-208 |
| 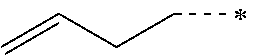 | L-205 | L-209 |

TABLE 9

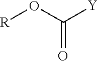

| | Y | |
|---|---|---|
| R | 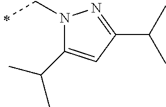 | 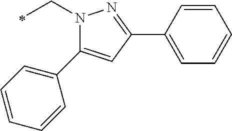 |
| 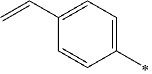 | L-210 | L-214 |
| 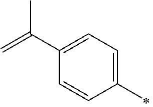 | L-211 | L-215 |
| 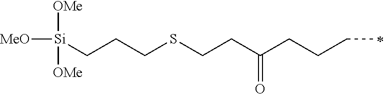 | L-212 | L-216 |
| 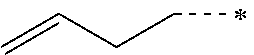 | L-213 | L-217 |

| R | 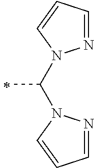 | 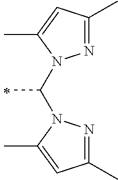 | 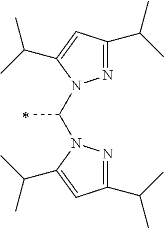 |
|---|---|---|---|
| 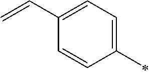 | L-218 | L-222 | L-226 |
| 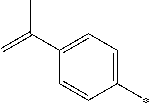 | L-219 | L-223 | L-227 |
| 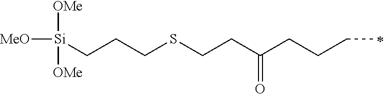 | L-220 | L-224 | L-228 |
| 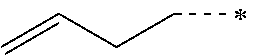 | L-221 | L-225 | L-229 |

TABLE 10

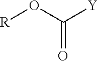

| | Y | | |
|---|---|---|---|
| R | 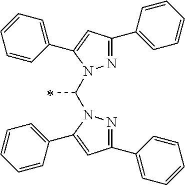 | 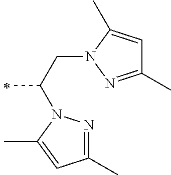 | 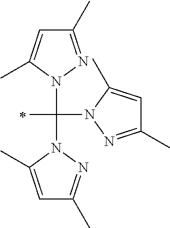 |
| 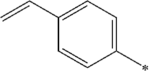 | L-230 | L-234 | L-238 |
| 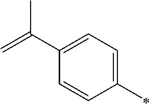 | L-231 | L-235 | L-239 |
| 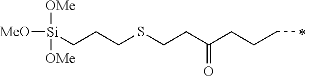 | L-232 | L-236 | L-240 |
| 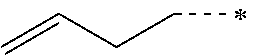 | L-233 | L-237 | L-241 |

TABLE 11

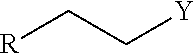

| | Y | | | |
|---|---|---|---|---|
| R | 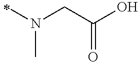 | 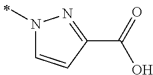 | 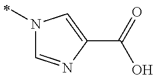 | 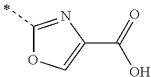 |
| 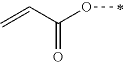 | L-242 | L-249 | L-256 | L-263 |
| 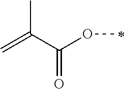 | L-243 | L-250 | L-257 | L-264 |
| 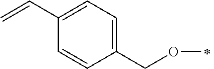 | L-244 | L-251 | L-258 | L-265 |
| 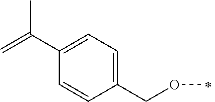 | L-245 | L-252 | L-259 | L-266 |
| 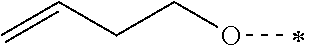 | L-246 | L-253 | L-260 | L-267 |
| 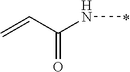 | L-247 | L-254 | L-261 | L-268 |
| 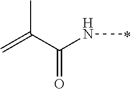 | L-248 | L-255 | L-262 | L-269 |

TABLE 12

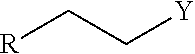

| | Y | | |
|---|---|---|---|
| R | 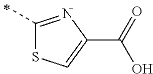 | 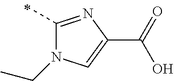 | 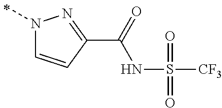 |
| 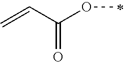 | L-270 | L-277 | L-284 |
| 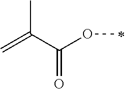 | L-271 | L-278 | L-285 |
| 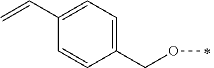 | L-272 | L-279 | L-286 |
| 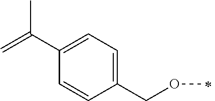 | L-273 | L-280 | L-287 |
| 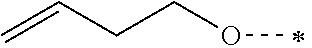 | L-274 | L-281 | L-288 |
| 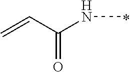 | L-275 | L-282 | L-289 |
| 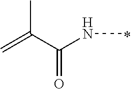 | L-276 | L-283 | L-290 |

TABLE 13

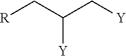

| | Y | | |
|---|---|---|---|
| R | 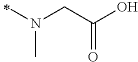 | 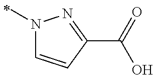 | 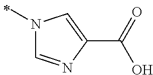 |
| 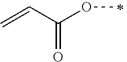 | L-291 | L-298 | L-305 |
| 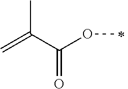 | L-292 | L-299 | L-306 |
| 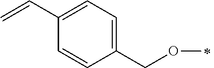 | L-293 | L-300 | L-307 |
| 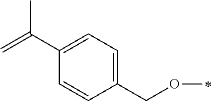 | L-294 | L-301 | L-308 |
| 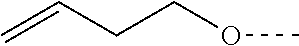 | L-295 | L-302 | L-309 |
| 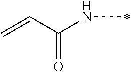 | L-296 | L-303 | L-310 |
| 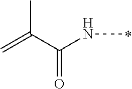 | L-297 | L-304 | L-311 |

| | Y | |
|---|---|---|
| R | 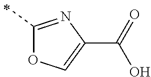 | 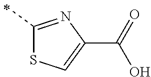 |
| 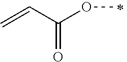 | L-312 | L-319 |
| 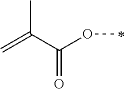 | L-313 | L-320 |
| 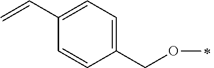 | L-314 | L-321 |
| 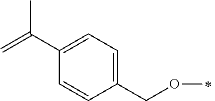 | L-315 | L-322 |
| 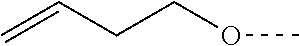 | L-316 | L-323 |
| 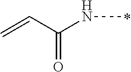 | L-317 | L-324 |
| 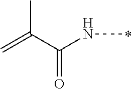 | L-318 | L-325 |

TABLE 14

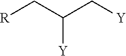

| | Y | |
|---|---|---|
| R | 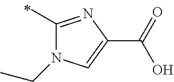 | 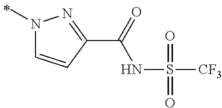 |
| 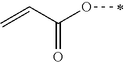 | L-326 | L-333 |
| 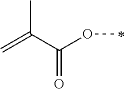 | L-327 | L-334 |
| 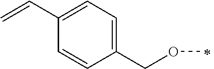 | L-328 | L-335 |
| 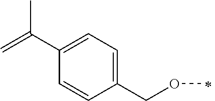 | L-329 | L-336 |
| 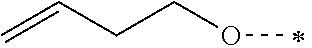 | L-330 | L-337 |
| 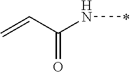 | L-331 | L-338 |
| 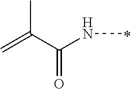 | L-332 | L-339 |

TABLE 15

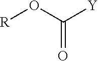

| | Y | | |
|---|---|---|---|
| R | 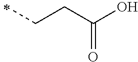 | 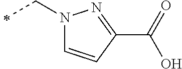 | 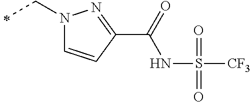 |
| 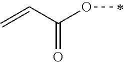 | L-340 | L-348 | L-356 |
| 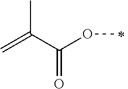 | L-341 | L-349 | L-357 |
| 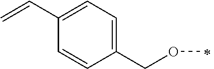 | L-342 | L-350 | L-358 |
| 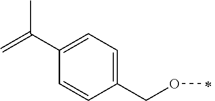 | L-343 | L-351 | L-359 |
| 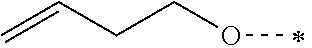 | L-344 | L-352 | L-360 |
| 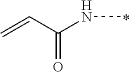 | L-345 | L-353 | L-361 |
| 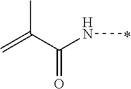 | L-346 | L-354 | L-362 |
| 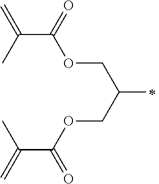 | L-347 | L-355 | L-363 |

TABLE 16

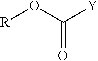

| | Y | | |
|---|---|---|---|
| R | 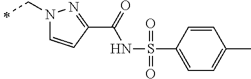 | 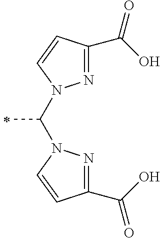 | 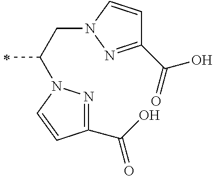 |
| 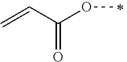 | L-364 | L-372 | L-380 |
| 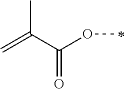 | L-365 | L-373 | L-381 |
| 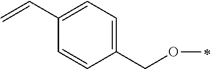 | L-366 | L-374 | L-382 |
| 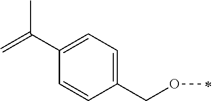 | L-367 | L-375 | L-383 |
| 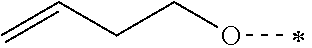 | L-368 | L-376 | L-384 |
| 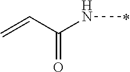 | L-369 | L-377 | L-385 |
| 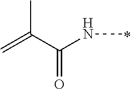 | L-370 | L-378 | L-386 |
| 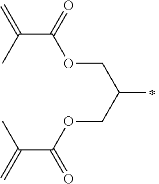 | L-371 | L-379 | L-387 |

<<Low-Molecular-Weight Compound having Two or more Coordination Sites to Metal Component and having Molecular Weight of 1800 or Lower (hereinafter, also Referred to as “Low-Molecular-Weight Compound (a2)”)>>

The coordination site to the metal component in the low-molecular-weight compound (a2) is identical to the coordination site described in the section of the low-molecular-weight compound (a1), and the preferred range thereof is also identical.

The number of the coordination sites to the metal component in the low-molecular-weight compound (a2) may be two or more, and is preferably in a range of 2 to 6, more preferably in a range of 2 to 5, and still more preferably in a range of 2 to 4. In addition, the low-molecular-weight compound (a2) may include the cross-linking group described in the section of the low-molecular-weight compound (a1).

The low-molecular-weight compound (a2) is preferably a compound represented by Formula (I) below.

R¹(—X¹)ₙ₁ (I)

In Formula (I), X¹ represents a coordination site, n1 represents an integer from 2 to 6, and R¹ represents an n1-valent group.

In Formula (I), X¹ is identical to X¹⁰⁰ in Formula (a1-i) described below and is preferably a coordination site to be coordinated with an anion and more preferably an acid group. The acid group is preferably the above-described acid group having an acid dissociation constant (pKa) of 12 or lower and more preferably includes at least one of a sulfonic acid group, a carboxylic acid group, and an imidic acid group. The number of kinds of X¹ may be one or more and is preferably two or more.

In Formula (I), n1 is preferably an integer from 2 to 5 and more preferably an integer from 2 to 4.

In Formula (I), R¹ is preferably an n1 -valent organic group or a group foimed of a combination of the nl-valent organic group and at least one group selected from —O—, —S—, —CO—, —SO—, —SO₂—, —CO—, and —CS— and is preferably a hydrocarbon group or a group formed of a combination of the hydrocarbon group and at least one group selected from —O—, —S—, —CO—, —SO₂—, and —NR^{N1}—.

In a case in which n1 is 2, R¹ more preferably includes at least one of an alkylene group, an alkenylene group, and an arylene group and is still more preferably a group formed of a combination of the above-described group and one group selected from —O—, —S—, —CO—, and —SO₂—. —NR^{N1}— is identical to —NR^{N1}— in General Formula (a1-i) described above.

In addition, the nl-valent group may be a group having at least one coordination site selected from Group (AN-1) described above, a ring having a coordinating atom to be coordinated with an unshared electron pair, or a group having at least one partial structure selected from Group (UE-1) described above.

In a case in which n1 is 2, the alkylene group as R¹ may be a linear, branched, or cyclic alkylene group, but is preferably a linear or branched alkylene group and more preferably a linear alkylene group. The number of carbon atoms in the linear or branched alkylene group is preferably in a range of 1 to 18, more preferably in a range of 1 to 12, and still more preferably in a range of 1 to 8.

In a case in which n1 is 2, the number of carbon atoms in the alkenylene group as R¹ is preferably in a range of 2 to 10, more preferably in a range of 2 to 8, and still more preferably in a range of 2 to 6.

In a case in which n1 is 2, the arylene group as R¹ is preferably an arylene group having 6 to 20 carbon atoms. The arylene group is preferably a phenylene group or a naphthylene group and more preferably a 1,4-phenylene group or a 1,5-naphthylene group.

In a case in which n1 is 3 or greater, n1 is preferably represented by Formula (III) below.

Examples of a substituent that R¹ in Formula (I) may have include an alkyl group, a polymerizable group (for example, a group having an unsaturated double bond (a vinyl group, a (meth)acryloyl group, an epoxy group, an oxetane group, or the like)), a halogen atom, a carboxylic acid group, a carboxylic acid ester group (—CO₂CH₃ or the like), a hydroxyl group, an alkoxy group (for example, a methoxy group), an amino group, a carbamoyl group, a carbamoyloxy group, an amide group, a halogenated alkyl group (a fluoroalkyl group, a chloroalkyl group, or the like), a (meth)acryloyloxy group, and the like, and the substituent is preferably a halogen atom (particularly, a fluorine atom). In a case in which R¹ has a substituent, R¹ may have another substituent, and examples of the substituent include an alkyl group, the above-described polymerizable group, a halogen atom, and the like.

The molecular weight of the compound represented by Formula (I) and a salt thereof is preferably in a range of 80 to 1800, more preferably in a range of 100 to 1500, and still more preferably in a range of 150 to 1000.

Specific aspects of the low-molecular-weight compound (a2) include a compound including one or more coordination sites to be coordinated with an anion and one or more coordinating atoms to be coordinated with an unshared electron pair (hereinafter, also referred to as compound (a2-1)), a compound including two or more coordinating atoms to be coordinated with an unshared electron pair (hereinafter, also referred to as compound (a2-2)), a compound including two or more coordination sites to be coordinated with an anion (hereinafter, also referred to as compound (a2-3)), and the like. Each of these compounds can be independently used or a combination of two or more compounds can be used.

<<<<Compound (a2-1)>>>>

In the compound (a2-1), the total number of coordination sites to be coordinated with an anion and coordinating atoms to be coordinated with an unshared electron pair in one molecule may be 2 or more and may be 3 or 4.

The compound (a2-1) is preferably, for example, a compound represented by Formula (i-1) below.

X¹¹-L¹¹-Y¹¹

X¹¹ represents the coordination site represented by Group (AN) described above.

Y¹¹ represents the above-described ring including the coordinating atom to be coordinated with an unshared electron pair or the partial structure represented by Group (UE).

L¹¹ represents a single bond or a divalent linking group. The divalent linking group is preferably an alkylene group having 1 to 12 carbon atoms, an arylene group having 6 to 12 carbon atoms, —SO—, —SO₂—, —O—, or a group formed of a combination thereof.

More detailed examples of the compound (a2-1) also include compounds represented by General Formulae (i-2) to (i-9) below.)

X¹²-L¹²-Y¹²-L¹³-X¹³ (i-₂)

Y¹³-L¹⁴-Y¹⁴-L¹⁵-X¹⁴ (i-3)

Y¹⁵-L¹⁶-X¹⁵-L¹⁷-X¹⁶ (i-4)

Y¹⁶-L¹⁸-X¹⁷-L¹⁹-Y¹⁷ (i-5)

X¹⁸-L²⁰-Y¹⁸-L²¹-Y¹⁹-L²²-X¹⁹ (i-6)

X²⁰-L²³-Y²⁰-L²⁴-Y²¹-L²⁵-Y²² (i-7)

Y²³-L²⁶-X²¹-L²⁷-X²²-L²⁸-Y²⁴ (i-8)

Y²⁵-L²⁹-X²³-L³⁰-Y²⁶-L³¹-Y²⁷ (i-9)

In General Formulae (i-2) to (i-9), each of X¹² to X¹⁴, X¹⁶, and X¹⁸ to X²⁰ independently represents the coordination site represented by Group (AN) described above. In addition, each of X¹⁵, X¹⁷, and X²¹ to X²³ independently represents the coordination site represented by Group (AN-1) described above.

In General Formulae (i-2) to (i-9), each of L¹² to L³¹ independently represents a single bond or a divalent linking group. The divalent linking group is identical to that of a case in which L¹ in General Formula (i-1) represents a divalent linking group.

The compound (a2-1) is also preferably a compound represented by Formula (i-10) or (i-11).

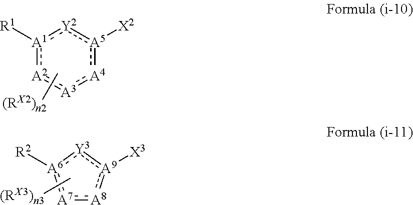

In Formula (i-10), X² represents a group including the coordination site to be coordinated with an anion. Y² represents an oxygen atom, a nitrogen atom, a sulfur atom, or a phosphorus atom. Each of A¹ and A⁵ independently represents a carbon atom, a nitrogen atom, or a phosphorus atom. Each of A² to A⁴ independently represents a carbon atom, an oxygen atom, a nitrogen atom, a sulfur atom, or a phosphorus atom. R¹ represents a substituent. R^{X2} represents a substituent. n2 represents an integer from 0 to 3.

In Formula (i-10), X² may be formed of only a group including the coordination site to be coordinated with an anion and the group including the coordination site to be coordinated with an anion may have a substituent. Examples of the substituent that the group including the coordination site to be coordinated with an anion may have include a halogen atom, a carboxylic acid group, and a heterocyclic group. The heterocyclic group as the substituent may be a monocyclic ring or a polycyclic ring and may be an aromatic group or an non-aromatic group. The number of hetero atoms constituting the heterocyclic ring is preferably in a range of 1 to 3. The hetero atom constituting the heterocyclic ring is preferably a nitrogen atom.

In Formula (i-10), Y² is preferably an oxygen atom, a nitrogen atom, or a sulfur atom, more preferably an oxygen atom or a nitrogen atom, and still more preferably a nitrogen atom.

In Formula (i-10), A¹ and A⁵ are preferably carbon atoms.

In Formula (i-10), A² to A³ preferably represent carbon atoms. A⁴ preferably represents a carbon atom or a nitrogen atom.

In Formula (i-10), R¹ is identical to the substituent that the ring including the above-described coordinating atom to be coordinated with an unshared electron pair may have.

In Formula (i-10), R^{X2} is identical to the substituent that the above-described ring including the coordinating atom to be coordinated with an unshared electron pair may have, and the preferred range thereof is also identical.

In Formula (i-10), n2 represents an integer from 0 to 3, and is preferably 0 or 1 and more preferably 0.

In the compound represented by Formula (i-10), the hetero ring including Y² may be a monocyclic structure or a polycyclic structure. Specific examples of a monocyclic structure as the hetero ring including Y² include a pyridine ring, a pyridazine ring, a pyrimidine ring, a pyrazine ring, a triazine ring, a pyran ring, and the like. Specific examples of a polycyclic structure as the hetero ring including Y² include a quinoline ring, an isoquinoline ring, a quinoxaline ring, an acridine ring, and the like.

In Formula (i-11), X³ represents the above-described group having the coordination site to be coordinated with an anion. Y³ represents an oxygen atom, a nitrogen atom, a sulfur atom, or a phosphorus atom. Each of A⁶ and A⁹ independently represents a carbon atom, a nitrogen atom, or a phosphorus atom. Each of A⁷ to A⁸ independently represents a carbon atom, an oxygen atom, a nitrogen atom, a sulfur atom, or a phosphorus atom. R² represents a substituent. R^{X3} represents a substituent. n3 represents an integer from 0 to 2.

In Formula (i-11), X³ is identical to X² in Formula (i-10), and the preferred range thereof is also identical.

In Formula (i-11), Y³ is preferably an oxygen atom, a nitrogen atom, or a sulfur atom, and more preferably an oxygen atom or a nitrogen atom.

In Formula (i-11), A⁶ is preferably a carbon atom or a nitrogen atom. A⁹ is preferably a carbon atom.

In Formula (i-11), A⁷ is preferably a carbon atom. A⁸ is preferably a carbon atom, a nitrogen atom, or a sulfur atom.

In Formula (i-11), R² is preferably a hydrophobic substituent, more preferably a hydrocarbon group having 1 to 30 carbon atoms, still more preferably an alkyl group having 3 to 30 carbon atoms or an aryl group having 6 to 30 carbon atoms, and particularly preferably an alkyl group having 3 to 15 carbon atoms.

In Formula (i-11), R^{X3} is identical to R^{X2} in Formula (i-10), and the preferred range thereof is also identical.

In Formula (i-11), n3 is preferably 0 or 1 and more preferably 0.

In the compound represented by Formula (i-11), the hetero ring including Y³ may be a monocyclic structure or a polycyclic structure. Specific examples of a monocyclic structure as the hetero ring including Y³ include a pyrazole ring, an imidazole ring, a triazole ring, an oxazole ring, a thiazole ring, an isothiazole ring, and the like. Specific examples of a polycyclic structure as the hetero ring including Y³ include an indole ring, an isoindole ring, a benzofuran ring, an isobenzofuran ring, and the like.

Particularly, the compound represented by Formula (i-11) is preferably a compound having a pyrazole ring and preferably includes a secondary or tertiary alkyl group at the fifth site of the pyrazole ring. In the present specification, the fifth site of the pyrazole ring in a case in which the compound represented by Formula (i-11) is a compound having a pyrazole ring refers to the substitution position of R² in a case in which Y³ and A⁶ in Formula (i-11) represent nitrogen atoms and A⁷ to A⁹ represent carbon atoms. The number of carbon atoms in the secondary or tertiary alkyl group at the fifth site of the pyrazole ring is preferably in a range of 3 to 15 and more preferably in a range of 3 to 12.

The molecular weight of the compound (a2-1) is preferably 1000 or lower, more preferably 750 or lower, still more preferably 600 or lower, and particularly preferably 500 or lower. In addition, the molecular weight of the compound (a2-1) is preferably 50 or higher, more preferably 70 or higher, and still more preferably 80 or higher.

Specific examples of the compound (a2-1) include the following compounds.

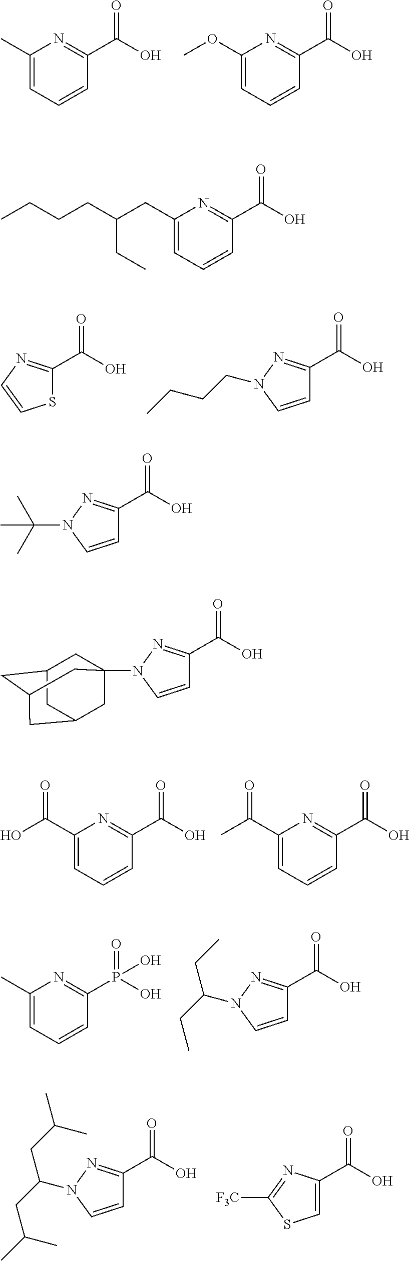

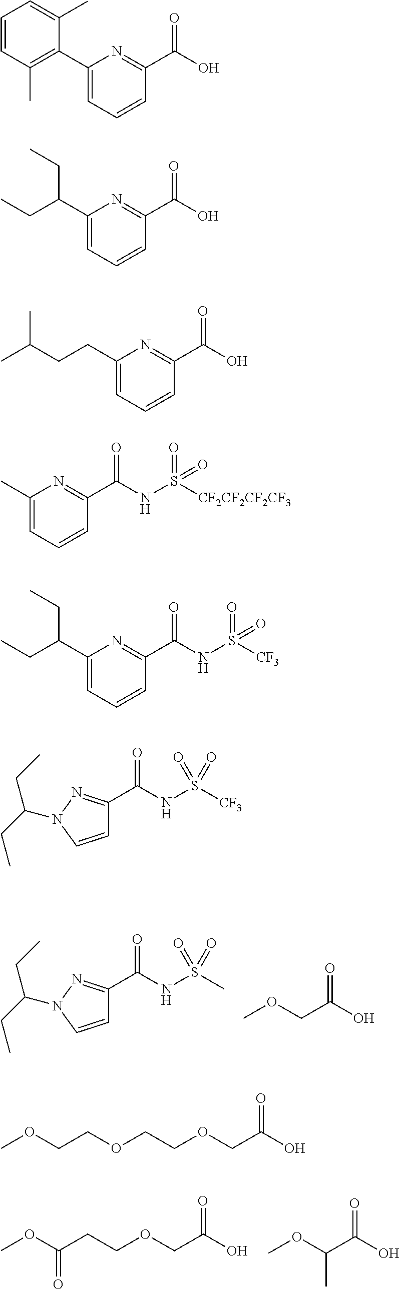

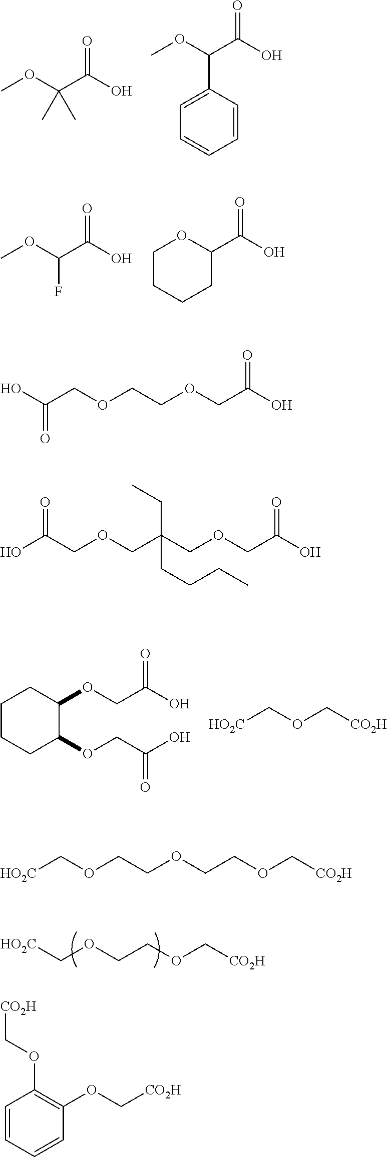

<<<<Salt of Compound (a2-1)>>>>

The salt of the compound (a2-1), that is, the compound including a salt of the coordination site to be coordinated with an anion is preferably, for example, a metal salt. A metal atom constituting the metal salt is preferably an alkali metal atom or an alkaline-earth metal atom. Examples of the alkali metal atom include sodium, potassium, and the like. Examples of the alkaline-earth metal atom include potassium, magnesium, and the like.

<<<<Compound (a2-2)>>>>

In the compound (a2-2), the number of the coordinating atoms to be coordinated with an unshared electron pair may be 2 or more or 3 or more, and is preferably in a range of 2 to 4 in a molecule.

The compound (a2-2) is preferably a compound represented by General Formula (ii-1) below.

Y⁴⁰-L⁴⁰-Y⁴¹ (ii-1)

In General Formula (ii-1), each of Y⁴⁰ and Y⁴¹ independently represents a ring including the coordinating atom to be coordinated with an unshared electron pair or the partial structure represented by Group (UE).

In General Formula (ii-1), L⁴⁰ represents a single bond or a divalent linking group. In a case in which L⁴⁰ represents a divalent linking group, an alkylene group having 1 to 12 carbon atoms, an arylene group having 6 to 12 carbon atoms, —SO—, —O—, —SO₂—, or a group formed of a combination thereof is preferred, and an alkylene group having 1 to 3 carbon atoms, a phenylene group, or —SO₂— is preferred.

More detailed examples of the compound (a2-2) also include compounds represented by General Formula (ii-2) or (ii-3) below.

Y⁴²-L⁴¹-Y⁴³-L⁴²-Y⁴⁴ (ii-2)

Y⁴⁵-L⁴³-Y⁴⁶-L⁴⁴-Y⁴⁷-L⁴⁵-Y⁴⁸ (ii-3)

In General Formulae (ii-2) and (ii-3), each of Y⁴², Y⁴⁴, Y⁴⁵, and Y⁴⁸ independently represents a ring including the coordinating atom to be coordinated with an unshared electron pair or the partial structure represented by Group (UE).

In addition, each of Y⁴³, Y⁴⁶, and Y⁴⁷ is independently a ring including the coordinating atom to be coordinated with an unshared electron pair or a partial structure represented by Group (UE-1) described above.

In General Formulae (ii-2) and (ii-3), each of L⁴¹ to L⁴⁵ independently represents a single bond or a divalent linking group. The divalent linking group is identical to that of a case in which L⁴⁰ in General Formula (ii-1) represents a divalent linking group, and the preferred range thereof is also identical.

The molecular weight of the compound (a2-2) is preferably 1000 or lower, more preferably 750 or lower, still more preferably 600 or lower, and particularly preferably 500 or lower. In addition, the molecular weight of the compound (a2-2) is preferably 50 or higher, more preferably 70 or higher, and still more preferably 80 or higher.

Specific examples of the compound (a2-2) include the following compounds.

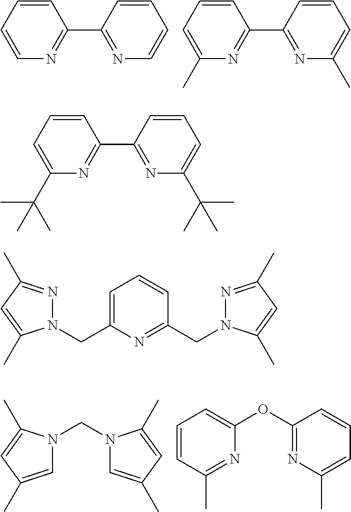

<<<<Compound (a2-3)>>>>

The compound (a2-3) has two or more coordination sites to be coordinated with an anion. The coordination site to be coordinated with an anion is identical to the above-described coordination site to be coordinated with an anion.

The compound (a2-3) is preferably a compound represented by General Formula (iii-1) below.)

X⁵⁰-L⁵⁰-X⁵¹

In General Formula (iii-1), each of X⁵⁰ and X⁵¹ represents the coordination site to be coordinated with an anion, is identical to the above-described coordination site to be coordinated with an anion, and is preferably a monoanionic coordination site.

In General Formula (iii-1), L⁵⁰ represents a single bond or a divalent linking group. The divalent linking group is preferably an alkylene group having 1 to 20 carbon atoms, an alkenylene group having 2 to 10 carbon atoms, an arylene group having 6 to 18 carbon atoms, a heterocyclic group, —O—, —S—, —CO—, or —CS—, —SO₂—, or a group formed of a combination thereof. R^{N1} is preferably a hydrogen atom, an alkyl group having 1 to 12 carbon atoms, an aryl group having 6 to 18 carbon atoms, or an aralkyl group having 7 to 20 carbon atoms.

The compound (a2-3) preferably includes at least one group selected from a sulfonic acid group, a carboxylic acid group, and an imidic acid group. When a compound including at least one group selected from a sulfonic acid group, a carboxylic acid group, and an imidic acid group is used, it is possible to further improve valency.

The molecular weight of the compound (a2-3) is preferably 1000 or lower, more preferably 750 or lower, still more preferably 600 or lower, and particularly preferably 500 or lower. In addition, the molecular weight of the compound (a2-3) is preferably 50 or higher, more preferably 70 or higher, and still more preferably 80 or higher.

In addition, the compound (a2-3) is also preferably a low-molecular-weight compound having a molecular weight of 1800 or lower which is represented by Formula (III) below. That is, the near-infrared-absorbing composition of the present invention may include the near-infrared-absorbing compound (A2) obtained from a reaction with a low-molecular-weight compound having a molecular weight of 1800 or lower which is represented by Formula (III) below or a salt thereof.

R³(—X¹)ₙ₂ (III)

In Formula (III), R³ represents an n2-valent group, X¹ represents a coordination site to the metal component, and n2 represents an integer from 3 to 6.

When the near-infrared-absorbing composition of the present invention includes the near-infrared-absorbing compound (A2), it is possible to form a cured film having excellent heat resistance while maintaining high infrared-shielding properties.

In Formula (III), R³ is identical to R¹ in Formula (I), and the preferred range thereof is also identical.

In Formula (III), X¹ is identical to X¹ in Formula (I), and the preferred range thereof is also identical.

In Formula (III), n2 is preferably an integer from 3 to 5 and more preferably 3 or 4.

Formula (III) is preferably represented by Formula (IV) below.

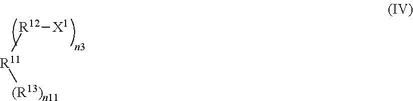

In Formula (IV), R¹¹ is an (n3+n11)-valent group, R¹² is a single bond, a divalent hydrocarbon group, or a group formed of a combination of a divalent hydrocarbon group and at least one element selected from —O—, —S—, —CO—, —SO₂—, —NR—(R represents a hydrogen atom or an alkyl group), R¹³ is a hydrocarbon group, —OH, or a group formed of a combination of a hydrocarbon group and at least one element selected from —O—, —S—, —CO—, —SO₂—, —NR—(R represents a hydrogen atom or an alkyl group), and the like), and X¹ is a coordination site.

In Formula (IV), the total of n3 and n11 is preferably 4. n3 is preferably 3 or 4.

is preferably an aliphatic hydrocarbon group having 1 or 2 carbon atoms or an aromatic hydrocarbon group having 6 carbon atoms.

R¹² is preferably a single bond, an alkylene group, or a group formed of a combination of an alkylene group and at least one of —O—, —S—, —CO—, and —SO₂—. The number of carbon atoms in the alkylene group is preferably in a range of 1 to 6.

R¹³ is preferably an ethylene group or —OH.

X¹ is identical to X¹ in Formula (I), and the preferred range thereof is also identical.

Specific examples of the compound (a2-3) include the following compounds and compounds of a salt of an acid group in the following compound (for example, the above-described metal salt), but the compound (a2-3) is not limited thereto. In addition, specific examples of the compound represented by Formula (III) include compounds having three or more coordination sites to be coordinated with an anion (specifically, an acid group) out of the following specific examples.

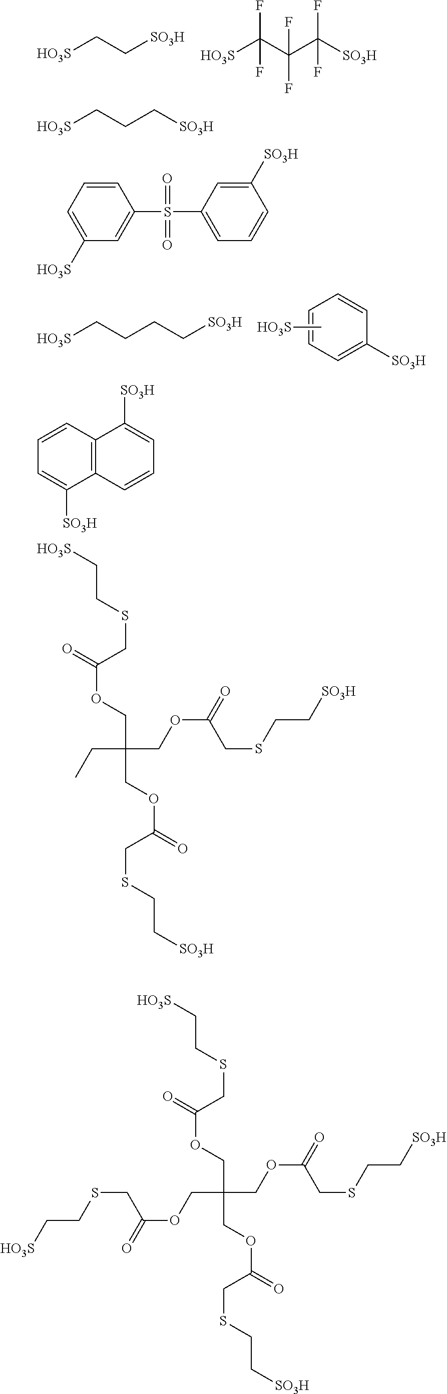

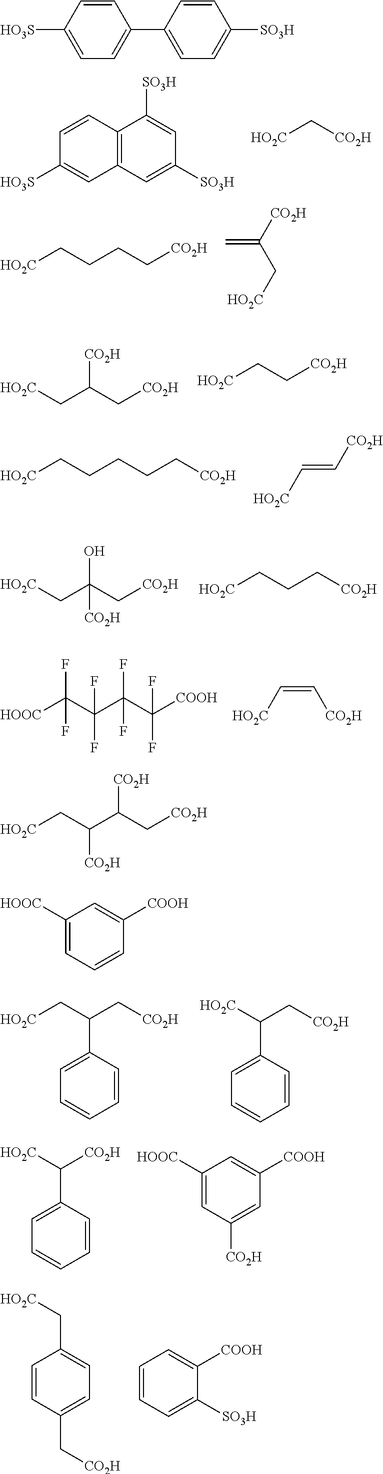

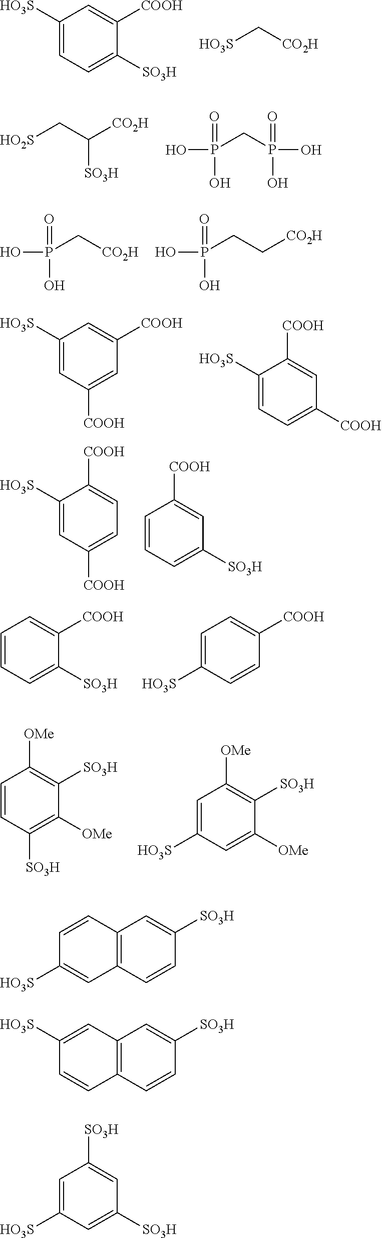

<<Near-Infrared-Absorbing Compound (B: High-Molecular-Weight Type)>>

The near-infrared-absorbing compound (B) is obtained from a reaction between a metal component and the compound represented by Formula (II).

<<<Metal Component>>>

The metal component is not particularly limited as long as the metal component is capable of reacting with the compound represented by Formula (II) and thus forming a compound exhibiting near-infrared-absorbing properties and is identical to the metal component used to obtain the above-described near-infrared-absorbing compound (A1: low-molecular-weight type), and the preferred range thereof is also identical.

<<<High-Molecular-Weight Compound having Repeating Unit Represented by Formula (II) or Salt thereof>>>

A high-molecular-weight compound or a salt thereof which is reacted with the metal component has a repeating unit represented by Formula (II).

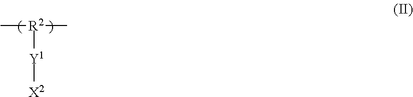

(in Fonnula (II), R² represents an organic group, Y¹ represents a single bond or a divalent linking group, and X² represents a coordination site to the metal component.)

In Formula (II), R² is preferably an aliphatic hydrocarbon group or a group having an aromatic hydrocarbon group and/or an aromatic heterocyclic group.

In Formula (II), in a case in which Y¹ represents a divalent linking group, examples thereof include a divalent hydrocarbon group, a heteroarylene group, —O—, —S—, —CO—, —COO—, —OCO—, —SO₂—, —NX—(X represents a hydrogen atom or an alkyl group and is preferably a hydrogen atom), or a group formed of a combination thereof.

Examples of the divalent hydrocarbon group include linear, branched, or cyclic alkylene groups and arylene groups. The hydrocarbon group may have a substituent, but is preferably not substituted.

The number of carbon atoms in the linear alkylene group is preferably in a range of 1 to 30, more preferably in a range of 1 to 15, and still more preferably in a range of 1 to 6. In addition, the number of carbon atoms in the branched alkylene group is preferably in a range of 3 to 30, more preferably in a range of 3 to 15, and still more preferably in a range of 3 to 6. The cyclic alkylene group may be either a monocyclic ring or a polycyclic ring. The number of carbon atoms in the cyclic alkylene group is preferably in a range of 3 to 20, more preferably in a range of 4 to 10, and still more preferably in a range of 6 to 10.

The number of carbon atoms in the arylene group is preferably in a range of 6 to 18, more preferably in a range of 6 to 14, and still more preferably in a range of 6 to 10, and a phenylene group is particularly preferred.

The heteroarylene group is preferably a 5-membered ring or a 6-membered ring. In addition, the heteroarylene group may be a monocyclic ring or a fused ring and is preferably a monocyclic ring or a fused ring having 2 to 8 fused portions, and more preferably a monocyclic ring or a fused ring having 2 to 4 fused portions.

In Formula (II), X² is identical to X¹ in Formula (I) and is preferably a group having one or more selected from a coordination site to be coordinated to the metal component with an anion and a coordinating atom to be coordinated to the metal component with an unshared electron pair. The coordination site to be coordinated with an anion preferably includes at least one of a carboxylic acid group, a sulfonic acid group, and an imidic acid group. A carboxylic acid group and a sulfonic acid group are preferred, and a sulfonic acid group is more preferred.

In Formula (II), in a case in which X² represents a group having a coordinating atom to be coordinated with an unshared electron pair, examples of X² include groups represented by Formula (1a1) or (1a2) below.

*-L¹¹-(X¹¹)ₚ (1a1)

*-L¹¹-(X^{11a}-L¹²-X¹¹)ₚ (1a2)

“*” represents a bonding site with Y¹ in Formula (II).

L¹¹ represents a single bond or a (p+1)-valent linking group. In a case in which L¹¹ represents a divalent linking group, L¹¹ is preferably an alkylene group having 1 to 12 carbon atoms, an arylene group having 6 to 12 carbon atoms, —CO—, —COO—, —OCO—, —SO₂—, —O—, —NR¹⁰—(R¹⁰ represents a hydrogen atom or an alkyl group and is preferably a hydrogen atom), or a group formed of a combination thereof.

In a case in which L¹¹ represents a tri- or higher-valent linking group, examples thereof include groups obtained by removing one or more hydrogen atoms from the groups exemplified as the above-described divalent linking group.

L¹² represents a single bond or a divalent linking group. Preferred examples of the divalent linking group include the divalent linking groups described in the section of L¹¹. L¹² is more preferably a single bond, an alkylene group, or a group formed of a combination of —NH— and —CO—.

X¹¹ represents a ring having a coordinating atom to be coordinated with an unshared electron pair or the partial structure represented by Group (UE) described above. In a case in which p represents an integer of 2 or higher, a plurality of X¹¹'s may be identical to or different from each other.

X^{11a} represents a ring having a coordinating atom to be coordinated with an unshared electron pair or at least one partial structure selected from Group (UE-1) described above. In a case in which p represents an integer of 2 or higher, a plurality of X^{11a}'s may be identical to or different from each other.

In Formulae (1a1) and (1a2), p represents an integer of 1 or higher and is preferably 2 or higher. The upper limit is, for example, preferably 5 or lower and more preferably 3 or lower.

<<<<Group having One or more Coordinating Atoms to be Coordinated with Unshared Electron Pair and One or more Coordination Sites to be Coordinated with Anion>>>>

In Formula (II), in a case in which X² represents a group having one or more coordinating atoms to be coordinated with an unshared electron pair and one or more coordination sites to be coordinated with an anion, examples of X² include groups represented by Formulae below.

*-L²¹-(X^{21a}-L²³-X²²)_{q} (1b1)

*-L²¹-(X^{22a}-L²-X²¹)_{q} (1b2)

*-L²²-(X²¹)_{q}(X²²)ᵣ (1b3)

*-L²²-(X^{21a}-L²³-X²²)_{q}(X²¹)ᵣ (1b4)

*-L²²-(X^{22a}-L²³-X²¹)_{q}(X²¹)ᵣ (1b5)

*-L²²-(X^{21a}-L²³-X²²)_{q}(X²²)ᵣ (1b6)

*-L22-(X^{22a}-L²³-X²¹)_{q}(X²²)ᵣ (1b7)

“*” represents a bonding site with Y¹ in Formula (II).

L²¹ represents a single bond or a (q+1)-valent linking group. L²¹ is identical to L¹¹ in Formula (lal), and the preferred range thereof is also identical.

L²² represents a single bond or a (q+r+1)-valent linking group. L²² is identical to L¹¹ in Formula (1 al), and the preferred range thereof is also identical.

L²³ represents a single bond or a divalent linking group. Preferred examples of the divalent linking group include the divalent linking groups described in the section of L¹¹ in Formula (1 a1). L²³ is more preferably a single bond, an alkylene group, or a group formed of a combination of —NH— and —CO—.

X²¹ represents a ring having a coordinating atom to be coordinated with an unshared electron pair or the partial structure represented by Group (UE) described above. In a case in which q and r represent integers of 2 or higher, a plurality of X²¹'s may be identical to or different from each other.

X^{21a} represents a ring having a coordinating atom to be coordinated with an unshared electron pair or at least one partial structure selected from Group (UE-1) described above. In a case in which q and r represent integers of 2 or higher, a plurality of X^{21a}'s may be identical to or different from each other.

X²² represents the partial structure represented by Group (AN) described above. In a case in which q and r represent integers of 2 or higher, a plurality of X²²'s may be identical to or different from each other.

X^{22a} represents at least one coordination site selected from Group (AN-1) described above.

q represents an integer of 1 or higher and is preferably in a range of 1 to 5 and particularly preferably in a range of 1 to 3.

r represents an integer of 1 or higher and is preferably in a range of 1 to 5 and particularly preferably in a range of 1 to 3.

q+r represents 2 or higher and is preferably in a range of 2 to 5 and particularly preferably 2 or 3.

<<<<Group having Coordination Site to be Coordinated with Anion>>>>

In Formula (II), in a case in which X² represents a group having a coordination site to be coordinated with an anion, examples of X² include groups represented by Formula (1c1) or (1c2) below.

*-L³¹-(X¹¹)ₚ (1c1)

*-L³¹-(X^{31a}-L³²-X³¹)ₚ (1c2)

“*” represents a bonding site with Y¹ in Formula (II).

L³¹ represents a single bond or a (p+1)-valent linking group. In a case in which L³¹ is identical to L″ in Formula (lal), the preferred range thereof is also identical.

L³² represents a single bond or a divalent linking group. The divalent linking group is identical to L¹² in Formula (1a2), and the preferred range thereof is also identical.

X³¹ represents the coordination site to be coordinated with an anion. In a case in which p represents an integer of 2 or higher, a plurality of X³¹'s may be identical to or different from each other.

X^{31a} represents at least one coordination site selected from Group (AN-1) described above. In a case in which p represents an integer of 2 or higher, a plurality of X^{31a}'s may be identical to or different from each other.

In Formulae (1c1) and (1c2), p represents an integer of 1 or higher and is preferably 2 or higher. The upper limit is, for example, preferably 5 or lower and more preferably 3 or lower.

A first embodiment of the compound represented by Formula (II) is a polymer having a carbon-carbon bond at the main chain, preferably has a repeating unit represented by Formula (II-1A) below, and more preferably has a repeating unit represented by Formula (II-1B) below.

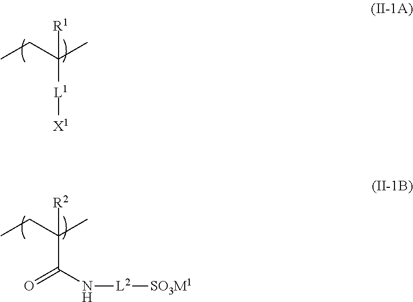

(In Formula (II-1A), R′ represents a hydrogen atom or a methyl group, L¹ represents a single bond or a divalent linking group, and X¹ represents a coordination site to the metal component. In Formula (II-1B), R² represents a hydrogen atom or a methyl group, L² represents a divalent linking group, and M¹ represents a hydrogen atom or an atom or an atomic group constituting a salt with a sulfonic acid group.)

In Formulae (II-1 A) and (II-1 B), each of R¹ and R² is preferably independently a hydrogen atom.

In Formulae (II-1A) and (II-1B), in a case in which each of L¹ and L² represents a divalent linking group, each of L¹ and L² is identical to that of a case in which Y¹ represents a divalent linking group, and the preferred range is also identical.

In Formula (II-1A), X¹ is identical to X¹ in Formula (I), and the preferred range is also identical.

In Formula (II-1B), M′ is preferably a hydrogen atom.

The compound represented by Formula (II) may have a repeating unit other than the repeating unit represented by Formula (II-1A) or (II-1B). Regarding the repeating unit, Paragraphs “0068” to “0075” (“0112” to “0118” in the specification of the corresponding US2011/0124824A) of JP2010-106268A can be referred to, the content of which is incorporated into the specification of the present application.

Preferred examples of the repeating unit include repeating units represented by Formula (II-1C) below.

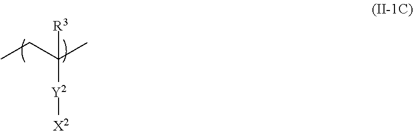

In Formula (II-1C), R³ represents a hydrogen atom or a methyl group and is preferably a hydrogen atom.

Y² represents a single bond or a divalent linking group, and the divalent linking group is identical to the divalent linking group in Formula (II-1A) described above. Particularly, Y2 is preferably —COO—, —CO—, —NH—, a linear or branched alkylene group, or a group formed of a combination thereof or a single bond.

In Formula (II-1C), X² represents —PO₃H—, —PO₃H₂, —OH, or —COOH, and is preferably —COOH.

In a case in which the compound represented by Formula (II) includes other repeating units (preferably a repeating unit represented by Formula (II-1A) or (II-1B)), the molar ratio between the repeating unit represented by Formula (II-1A) or (II-1B) and the repeating unit represented by Formula (II-1C) is preferably in a range of 95:5 to 20:80 and more preferably in a range of 90:10 to 40:60.

Specific examples of the first embodiment of the compound represented by Formula (II) include the following compounds and salts of the following compounds, but the first embodiment is not limited thereto.

TABLE 17

| | |
|---|---|
| B-1 | 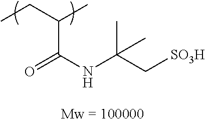 |
| B-2 | 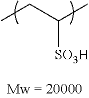 |
| B-3 | 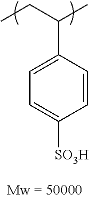 |
| B-4 | 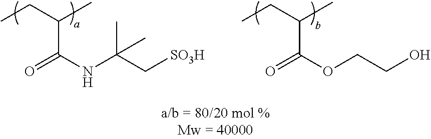 |
| B-5 | 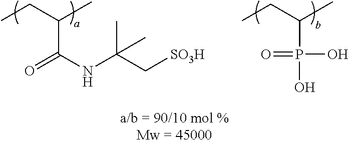 |
| B-6 | 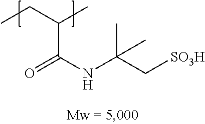 |
| B-7 | 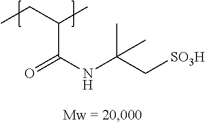 |
| B-8 | 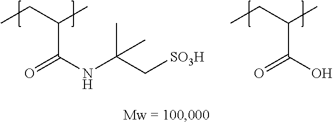 |
| B-9 | 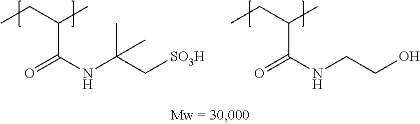 |
| B-10 | 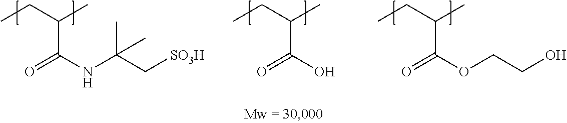 |
| B-11 | 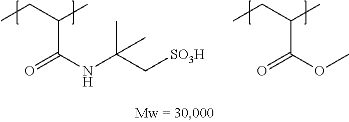 |
| B-12 | 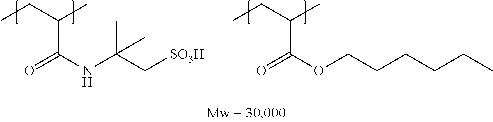 |
| B-13 | 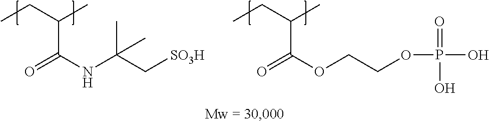 |
| B-14 | 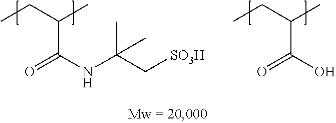 |
| B-15 | 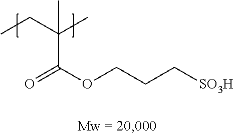 |

TABLE 18

| | |
|---|---|
| B-16 | 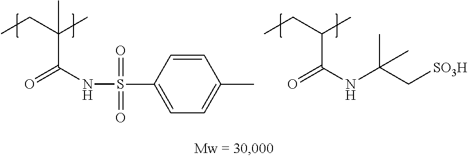 |
| B-17 | 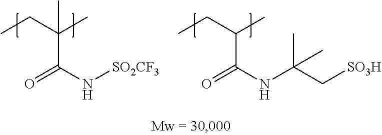 |
| B-18 | 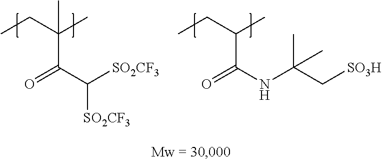 |
| B-19 | 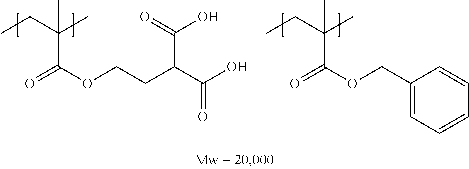 |
| B-20 | 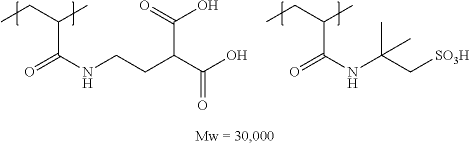 |
| B-21 | 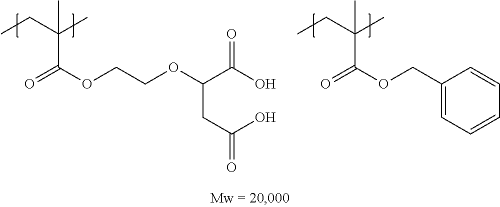 |
| B-22 | 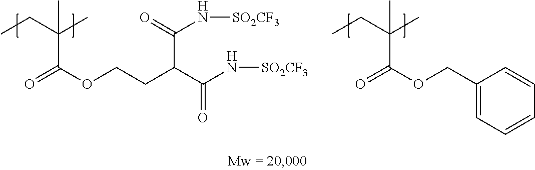 |

TABLE 19

| | |
|---|---|
| B-23 | 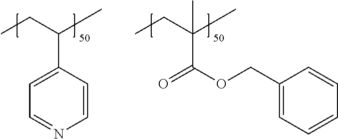 |
| B-24 | 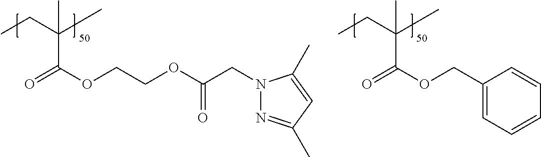 |
| B-25 | 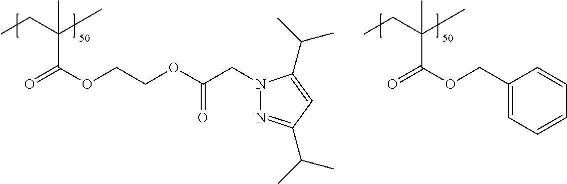 |
| B-26 | 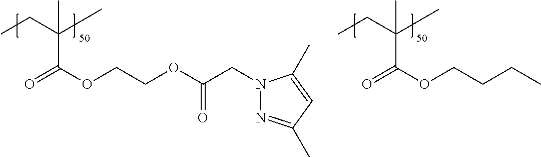 |
| B-27 | 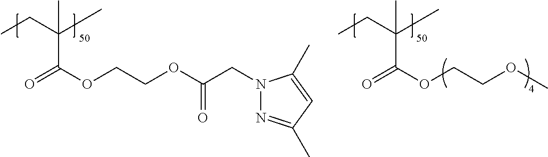 |
| B-28 | 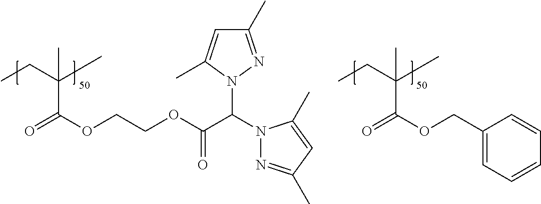 |
| B-29 | 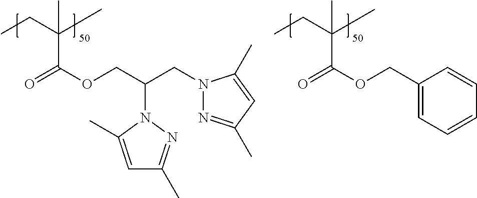 |
| B-30 | 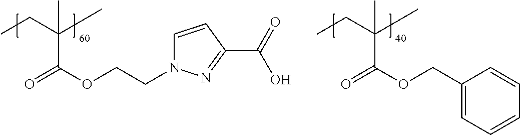 |
| B-31 | 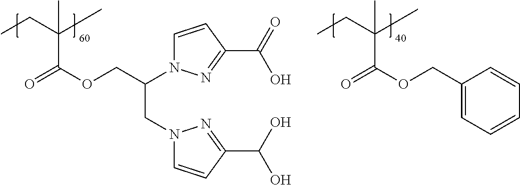 |
| B-32 | 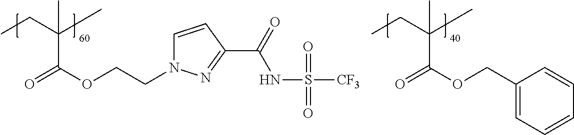 |
| B-33 | 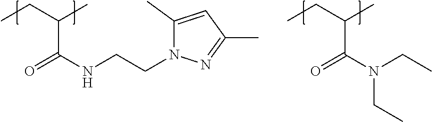 |
| B-34 | 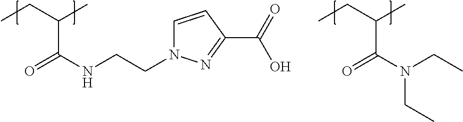 |
| B-35 | 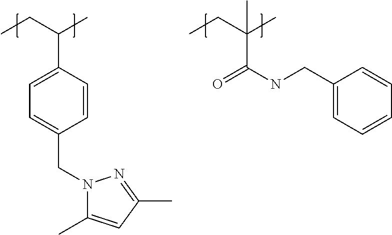 |
| B-36 | 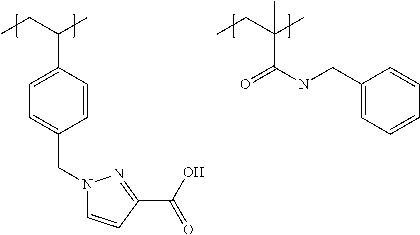 |

The first embodiment of the compound represented by Formula (II) is obtained from a polymerization reaction of monomers constituting the above-described constitutional unit. The polymerization reaction can be performed using a well-known polymerization initiator. As the polymerization initiator, an azo polymerization initiator can be used, and specific examples thereof include a water-soluble azo polymerization initiator, an oil-soluble azo polymerization initiator, and a high-molecular-weight polymerization initiator. Only one polymerization initiator may be used, or two or more polymerization initiators may be jointly used.

As the water-soluble azo polymerization initiator, it is possible to use, for example, commercially available products VA-044, VA-046B, V-50, VA-057, VA-061, VA-067, VA-086, and the like (trade names: all manufactured by Wako Pure Chemical Industries, Ltd.). As the oil-soluble azo polymerization initiator, it is possible to use, for example, commercially available products V-60, V-70, V-65, V-601, V-59, V-40, VF-096, VAm-110, and the like (trade names: all manufactured by Wako Pure Chemical Industries, Ltd.). As the high-molecular-weight polymerization initiator, it is possible to use, for example, commercially available products VPS-1001, VPE-0201, and the like (trade names: all manufactured by Wako Pure Chemical Industries, Ltd.).

A second embodiment of the compound represented by Formula (II) includes a repeating unit represented by at least any one of Formulae (II-2A), (II-2B), and (II-2C).

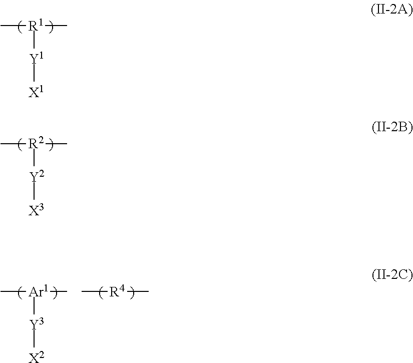

(In Formula (II-2A), R¹ represents an aliphatic hydrocarbon group, Y¹ represents a single bond or a divalent linking group, X¹ represents a coordination site to the metal component, and at least one of R¹ and Y¹ is substituted with a fluorine atom.

In Formula (II-2B), R² represents an aliphatic hydrocarbon group, R³ represents a hydrocarbon group, Y² represents a single bond or a divalent linking group, and at least one of R², R³, and Y² is substituted with a fluorine atom.

In Formula (II-2C), Ar^{l} represents an aromatic hydrocarbon group and/or an aromatic heterocyclic group, R⁴ represents an organic group, Y³ represents a single bond or a divalent linking group, X² represents a coordination site to the metal component, and at least one of Ar¹, R⁴, and Y³ is substituted with a fluorine atom.)

In Formulae (II-2A) and (II-2B), each of R¹ and R² independently represents an aliphatic hydrocarbon group, and examples thereof include linear, branched, or cyclic alkyl groups. The number of carbon atoms in the linear alkyl group is preferably in a range of 1 to 20, more preferably in a range of 1 to 10, and still more preferably in a range of 1 to 6. The number of carbon atoms in the branched alkyl group is preferably in a range of 3 to 20, more preferably in a range of 3 to 10, and still more preferably in a range of 3 to 6. The cyclic alkyl group may be either a monocyclic ring or a polycyclic ring. The number of carbon atoms in the cyclic alkyl group is preferably in a range of 3 to 20, more preferably in a range of 4 to 10, and still more preferably in a range of 6 to 10.

In a case in which R¹ and R² have a substituent, examples thereof include a polymerizable group (preferably a polymerizable group having a carbon-carbon double bond), a halogen atom (a fluorine atom, a chlorine atom, a bromine atom, or an iodine atom), an alkyl group, a carboxylic acid ester group, a halogenated alkyl group, an alkoxy group, a methacryloyloxy group, an acryloyloxy group, an ether group, a sulfonyl group, a sulfide group, an amide group, an acyl group, a hydroxy group, a carboxylic acid group, an aralkyl group, -Si-(OR^{N22})₃, and the like, and a fluorine atom is particularly preferred. (R^{N22} represents an alkyl group, and the number of carbon atoms is preferably in a range of 1 to 3.)

In Formulae (II-2A) to (II-2C), in a case in which each of Y¹ to Y³ independently represents a divalent linking group, the divalent linking group is identical to the divalent linking group in Formula (II-1A).

Examples of the hydrocarbon group include linear, branched, or cyclic alkylene groups or arylene groups. The number of carbon atoms in the linear alkylene group is preferably in a range of 1 to 20, more preferably in a range of 1 to 10, and still more preferably in a range of 1 to 6. The number of carbon atoms in the branched alkylene group is preferably in a range of 3 to 20, more preferably in a range of 3 to 10, and still more preferably in a range of 3 to 6. The cyclic alkylene group may be either a monocyclic ring or a polycyclic ring. The number of carbon atoms in the cyclic alkylene group is preferably in a range of 3 to 20, more preferably in a range of 4 to 10, and still more preferably in a range of 6 to 10.

The arylene group and the heteroarylene group are identical to those in a case in which the divalent linking group in Formula (II-1A) is an arylene group, and the preferred range thereof is also identical.

In the present invention, particularly, in a case in which Y¹ represents a divalent linking group, the divalent linking group is preferably —COO—, —CO—, —O—, —NX—(X represents a hydrogen atom or an alkyl group and is preferably a hydrogen atom), a hydrocarbon group (preferably an alkylene group or arylene group having 1 to 30 carbon atoms), or a group formed of a combination thereof.

In Formulae (II-2A) to (II-2C), in a case in which each of X¹ and X² independently represents a coordination site to the metal component, the coordination site to the metal component is identical to the above-described coordination site to the metal component, and the preferred range thereof is also identical.

In addition, in Formula (II-2A), at least one of R¹ and Y¹ is substituted with a fluorine atom, and, out of R¹ and Y¹, at least Y¹ is preferably substituted with a fluorine atom. Here, R¹ being substituted with a fluorine atom means that at least one of hydrogen atoms constituting R¹ is substituted with a fluorine atom. At least one of R¹ and Y¹ is preferably a perfluoro group.

In Formula (II-2B), R³ represents a hydrocarbon group, and examples thereof include the alkyl group described in the section of R¹ in Formula (II-2A) and an aryl group. The alkyl group is identical to the alkyl group described in the section of R¹ in Formula (II-2A), and the preferred range thereof is also identical. The number of carbon atoms in the aryl group is preferably in a range of 6 to 18, more preferably in a range of 6 to 14, and more preferably in a range of 6 to 10. In a case in which R³ has a substituent, a fluorine atom is preferred.

In Formula (II-2B), it is preferable that at least one of R², R³, and Y² has a fluorine atom and at least one of R², R³, and Y² is a perfluoro group.

In Formula (II-2C), Ar¹ preferably represents an aromatic hydrocarbon group. The aromatic hydrocarbon group is preferably an aryl group having 6 to 20 carbon atoms and more preferably a phenyl group or a biphenyl group. The aromatic heterocyclic group is preferably an aromatic heterocyclic group having 2 to 30 carbon atoms.

In Formula (II-2C), R⁴ represents an organic group, and examples thereof include an alkylene group having 1 to 6 carbon atoms, a cycloalkylene group having 1 to 6 carbon atoms, —O—, —SO₂—, —CO—, —NR_{N}—(R_{N} represents a hydrogen atom or an alkyl group), and a combination thereof. In a case in which R⁴ is an alkylene group, an alkyl group having one carbon atom is preferred, and a group represented by —C(R^{4A})(R^{4B})— is more preferred. Each of R^{4A} and R^{4B} independently represents a fluorine atom or an alkyl group (preferably an alkyl group having 1 to 3 carbon atoms), and the alkyl group may be substituted with a fluorine atom. In a case in which R⁴ includes —C(R^{4A})(R^{4B})—, R^{4A} and R^{4B} may bond to each other and thus faun a ring.

In a case in which R⁴ is a cycloalkylene group, cycloalkylene groups having 4 carbon atoms are preferred, and, among these, a perfluorocyclobutylene group is preferred.

Preferred examples of R⁴ include —C(R^{4A})(R^{4B})—, —O—, —CO—, and —SO₂—.

In Formula (II-2C), at least one of Ar¹, R⁴, and Y³ has a fluorine atom, and at least one of Ar', R⁴, and Y³ is preferably a perfluoro group.

In addition, the repeating unit represented by Formula (II-2C) may have one or more of each of Ar¹ and R⁴ in the repeating unit and may have two or more of each thereof.

The weight-average molecular weight of the polymer is preferably 2000 or higher, more preferably in a range of 2000 to 2,000,000, and still more preferably in a range of 5,000 to 400,000.

Specific examples of the second embodiment of the compound represented by Formula (II) include the following compounds and salts of the following compounds, but the second embodiment is not limited thereto. In addition, additionally, a perfluorocarbonsulfonic acid polymer represented by NAFION (registered trade mark) can also be used.

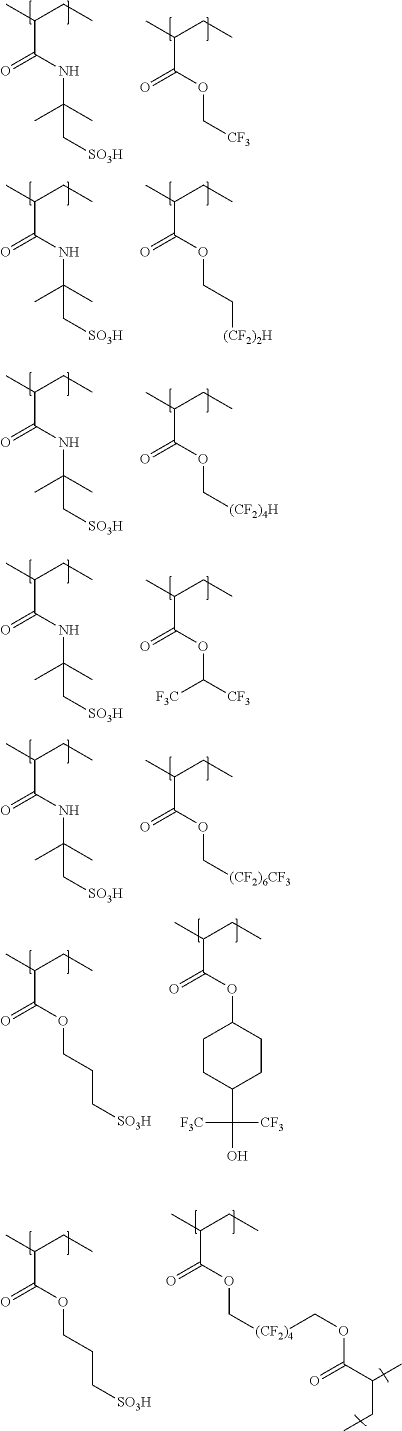

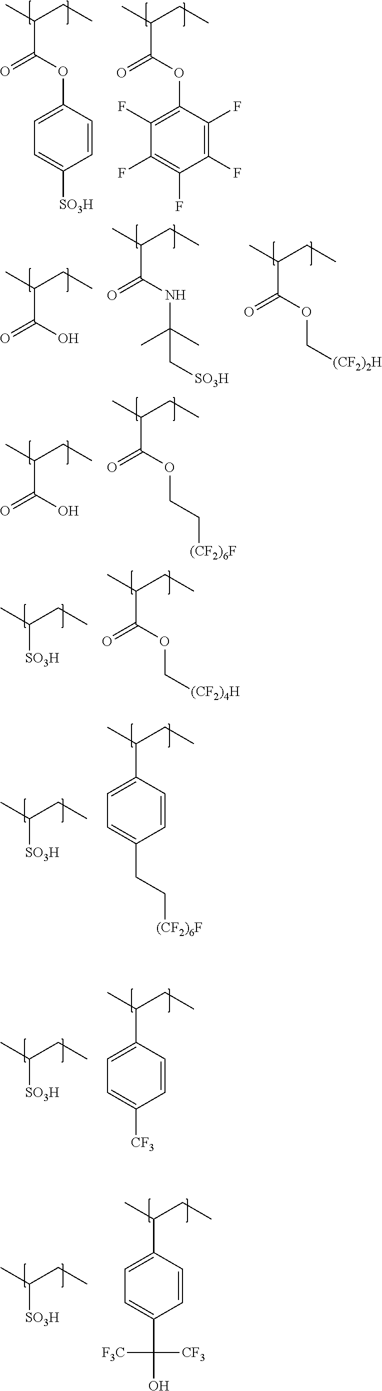

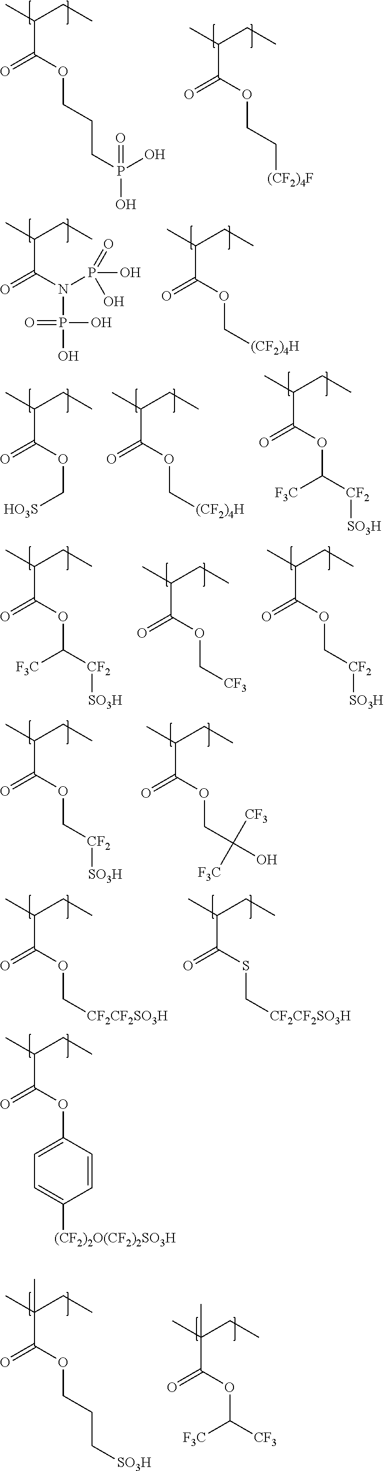

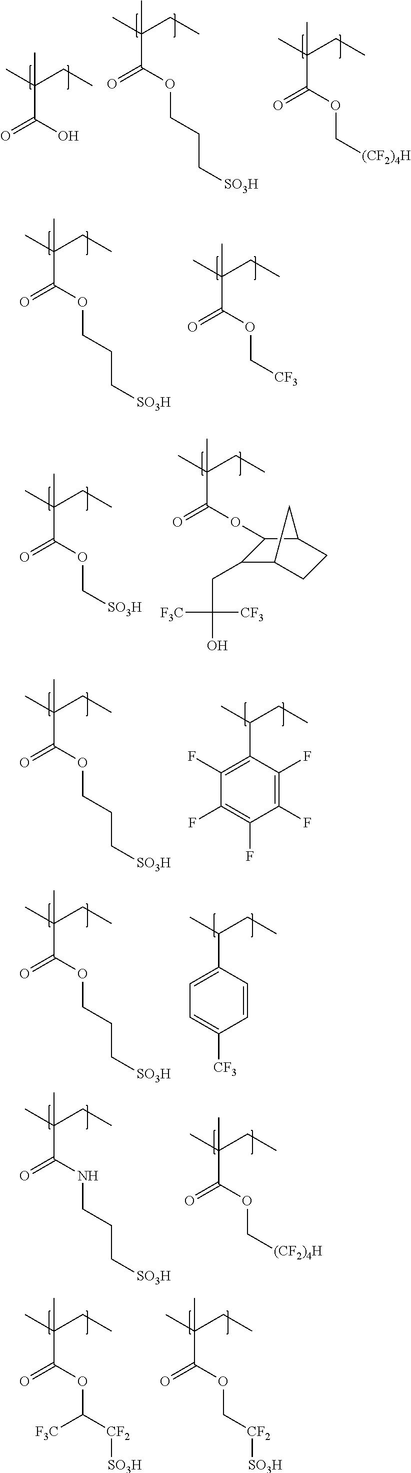

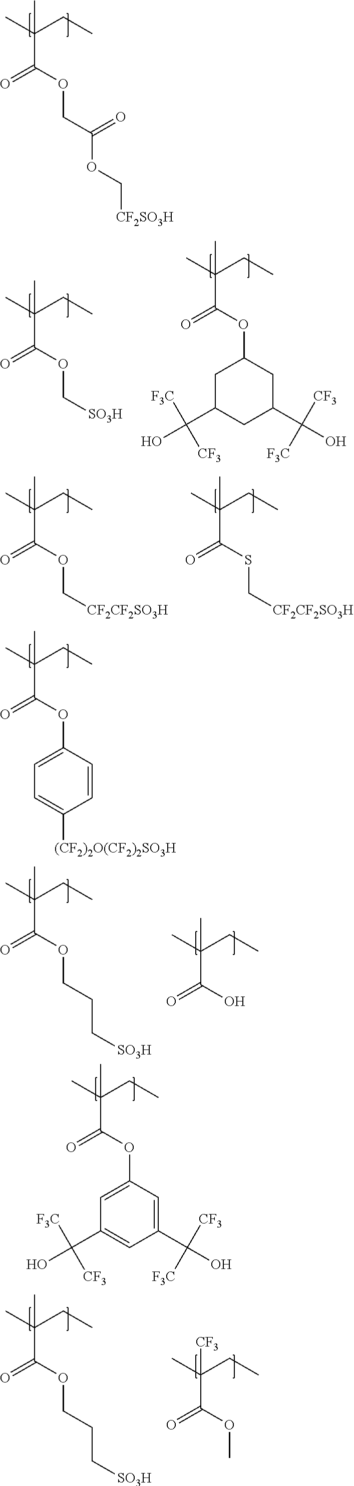

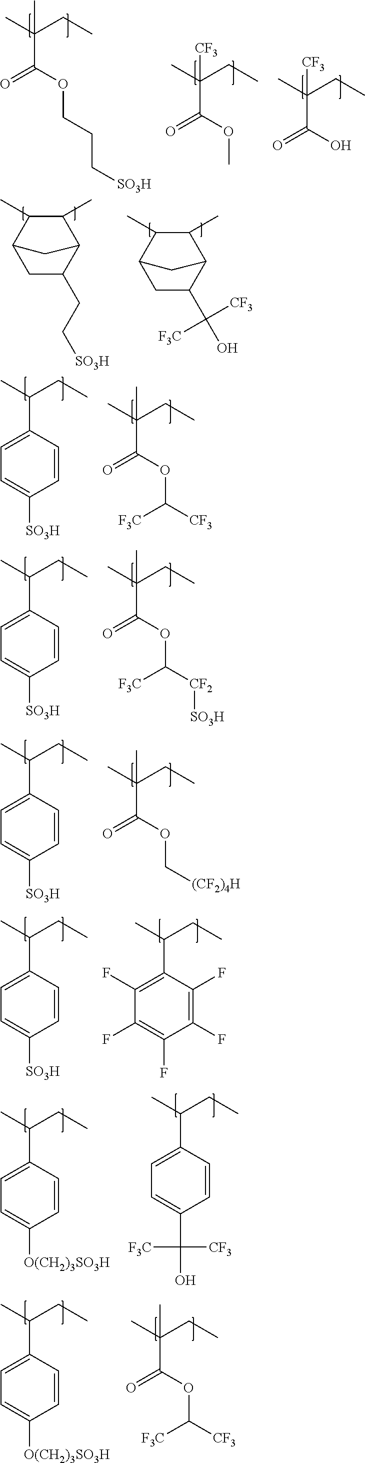

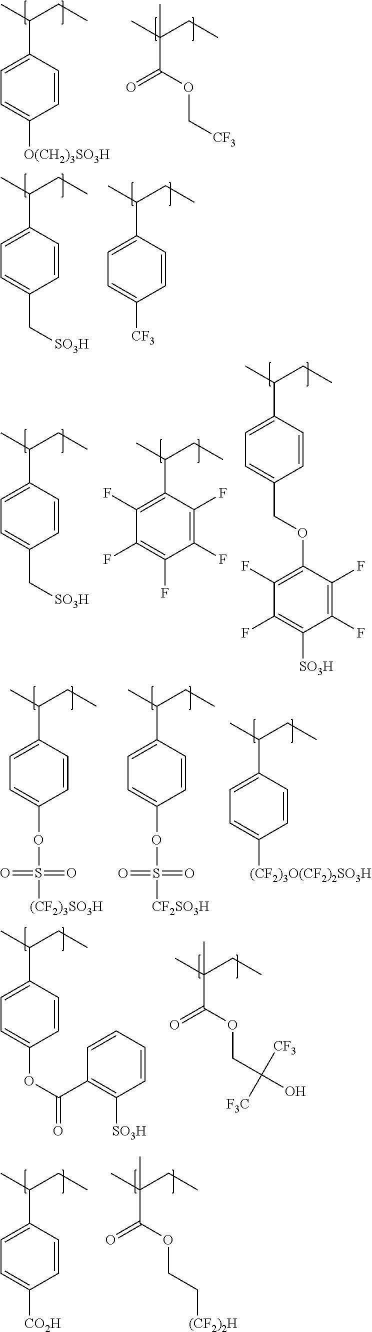

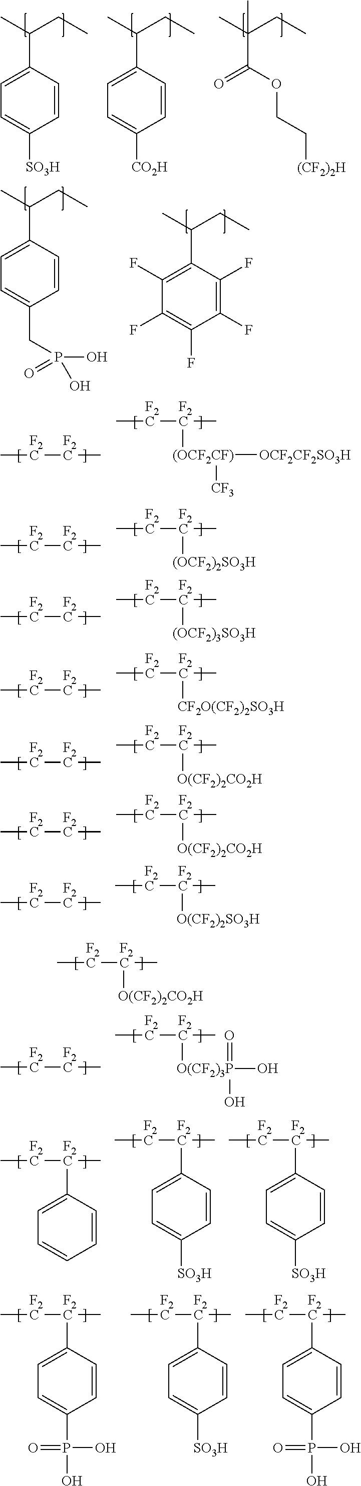

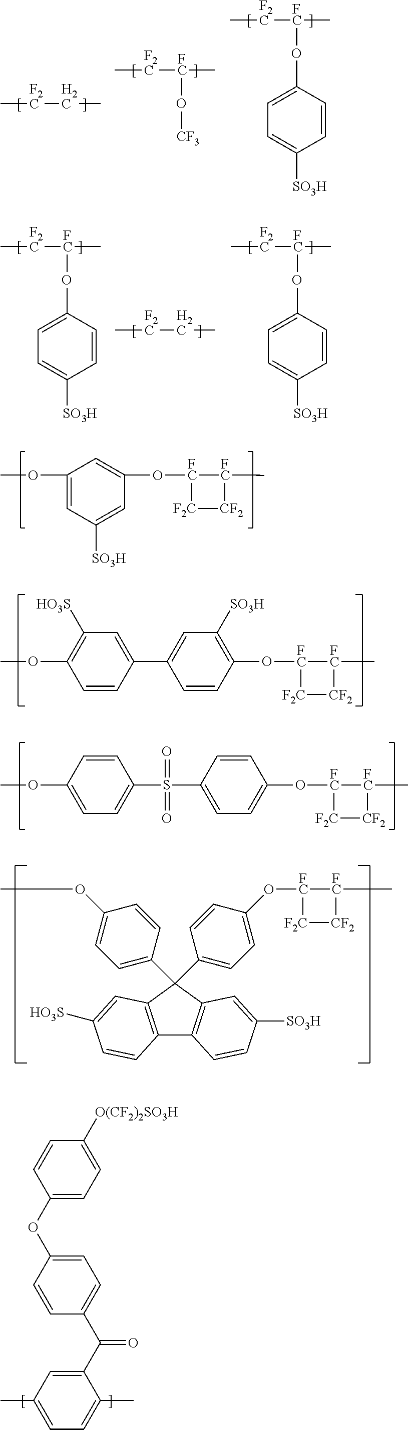

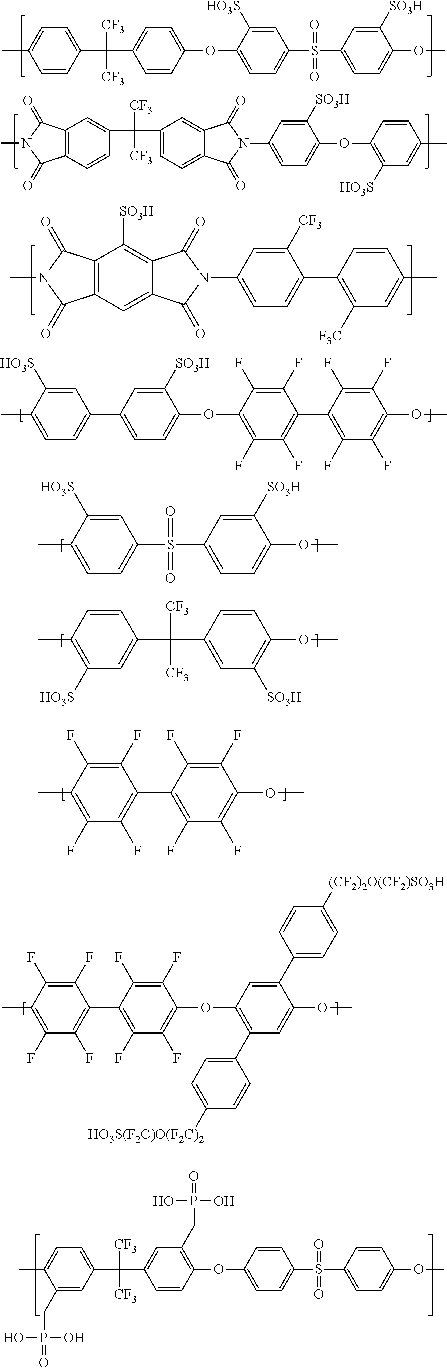

A third embodiment of the compound represented by Formula (II) is an aromatic group-containing polymer.

A preferred example of the aromatic group-containing polymer preferably includes a repeating unit represented by Formula (II-3) below.

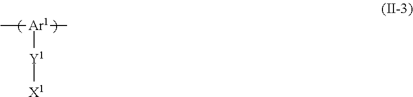

(In Formula (II-3), Ar¹ represents an aromatic hydrocarbon group and/or an aromatic heterocyclic group, Y¹ represents a single bond or a divalent linking group, and X¹ represents a coordination site to the metal component.)

In Formula (II-3), in a case in which Ar¹ represents an aromatic hydrocarbon group, the aromatic hydrocarbon group is preferably an aryl group. The number of carbon atoms in the aryl group is preferably in a range of 6 to 20, more preferably in a range of 6 to 15, and still more preferably in a range of 6 to 12. The aromatic hydrocarbon group may be a monocyclic ring or a polycyclic ring, but is preferably a monocyclic ring. Specifically, the aryl group is preferably a phenyl group, a naphthyl group, or a biphenyl group.

In Formula (II-3), in a case in which Ar¹ represents an aromatic heterocyclic group, the aromatic heterocyclic group is preferably an aromatic heterocyclic group having 2 to 30 carbon atoms. The aromatic heterocyclic group is preferably a monocyclic ring or a fused ring of a 5-membered ring or a 6-membered ring and more preferably a monocyclic ring or a fused ring having 2 to 8 fused portions. Examples of the hetero atom included in the heterocycle include nitrogen, oxygen, and sulfur atoms, and the hetero atom is more preferably nitrogen or oxygen.

Ar¹ may have a substituent T below other than —Y¹—X¹ in Formula (II-3).

Examples of the substituent T include an alkyl group, a polymerizable group (preferably a polymerizable group having a carbon-carbon double bond), a halogen atom (a fluorine atom, a chlorine atom, a bromine atom, or an iodine atom), a carboxylic acid ester group, a halogenated alkyl group, an alkoxy group, a methacryloyloxy group, an acryloyloxy group, an ether group, a sulfonyl group, a sulfide group, an amide group, an acyl group, a hydroxy group, a carboxylic acid group, and an aralkyl group, and an alkyl group (particularly, an alkyl group having 1 to 3 carbon atoms) is preferred.

Particularly, the aromatic group-containing polymer is preferably at least one polymer selected from a polyether sulfone-based polymer, a polysulfone-based polymer, a polyether ketone-based polymer, a polyphenylene ether-based polymer, a polyimide-based polymer, a polybenzimidazole-based polymer, a polyphenylene-based polymer, a phenol resin-based polymer, a polycarbonate-based polymer, a polyamide-based polymer, and a polyester-based polymer. Hereinafter, examples of the respective polymers will be described.

Polyether sulfone-based polymer: a polymer having a main chain structure /represented by (—O-Ph-SO₂-Ph-) (Ph represents a phenylene group, which shall apply below)

Polysulfone-based polymer: a polymer having a main chain structure represented by (—O-Ph-Ph-O-Ph-SO₂-Ph-)

Polyether ketone-based polymer: a polymer having a main chain structure represented by (—O-Ph-O-Ph-C(═O)-Ph-)

Polyphenylene ether-based polymer: a polymer having a main chain structure represented by (-Ph-O—, -Ph-S—)

Polyphenylene-based polymer: a polymer having a main chain structure represented by (-Ph-)

Phenol resin-based polymer: a polymer having a main chain structure represented by (-Ph(OH)—CH₂—)

Polycarbonate-based polymer: a polymer having a main chain structure represented by (-Ph-O—C(═O)—O—)

as the polyamide-based polymer, for example, a polymer having a main chain structure represented by (—Ph-C(═O)—NH—)

as the polyester-based polymer, for example, a polymer having a main chain structure represented by (-Ph-C(═O)O—)

Regarding the polyether sulfone-based polymer, the polysulfone-based polymer, and the polyether ketone-based polymer, for example, the main chain structures described in Paragraph “0022” of JP2006-310068A and Paragraph “0028” of JP2008-27890A can be referred to, and the content thereof is incorporated into the present specification.

Regarding the polyimide-based polymer, the main chain structures described in Paragraphs “0047” to “0058” of JP2002-367627A and “0018” and “0019” of JP2004-35891A can be referred to, and the content thereof is incorporated into the present specification.

In Formula (II-3), Y¹ is preferably a single bond. In a case in which Y¹ represents a divalent linking group, the divalent linking group is identical to Y¹ in Formula (II).

In a case in which Y¹ is a linear alkylene group, the number of carbon atoms in the linear alkylene group is preferably in a range of 1 to 20, more preferably in a range of 1 to 10, and still more preferably in a range of 1 to 6. In a case in which Y¹ is a branched alkylene group, the number of carbon atoms in the branched alkylene group is preferably in a range of 3 to 20, more preferably in a range of 3 to 10, and still more preferably in a range of 3 to 6. In a case in which Y¹ is a cyclic alkylene group, the cyclic alkylene group may be either a monocyclic ring or a polycyclic ring. The number of carbon atoms in the cyclic alkylene group is preferably in a range of 3 to 20, more preferably in a range of 4 to 10, and still more preferably in a range of 6 to 10.

The arylene group is identical to that of a case in which the divalent linking group in Formulae (II-2A) to (II-2C) is an arylene group.

In Formula (II-3), the coordination site to the metal component which is represented by X¹ is identical to the above-described coordination site to the metal component, and the preferred range thereof is also identical.

Specific examples of the third embodiment of the compound represented by Formula (II) include the following compounds and compounds of a salt of the following acid groups, but the third embodiment is not limited thereto.

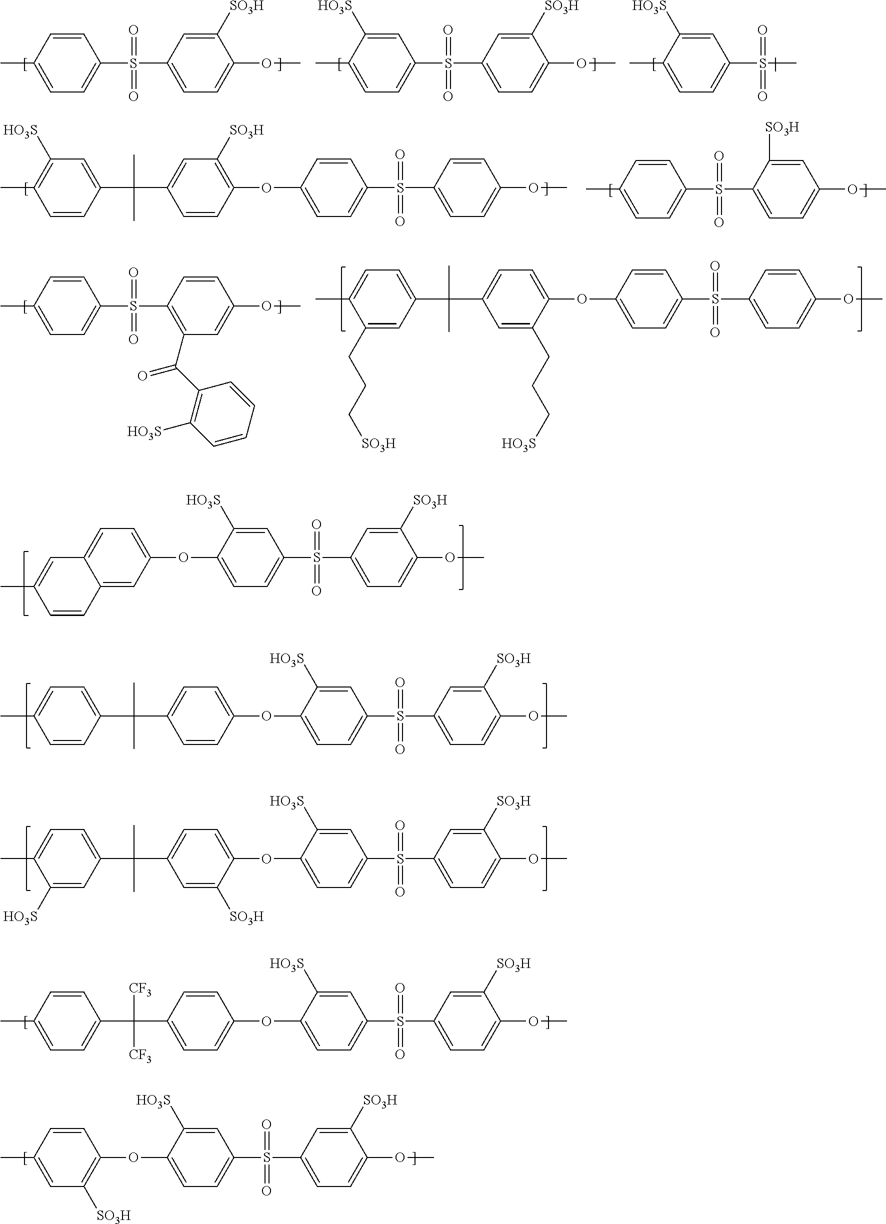

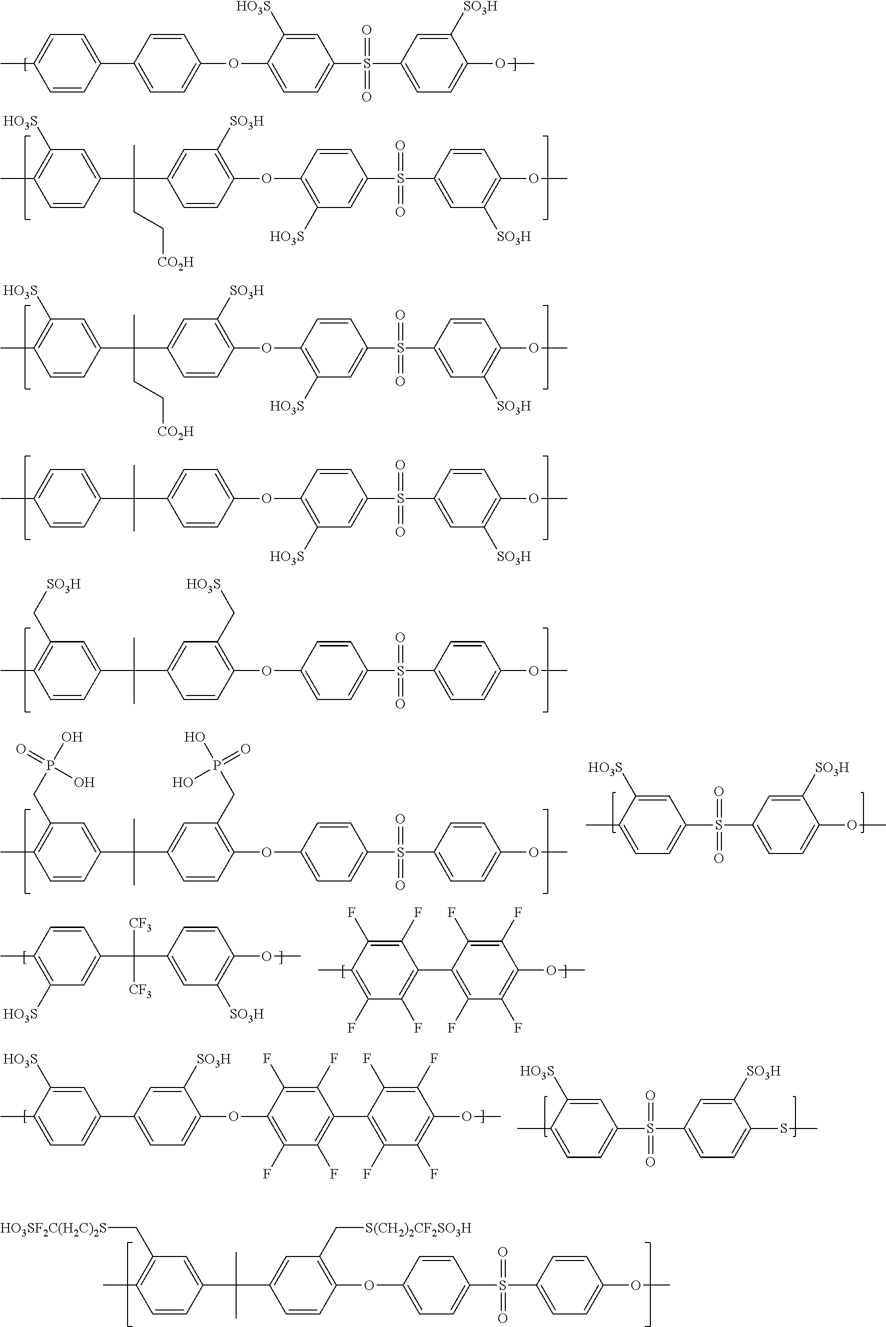

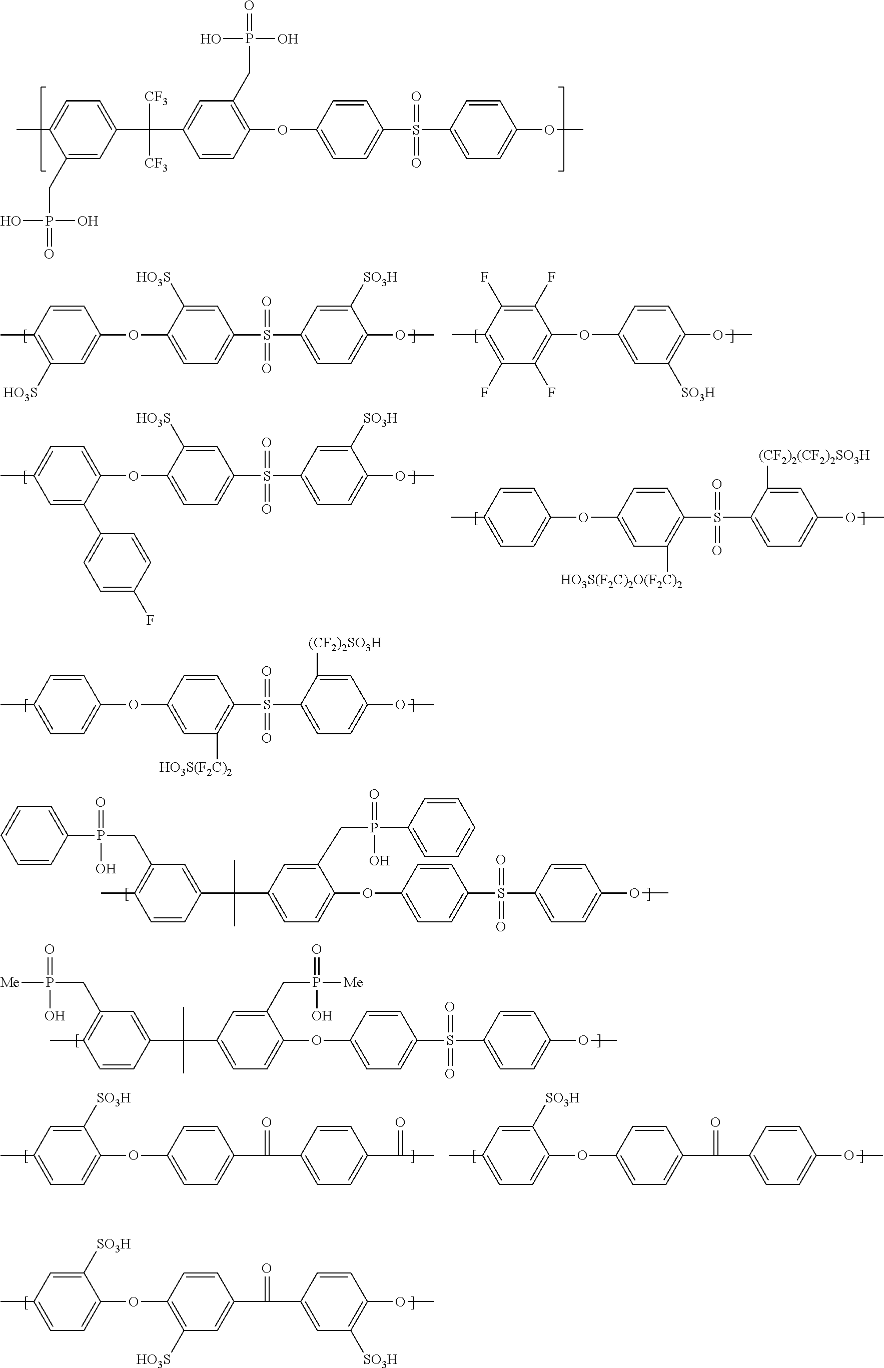

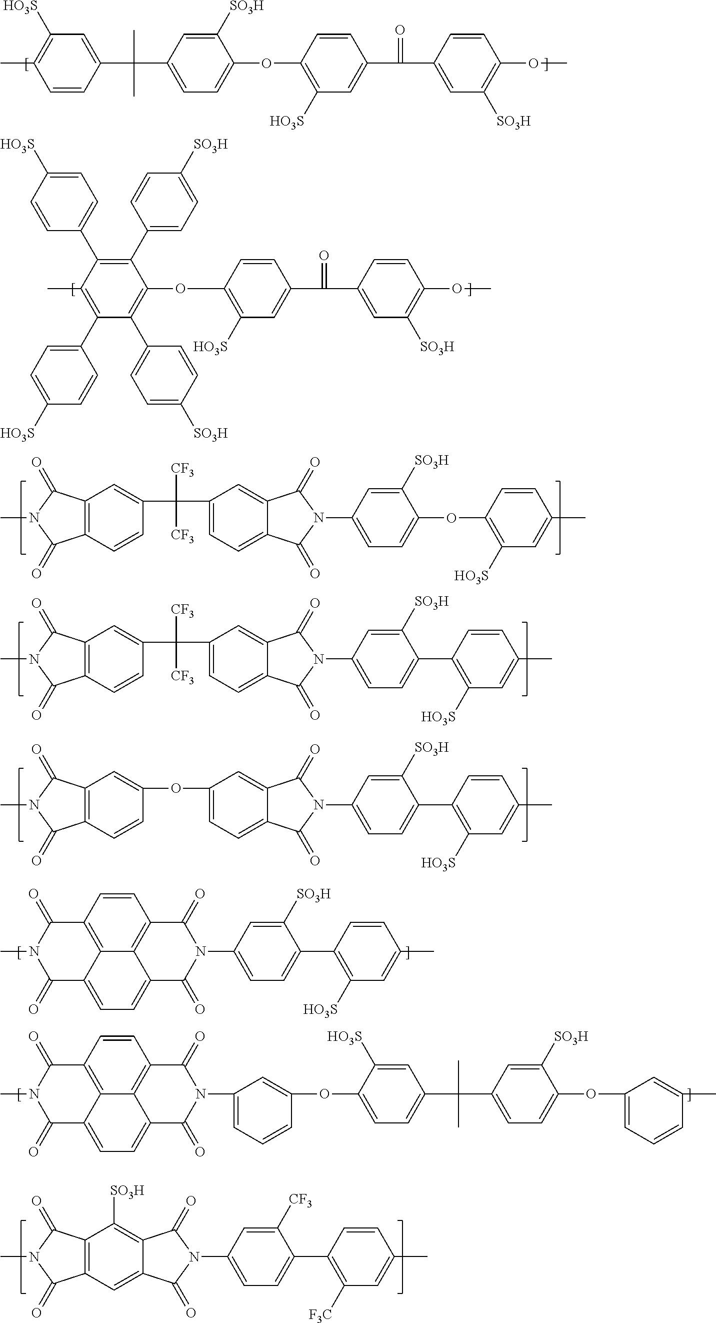

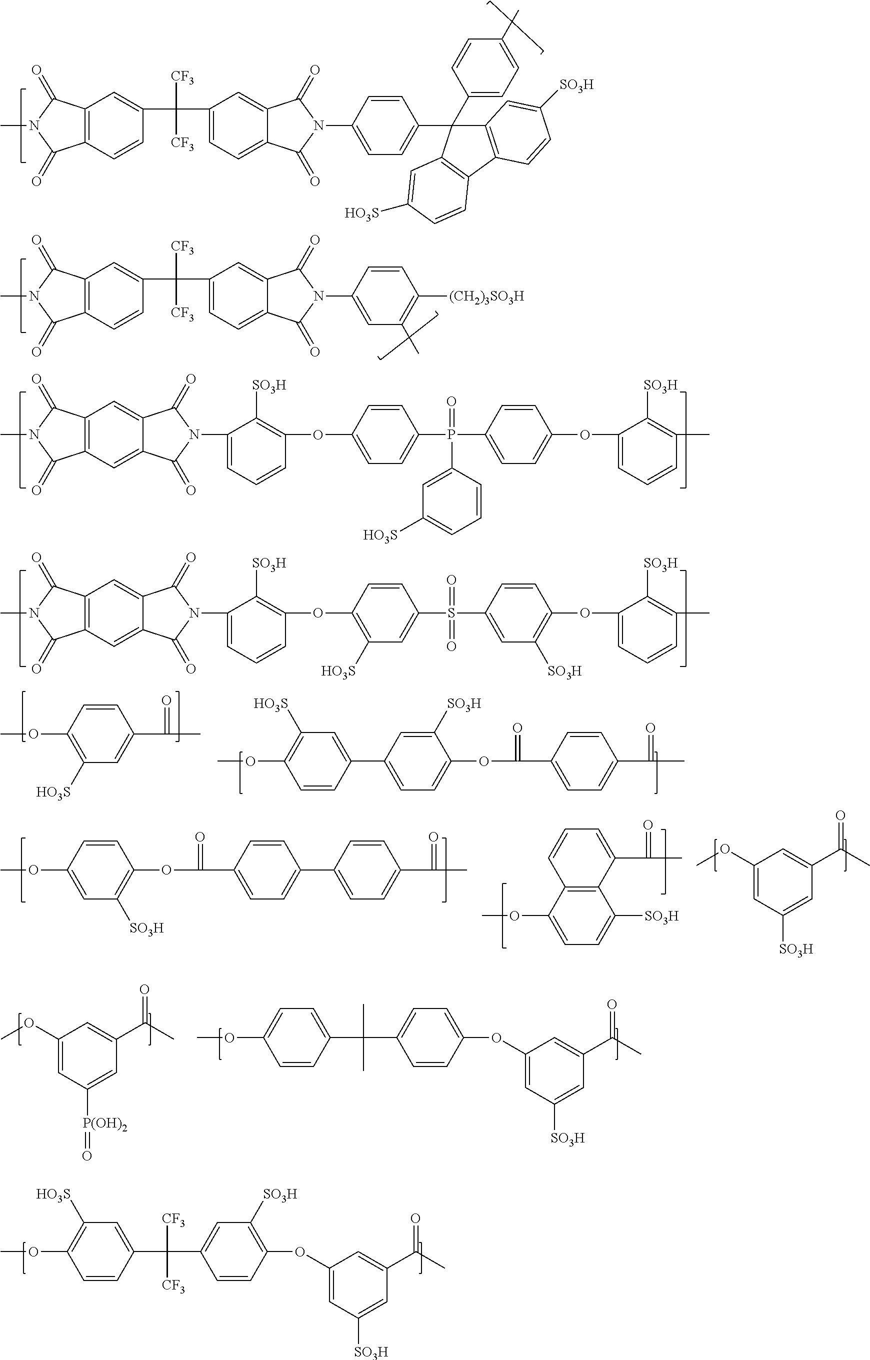

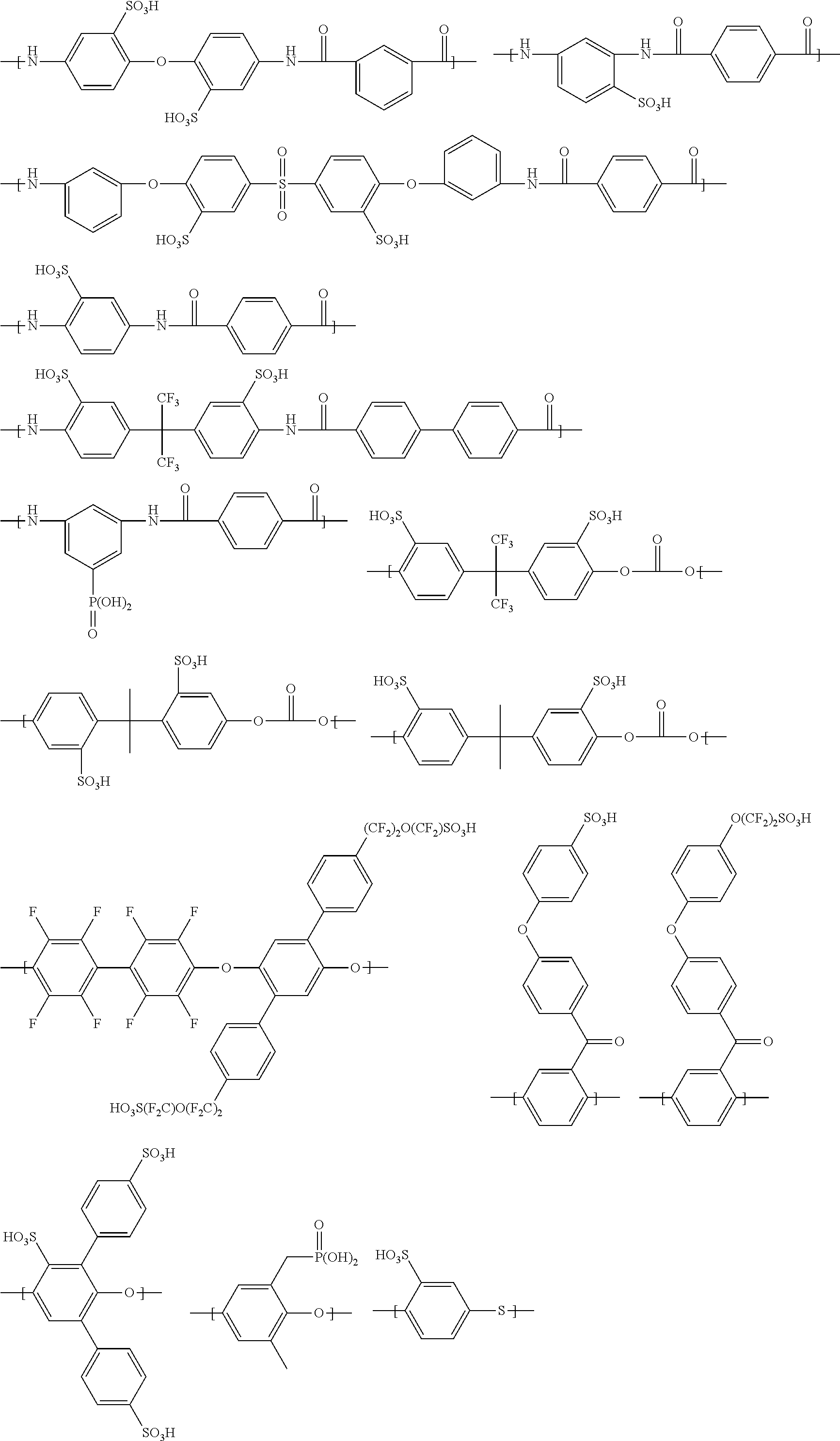

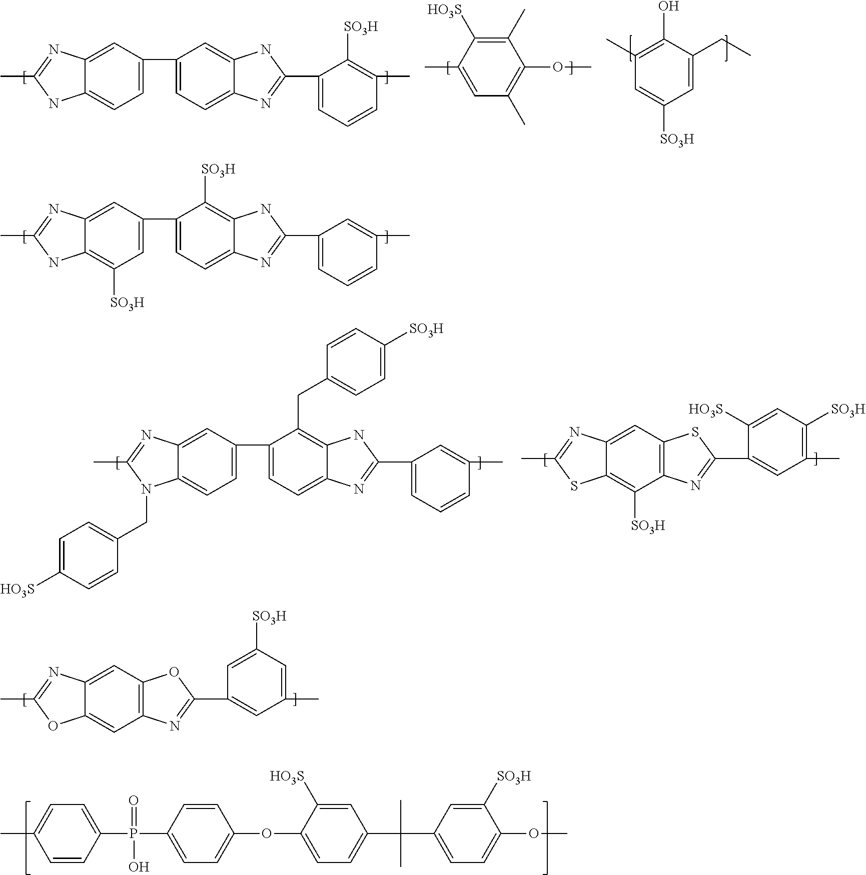

The near-infrared-absorbing composition of the present invention preferably includes a near-infrared-absorbing compound (C) having a partial structure represented by Formula (IV) below.

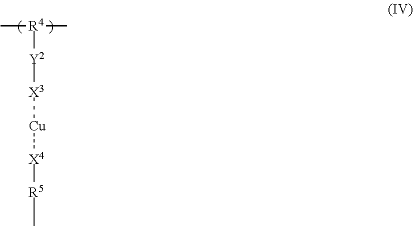

(In Formula (IV), R⁴ represents an organic group, R⁵ represents a divalent group, Y² represents a single bond or a divalent linking group, each of X³ and X⁴ independently represents a site at which a coordinate bond is formed with copper, and Cu represents a copper ion.)

In Formula (IV), R⁴ is identical to R² in (II), and the preferred range thereof is also identical.

In Formula (IV), R⁵ is identical to that of a case in which R¹ in (I) represents a divalent linking group, and the preferred range thereof is also identical.

In Formula (IV), Y² is identical to Y² in (II), and the preferred range thereof is also identical.

In Formula (IV), X³ is preferably an acid group ion site derived from an acid group and more preferably an acid group ion site derived from X¹ in Formula (I) (a group obtained by removing a hydrogen atom from X¹). In Formula (IV), X⁴ is preferably an acid group ion site derived from X² in Formula (II).

<Near-infrared-absorbing composition including near-infrared-absorbing compound (A2: low-molecular-weight type)>

<<Near-Infrared-Absorbing Compound (A2)>>

The near-infrared-absorbing compound (A2) is obtained from a reaction between a metal component and a compound represented by Formula (III).

The metal component is not particularly limited as long as the metal component is capable of reacting with the compound represented by Formula (III) and thus forming a compound exhibiting near-infrared-absorbing properties and is identical to the metal component used to obtain the above-described near-infrared-absorbing compound (A1: low-molecular-weight type), and the preferred range thereof is also identical.

The near-infrared-absorbing composition of the present invention may include at least one of the near-infrared-absorbing compound (A1: low-molecular-weight type), the near-infrared-absorbing compound (B: high-molecular-weight type), and the near-infrared-absorbing compound (A2: low-molecular-weight type), and, if necessary, another near-infrared-absorbing compound, a solvent, a curable compound, a binder polymer, a surfactant, a polymerization initiator, and other components may be formulated thereinto.

<<Another Near-Infrared-Absorbing Compound>>

In the composition of the present invention, for the purpose of further improving a near-infrared-absorbing function, another near-infrared-absorbing compound other than the near-infrared-absorbing compound (A1), the near-infrared-absorbing compound (B), and the near-infrared-absorbing compound (A2) (hereinafter, also referred to as near-infrared-absorbing compounds used in the present invention) may be formulated. The another near-infrared-absorbing compound is not particularly limited as long as the another near-infrared-absorbing compound has a maximum absorption wavelength in a range of generally 700 nm to 2500 nm and preferably 700 nm to 1000 nm (near-infrared range).

The another near-infrared-absorbing compound is preferably a copper compound and more preferably a copper complex. In addition, in a case in which the another near-infrared-absorbing compound is formulated into the composition, the ratio (mass ratio) between the near-infrared-absorbing compound and the another near-infrared-absorbing compound which are used in the present invention is preferably in a range of 60:40 to 95:5 and more preferably in a range of 70:30 to 90:10.

In a case in which the another near-infrared-absorbing compound is a copper complex, a ligand L to be coordinated to copper is not particularly limited as long as the ligand is capable of forming a coordinate bond with a copper ion, and examples thereof include compounds having a sulfonic acid, a carboxylic acid, a phosphoric acid, a phosphoric acid ester, a phosphonic acid, a phosphonic acid ester, a phosphinic acid, a substituted phosphinic acid, a carbonyl (ester, ketone), an amine, an amide, a sulfone amide, urethane, urea, an alcohol, or a thiol.

Specific examples of the copper complex include phosphorus-containing copper compounds, sulfonic acid copper compounds, and copper compounds represented by Formula (A). Regarding the phosphorus-containing copper compound, specifically, for example, the compounds described in Row 27 on Page 5 to Row 20 on Page 7 in W02005/030898A can be referred to, and the content thereof is incorporated into the specification of the present application.

Examples of the copper complex include copper complexes represented by Formula (A) below.

Cu(X)ₙ₁ Formula (A)

In Formula (A), X represents a ligand coordinated to copper, and each of n1's independently represents an integer from 1 to 6.

The ligand X is a coordination site which is coordinated to copper and has, for example, a substituent including C, N, O, and S as an atom capable of being coordinated to copper and more preferably has a group having a lone electron pair such as N, O, or S. The number of kinds of the coordination sites in the molecule is not limited to one and may be two or more, and the coordination site may or may not be dissociated.

The copper complex is a copper compound in which a copper central metal is coordinated with a ligand, and copper is generally divalent copper. The copper complex can be obtained by, for example, mixing, and reacting, a compound or a salt thereof which serves as the ligand with the copper component.

The compound or the salt thereof which serves as the ligand preferably includes a coordination site (for example, a coordination site to be coordinated with an anion or a coordination site to be coordinated with a lone electron pair), and preferred examples thereof include organic acid compounds (for example, a sulfonic acid compound and a carboxylic acid compound), salts thereof, and the like.

Particularly, a sulfonic acid compound represented by Formula (J) below or a salt thereof is preferred.

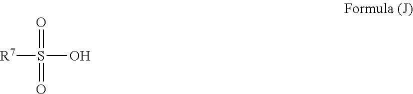

In Formula (J), R⁷ represents a monovalent organic group.

A specific monovalent organic group is not particularly limited, and examples thereof include linear, branched, or cyclic alkyl groups, alkenyl group, and aryl groups. Here, these groups may be groups through a divalent linking group (for example, an alkylene group, a cycloalkylene group, an arylene group, —O—, —S—, —CO—, —C(═O)O—, —OCO—, —SO₂—, —NR—(R represents a hydrogen atom or an alkyl group), or the like). In addition, the monovalent organic group may have a substituent.

The linear or branched alkyl group is preferably an alkyl group having 1 to 20 carbon atoms, more preferably an alkyl group having 1 to 12 carbon atoms, and still more preferably an alkyl group having 1 to 8 carbon atoms.

The cyclic alkyl group may be either a monocyclic ring or a polycyclic ring. The cyclic alkyl group is preferably a cycloalkyl group having 3 to 20 carbon atoms, more preferably a cycloalkyl group having 4 to 10 carbon atoms, and still more preferably a cycloalkyl group having 6 to 10 carbon atoms. The alkenyl group is preferably an alkenyl group having 2 to 10 carbon atoms, more preferably an alkenyl group having 2 to 8 carbon atoms, and still more preferably an alkenyl group having 2 to 4 carbon atoms.

The aryl group is preferably an aryl group having 6 to 18 carbon atoms, more preferably an aryl group having 6 to 14 carbon atoms, and still more preferably an aryl group having 6 to 10 carbon atoms.

Examples of the alkylene group, the cycloalkylene group, and the arylene group which are divalent linking groups include divalent linking groups derived by removing one hydrogen atom from the alkyl group, the cycloalkyl group, and the aryl group.

Examples of the substituent that the monovalent organic group may have include alkyl groups, polymerizable groups (for example, a vinyl group, a (meth)acryloyl group, an epoxy group, an oxetane group, and the like), halogen atoms, carboxylic acid groups, carboxylic acid ester groups (for example, —CO₂CH₃ and the like), hydroxyl groups, amide groups, halogenated alkyl groups (for example, a fluoroalkyl group and a chloroalkyl group), and the like.

The molecular weight of the sulfonic acid compound represented by Formula (J) below or a salt thereof is preferably in a range of 80 to 750, more preferably in a range of 80 to 600, and still more preferably in a range of 80 to 450.

Specific examples of the sulfonic acid compound represented by Formula (J) will be illustrated below, but the sulfonic acid compound is not limited thereto.

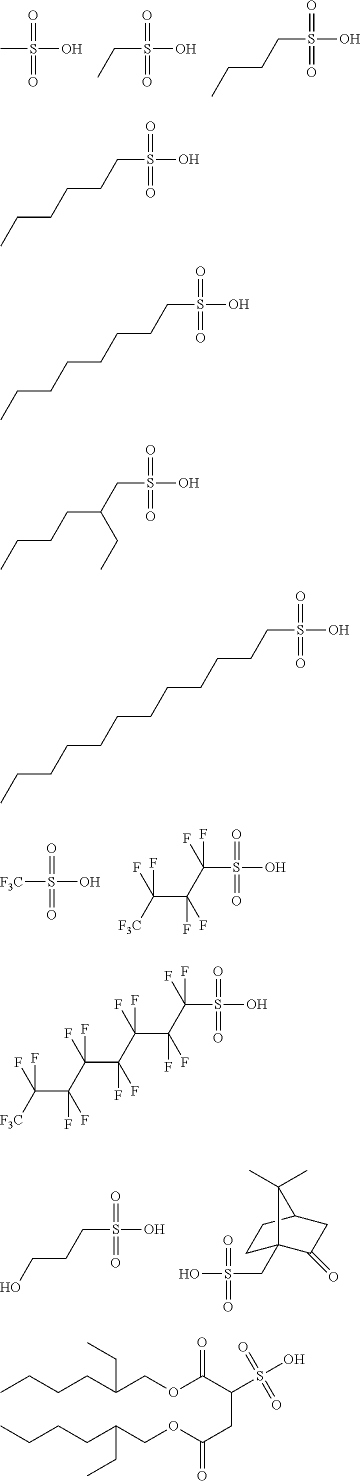

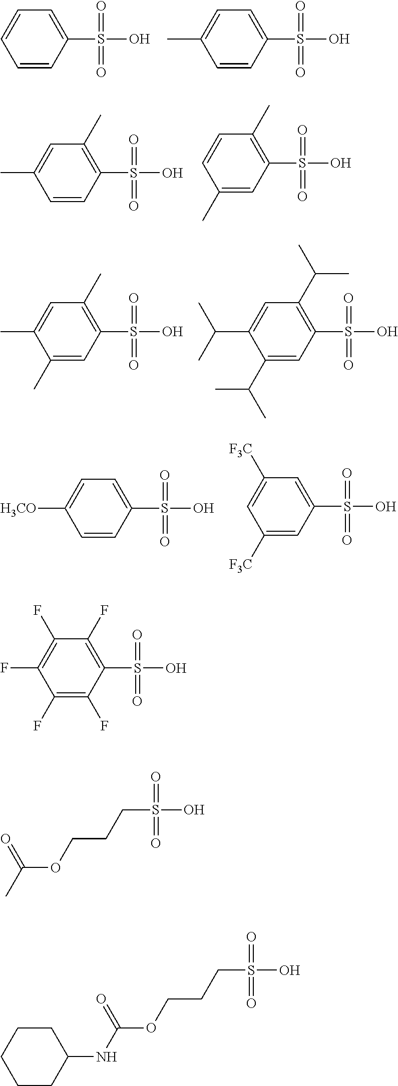

As the sulfonic acid compound, a commercially available sulfonic acid can also be used and can also be synthesized with reference to a well-known method. Examples of the salt of the sulfonic acid compound include metal salts, and specific examples thereof include sodium salts, potassium salts, and the like.

As the copper compound, in addition to the above-described copper compound, a copper compound for which a carboxylic acid is used as a ligand may be used. For example, a compound represented by Formula (K) below can be used.

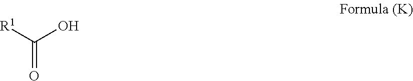

In Formula (K), R¹ represents a monovalent organic group. The monovalent organic group is not particularly limited and is identical to, for example, the monovalent organic group in Formula (J).

Specific examples of the compound represented by Formula (K) below will be illustrated below, but the compound is not limited thereto.

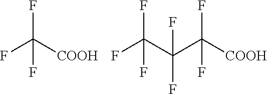 [SMILES: O=C(O)C(F)(F)F ; O=C(O)C(F)(F)C(F)(F)C(F)(F)F]

The composition of the present invention may include inorganic fine particles as another near-infrared-absorbing compound. Only one kind of inorganic fine particles may be used or two or more kinds of inorganic fine particles may be used.

The inorganic fine particles refer to particles that play a role of shielding (absorbing) infrared rays. The inorganic fine particles are preferably at least one selected from the group consisting of metal oxide particles and metal particles in tetuis of more favorable infrared shielding properties.

Examples of the inorganic fine particles include metal oxide particles such as indium tin oxide (ITO) particles, antimony tin oxide (ATO) particles, particles of zinc oxide which may be doped with aluminum (ZnO which may be doped with aluminum), fluorine-doped tin dioxide (F-doped SnO₂) particles, and niobium-doped titanium dioxide (Nb-doped TiO₂) and metal particles such as silver (Ag) particles, gold (Au) particles, copper (Cu) particles, and nickel (Ni) particles. Meanwhile, in order to satisfy both infrared shielding properties and photolithographic properties, inorganic fine particles having a high transmittance at an exposure wavelength (365 nm to 405 nm) are desired and indium tin oxide (ITO) particles or antimony tin oxide (ATO) particles are preferred.

The shapes of the inorganic fine particles are not particularly limited, may be any of non-spherical and spherical, and may be sheet shapes, wire shapes, or tube shapes.

In addition, as the inorganic fine particles, a tungsten oxide-based compound can be used and, specifically, the inorganic fine particles are more preferably a tungsten oxide-based compound represented by General Formula (Composition Formula) below.

MₓW_{y}O_{z}

M represents a metal, W represents tungsten, and O represents oxygen.

0.001≦x/y≦1.1

2.2≦z/y≦3.0

Examples of the metal M include alkali metals, alkaline earth metals, Mg, Zr, Cr, Mn, Fe, Ru, Co, Rh, Ir, Ni, Pd, Pt, Cu, Ag, Au, Zn, Cd, Al, Ga, In, Tl, Sn, Pb, Ti, Nb, V, Mo, Ta, Re, Be, Hf, Os, and Bi. The metal M is preferably an alkali metal, preferably Rb or Cs, and more preferably Cs. The number of the metals M may be one or more.

When x/y is 0.001 or more, it is possible to sufficiently shield infrared rays and, when x/y is 1.1 or less, it is possible to more reliably avoid the generation of impurity phases in the tungsten oxide-based compound.

When z/y is 2.2 or more, it is possible to further improve chemical stability as a material and, when z/y is 3.0 or less, it is possible to sufficiently shield infrared rays.

The metal oxide is preferably cesium tungsten oxide.

Specific examples of the tungsten oxide-based compound include Cs_{0.33}WO₃, Rb_{0.33}WO₃, K_{0.33}WO₃, Ba_{0.33}WO₃, and the like, Cs_{0.33}WO₃ or Rb_{0.33}WO₃ is preferred, and Cs_{0.33}WO₃ is more preferred.

The metal oxide preferably has a fine particle form. The average particle diameter of the metal oxide is preferably 800 nm or less, more preferably 400 nm or less, and still more preferably 200 nm or less. When the average particle diameter is in the above-described range, the metal oxide is not capable of easily shielding visible light through light scattering and thus it is possible to more reliably transmit light in the visible light range. From the viewpoint of avoiding light scattering, the average particle diameter is preferably small; however, in consideration of ease of handling during the production of the metal oxide, the average particle diameter of the metal oxide is generally 1 nm or more.

The tungsten oxide-based compound can be produced in a form of, for example, a dispersion of tungsten fine particles such as YMF-02, YMF-02A, YMS-01A-2, or YMF-10A-1 manufactured by Sumitomo Metal Mining Co., Ltd.

The content of the metal oxide is preferably in a range of 0.01% by mass to 30% by mass, more preferably in a range of 0.1% by mass to 20% by mass, and still more preferably in a range of 1% by mass to 10% by mass in relation to the total solid content mass of the composition including the metal oxide.

<Solvent>

Regarding a solvent used in the present invention, there is no particular limitation, any solvent can be appropriately selected depending on the purpose as long as the solvent is capable of uniformly dissolving or dispersing the respective components of the composition of the present invention, and preferred examples thereof include aqueous solvents such as water and alcohols (for example, ethanol). In addition, additional preferred examples of the solvent used in the present invention include organic solvents, alcohols, ketones, ethers, esters, aromatic hydrocarbons, halogenated hydrocarbons, dimethylformamide, dimethylacetamide, dimethylsulfoxide, sulfolane, and the like. Only one solvent may be used, or two or more solvents may be jointly used.

Specific examples of the alcohols, the aromatic hydrocarbons, and the halogenated hydrocarbons include those described in Paragraph “0136” and the like in JP2012-194534A and the content thereof is incorporated into the specification of the present application. In addition, specific examples of the esters, the ketones, and the ethers include those described in Paragraph “0497” in JP2012-208494A (Paragraph “0609” in the corresponding US2012/0235099A) and further include n-amyl acetate, ethyl acetate, ethyl propionate, dimethyl phthalate, ethyl benzoate, methyl sulfate, acetone, methyl isobutyl ketone, diethyl ether, ethylene glycol monobutyl ether acetate, cyclopentanone, propylene glycol monomethyl ether, propylene glycol methyl ether acetate, and the like.

The content of the solvent is preferably in a range of 5% by mass to 60% by mass and more preferably in a range of 10% by mass to 40% by mass of the total solid contents of the composition of the present invention.

The composition of the present invention particularly preferably includes water. The content of water is preferably 10% by mass or higher, more preferably 20% by mass or higher, still more preferably 30% by mass or higher, and far still more preferably 40% by mass or higher of the composition of the present invention. Particularly, the content of water is preferably in a range of 40% by mass to 95% by mass and more preferably in a range of 50% by mass to 90% by mass of the composition of the present invention.

In a case in which the composition of the present invention includes a solvent other than water, the content of the solvent is preferably 5% by mass or higher of the composition of the present invention. Particularly, the content thereof is preferably in a range of 5% by mass to 50% by mass and more preferably in a range of 5% by mass to 30% by mass of the composition of the present invention. Only one solvent other than water may be used, or two or more solvents may be used.

In a case in which water and an organic solvent are jointly used as the solvents, the mass ratio between water and the organic solvent is preferably in a range of 0.1:99.9 to 30:70, more preferably in a range of 0.2:99.8 to 20:80, and still more preferably in a range of 0.5:99.5 to 10:90.

<Curable Compound>

The composition of the present invention may further include a curable compound. The curable compound may be a polymerizing compound or a non-polymerizing compound such as a binder. In addition, the curable compound may be a thermosetting compound or a photocross-linking compound and is preferably a thermosetting composition due to its high reaction rate.

<<Compound having polymerizable Group>>

The composition of the present invention may include a compound having a polymerizable group (hereinafter, in some cases, referred to as “polymerizing compound”). A group of such compounds is widely known in the corresponding industrial field and, in the present invention, these compounds can be used without any particular limitation. The compounds may have any chemical form of, for example, a monomer, an oligomer, a prepolymer, a polymer, and the like.

<<Polymerizing monomer and polymerizing oligomer>>

The composition of the present invention may include a monomer having a polymerizable group (polymerizing monomer) or an oligomer having a polymerizable group (polymerizing oligomer) (hereinafter, in some cases, the polymerizing monomer and the polymerizing oligomer will be collectively referred to as “the polymerizing monomer and the like”) as the polymerizing compound.

Examples of the polymerizing monomer and the like include unsaturated carboxylic acids (for example, acrylic acid, methacrylic acid, itaconic acid, crotonic acid, isocrotonic acid, maleic acid, and the like), esters thereof, and amides thereof and esters of an unsaturated carboxylic acid and an aliphatic polyhydric alcohol compound and amides of an unsaturated carboxylic acid and an aliphatic polyvalent amine compound are preferred. In addition, addition reactants of an unsaturated carboxylic acid ester or amide having a nucleophilic substituent such as a hydroxyl group, an amino group, or a mercapto group and a monofunctional or polyfunctional isocyanate or epoxy, dehydration and condensation reactants of an unsaturated carboxylic acid ester or amide and a monofunctional or polyfunctional carboxylic acid, and the like are also preferably used. In addition, addition reactants of an unsaturated carboxyl ester or an amide having an electrophilic substituent such as an isocyanate group or an epoxy group and a monofunctional or polyfunctional alcohol, amine, or thiol and, furthermore, substitution reactants of an unsaturated carboxylic acid ester or amide having a desorbable substituent such as a halogen group or a tosyloxy group and a monofunctional or polyfunctional alcohol, amine, or thiol are also preferred. As additional examples, it is also possible to use a group of compounds substituted with an unsaturated phosphonic acid, a vinyl benzene derivative such as styrene, a vinyl ether, an aryl ether, or the like instead of the above-described unsaturated carboxylic acid.

As the specific compounds thereof, the compounds described in Paragraphs “0095” to “0108” in JP2009-288705A can be preferably used even in the present invention.

In addition, as the polymerizing monomer and the like, it is possible to use a compound having an ethylenic unsaturated group which has at least one addition-polymerizing ethylene group and a boiling point of 100° C. or higher at normal pressure, and it is also possible to use a monofunctional (meth)acrylate, a difunctional (meth)acrylate, and a tri- or higher-functional (meth)acrylate (for example, tri- to hexafunctional (meth)acrylate).

Examples thereof include monofunctional acrylates or methacrylates such as polyethylene glycol mono(meth)acrylate, polypropylene glycol mono(meth)acrylate, and phenoxyethyl (meth)acrylate; and substances obtained by adding ethylene oxide or propylene oxide to a polyfunctional alcohol such as polyethylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol penta(meth)acrylate, dipentaerythritol hexa(meth)acrylate, hexanediol(meth)acrylate, trimethylolpropane tri(acryloyloxypropyl)ether, tri(acryloyloxyethyl) isocyanurate, glycerin, or trimethylolethane and then (meth)acrylating the mixture.

The polymerizing compound is preferably ethyleneoxy-denatured pentaerythritol tetraacrylate (NK ester ATM-35E as a commercially available product: manufactured by Shin-Nakamura Chemical Co., Ltd.), dipentaerythritol triacrylate (KAYARAD D-330 as a commercially available product; manufactured by Nippon Kayaku Co., Ltd.), dipentaerythritol tetraacrylate (KAYARAD D-320 as a commercially available product; manufactured by Nippon Kayaku Co., Ltd.), dipentaerythritol penta(meth)acrylate (KAYARAD D-310 as a commercially available product; manufactured by Nippon Kayaku Co., Ltd.), dipentaerythritol hexa(meth)acrylate (KAYARAD DPHA as a commercially available product; manufactured by Nippon Kayaku Co., Ltd.), and structures in which the above-described (meth)acryloyl groups are bonded to each other through ethylene glycol and propylene glycol residues. In addition, the oligomer types thereof can also be used. It is also possible to use the compounds described in Paragraphs “0248” to “0251” in JP2007-269779A in the present invention.

Examples of the polymerizing monomer and the like include the polymerizing monomer and the like described in Paragraph “0477” in JP2012-208494A (Paragraph “0585” in the corresponding US2012/0235099A) and the content thereof is incorporated into the specification of the present application. In addition, DIGLYCERIN EO (ethylene oxide)-denatured (meth)acrylate (M-460 as a commercially available product; manufactured by Toagosei Co., Ltd.) can be used. Pentaerythritol tetraacrylate (manufactured by Shin-Nakamura Chemical Co., Ltd., A-TMMT) and 1,6-hexanediol diacrylate (manufactured by Nippon Kayaku Co., Ltd., KAYARAD HDDA) can also be used. The oligomer types thereof can also be used.

Examples thereof include RP-1040 (manufactured by Nippon Kayaku Co., Ltd.).

In the present invention, as the monomer having an acid group, it is possible to use an ester of an aliphatic polyhydroxy compound and an unsaturated carboxylic acid which is a polyfunctional monomer provided with an acid group by reacting an unreacted hydroxyl group in an aliphatic polyhydroxy compound and a non-aromatic carboxy anhydride. Examples of commercially available products thereof include ARONIX series M-305, M-510, M-520, and the like which are polybasic acid-denatured acryl oligomers manufactured by Toagosei Co., Ltd.

The acid value of the polyfunctional monomer having an acid group is in a range of 0.1 mg-KOH/g to 40 mg-KOH/g and particularly preferably in a range of 5 mg-KOH/g to 30 mg-KOH/g. In a case in which two or more polyfunctional monomers having different acid groups are jointly used or polyfunctional monomers having no acid groups are jointly used, it is essentially required to prepare the polyfunctional monomers so that all the acid values of the polyfunctional monomers fall within the above-described range.

<<Polymer having polymerizable Group in Side Chain>>

The second aspect of the composition of the present invention may be an aspect in which a polymer having a polymerizable group in a side chain is provided as the polymerizing compound. Examples of the polymerizable group include an ethylenic unsaturated double-bonded group, an epoxy group, and an oxetanyl group.

<<Compound having epoxy Group or oxetanyl Group>>

A third aspect of the present invention may be an aspect in which a compound having an epoxy group or an oxetanyl group is included as the polymerizing compound. Examples of the compound having an epoxy group or an oxetanyl group include polymers having an epoxy group in the side chain and polymerizing monomers or oligomers having two or more epoxy groups in the molecule and specific examples thereof include bisphenol A-type epoxy resins, bisphenol F-type epoxy resins, phenol novolac-type epoxy resins, cresol novolac-type epoxy resins, and aliphatic epoxy resins. In addition, examples thereof also include a monofunctional or polyfunctional glycidyl ether compound.

As the above-described compound, a commercially available product may be used or the compound can be obtained by introducing an epoxy group into the side chain in the polymer.

Regarding the commercially available product, for example, the description of Paragraphs “0191” and the like in JP2012-155288A can be referred to and the content thereof is incorporated into the specification of the present application by reference.

Examples of the commercially available product include polyfunctional aliphatic glycidyl ether compounds such as DENACOL EX-212L, EX-214L, EX-216L, EX-321L, and EX-850L (all manufactured by Nagase ChemteX Corporation). The above-described products are low-chlorine products and EX-212, X-214, EX-216, EX-321, EX-850, and the like, which are not low-chlorine products, can also be used in a similar manner.

Additionally, examples thereof include ADEKA RESIN EP-4000S, ADEKA RESIN EP-4003S, ADEKA RESIN EP-4010S, ADEKA RESIN EP-4011S (all manufactured by Adeka Corporation), NC-2000, NC-3000, NC-7300, XD-1000, EPPN-501, EPPN-502 (all manufactured by Adeka Corporation), JER1031S, and the like.

Furthermore, examples of the commercially available product of the phenol novolac-type epoxy resins include JER-157S65, JER-152, JER-154, JER-157S70 (all manufactured by Mitsubishi Chemical Corporation), and the like.

Specific examples of the polymer having an oxetanyl group in the side chain and the above-described polymerizing monomer or oligomer having two or more oxetanyl groups in the molecule that can be used include ARON OXETANE OXT-121, OXT-221, OX-SQ, and PNOX (all manufactured by Toagosei Co., Ltd.).

In a case in which the compound is synthesized by introducing an epoxy group into the side chain of the polymer, an epoxy group can be introduced by causing an introduction reaction in an organic solvent using, for example, a tertiary amine such as triethylamine or benzylmethylamine, a quaternary ammonium salt such as dodecyltrimethylammonium chloride, tetramethylammonium chloride, or tetraethylammonium chloride, pyridine, triphenylphosphine, or the like as a catalyst at a reaction temperature in a range of 50° C. to 150° C. for several hours to several tens of hours. The amount of an alicyclic epoxy unsaturated compound introduced can be controlled so that the acid value of the obtained polymer falls into a range of 5 KOH.mg/g to 200 KOH.mg/g. In addition, the molecular weight can be set in a range of 500 to 5000000 and furthermore set in a range of 1000 to 500000 in terms of weight average.

As the epoxy unsaturated compound, a compound having a glycidyl group as the epoxy group such as glycidyl (meth)acrylate or allylglycidyl ether can be used. Regarding the above-described compound, for example, the description of Paragraph “0045” of JP2009-265518A can be referred to, and the content thereof is incorporated into the present specification for reference.

In the present invention, the composition preferably further includes a polymer having a cross-linking group such as an unsaturated double bond, an epoxy group, or an oxetanyl group at a side chain. In such a case, it is possible to further improve film-forming properties (suppression of cracking or warping) and humidity resistance when a cured film is produced. Specific examples of the polymer include the following polymers.

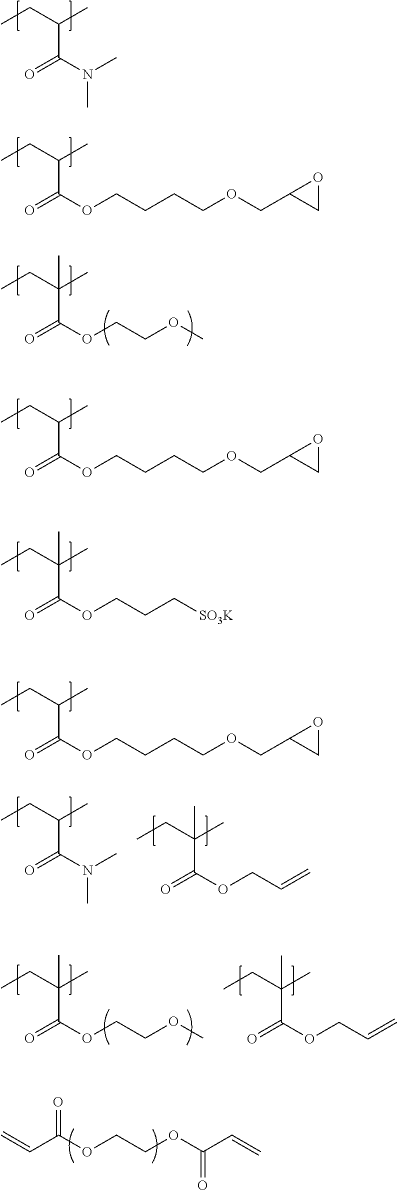

The amount of the curable compound added to the composition of the present invention can be set in a range of 1% by mass to 50% by mass, more preferably in a range of 1% by mass to 30% by mass, and particularly preferably in a range of 1% by mass to 10% by mass in relation to the total solid content excluding the solvent.

The number of the polymerizing compounds may be one or more and, in a case in which two or more polymerizing compounds are used, the total amount thereof needs to fall into the above-described range.

<Binder polymer>

The present invention may further include a binder polymer as necessary for the purpose of improving coating characteristics. As the binder polymer, an alkali-soluble resin can be used.

Regarding the alkali-soluble resin, the description of Paragraphs “0558” to “0571” and thereafter of JP2012-208494A (“0685” to “0700” in the specification of the corresponding US2012/0235099A) can be referred to, and the content thereof is incorporated into the present specification.

The content of the binder polymer in the present invention can be set to 80 mass % or lower of the total solid content of the composition, and can also be set to 50 mass % or lower, and furthermore, 30 mass % or lower.

<Surfactant>

The composition of the present invention may include a surfactant. Only one surfactant may be used or a combination of two or more surfactants may be used. The amount of the surfactant added can be set in a range of 0.0001% by mass to 2% by mass of the solid content of the composition of the present invention, and can be set in a range of 0.005% by mass to 1.0% by mass, and furthermore, in a range of 0.01% by mass to 0.1% by mass.

As the surfactant, a variety of surfactants such as a fluorine-based surfactant, a nonionic surfactant, a cationic surfactant, an anionic surfactant, and a silicone-based surfactant can be used.

Particularly, when the composition of the present invention includes at least any one of a fluorine-based surfactant and a silicone-based surfactant, the liquid characteristics (particularly, fluidity) are further improved when a coating fluid is produced, and thus it is possible to further improve the evenness of the coating thickness or liquid-saving properties.

That is, in a case in which a film is formed using a coating fluid to which the composition including at least any one of fluorine-based surfactants and silicone-based surfactants is applied, the surface tension between a surface to be coated and the coating fluid decreases and thus the wetting properties with respect to the surface to be coated are improved and the coating properties with respect to the surface to be coated are improved. Therefore, in a case in which a thin film having a thickness of approximately several micrometers is formed using a small amount of the fluid as well, the inclusion of the surfactant is effective since a film having a uniform thickness with little thickness variation is more preferably formed.

The content of fluorine in the fluorine-based surfactant can be set, for example, in a range of 3% by mass to 40% by mass.

Examples of the fluorine-based surfactant include MEGAFACE F171, MEGAFACE F172, MEGAFACE F173, MEGAFACE F176, MEGAFACE F177, MEGAFACE F141, MEGAFACE F 142, MEGAFACE F 143, MEGAFACE F 144, MEGAFACE R30, MEGAFACE F437, MEGAFACE F479, MEGAFACE F482, MEGAFACE F554, MEGAFACE F780, MEGAFACE R08 (manufactured by DIC Corporation), FLUORAD FC430, FLUORAD FC431, FLUORAD FC171 (manufactured by 3M Japan Limited.), SURFLON S-382, SURFLON S-141, SURFLON S-145, SURFLON SC-101, SURFLON SC-103, SURFLON SC-104, SURFLON SC-105, SURFLON SC1068, SURFLON SC-381, SURFLON SC-383, SURFLON 5393, SURFLON KH-40 (all manufactured by Asahi Glass Co., Ltd.), EFTOP EF301, EFTOP EF303, EFTOP EF351, EFTOP EF352 (all manufactured by Jemco Co., Ltd.), PF636, PF656, PF6320, PF6520, PF7002 (manufactured by OMNOVA Solution Inc.), and the like.

As the fluorine-based surfactant, a polymer having a fluoroaliphatic group can be used. Examples of the polymer having a fluoroaliphatic group include a fluorine-based surfactant having a fluoroaliphatic group, which is obtained from a fluoroaliphatic compound produced using a telomerization method (also referred to as a telomer method) or an oligomerization method (also referred to as an oligomer method).

Examples of a commercially available surfactant including a polymer having a fluoroaliphatic group in the present invention include the surfactants described in Paragraph “0552” in JP2012-208494A (“0678” in the specification of the corresponding US2012/0235099A) and the content thereof is incorporated into the specification of the present application. In addition, it is possible to use MEGAFACE F-781 (manufactured by Dainippon Ink and Chemicals), a copolymer of an acrylate (or methacrylate) having a C₆F₁₃ group, (poly(oxyethylene)) acrylate (or methacrylate), and (poly(oxypropylene)) acrylate (or methacrylate), a copolymer of an acrylate (or methacrylate) having a C₈F₁₇ group and (poly(oxyalkylene)) acrylate (or methacrylate), a copolymer of an acrylate (or methacrylate) having a C₈F₁₇ group, (poly(oxyethylene)) acrylate (or methacrylate), and (poly(oxypropylene)) acrylate (or methacrylate), or the like.

Specific examples of nonionic surfactants include the nonionic surfactants described in Paragraph “0553” (“0679” in the specification of the corresponding US2012/0235099A) and the like of JP2012-208494A, the content of which is incorporated into the specification of the present application.

Examples of the nonionic surfactants include polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkyl amines, glycerin fatty acid esters, oxyethylene oxypropylene block copolymers, acetylene glycol-based surfactants, acetylene-based polyoxyethylene oxides, and the like. The above-described surfactants can be used singly or two or more surfactants can be used.

Examples of specific commercially available products thereof include SURFYNOL 61, 82, 104, 104E, 104H, 104A, 104BC, 104DPM, 104PA, 104PG-50, 104S, 420, 440, 465, 485, 504, CT-111, CT-121, CT-131, CT-136, CT-141, CT-151, CT-171, CT-324, DF-37, DF-58, DF-75, DF-110D, DF-210, GA, OP-340, PSA-204, PSA-216, PSA-336, SE, SE-F, TG, DYNOL 604 (all manufactured by Nissin Chemical Co., Ltd. and Air Products & Chemicals, Inc.), OLFINE A, B, AK-02, CT-151W, E1004, E1010, P, SPC, STG, Y, 32W, PD-001, PD-002W, PD-003, PD-004, EXP. 4001, EXP. 4036, EXP. 4051, AF-103, AF-104, SK-14, AE-3 (all manufactured by Nissin Chemical Co., Ltd.), ACETYLENOL BOO, E13T, E40,E60, E81, E100, E200 (all are trade names and are manufactured by Kawaken Fine Chemicals Co., Ltd.), and the like. Among these, OLFINE E1010 is preferred.

Specific examples of cationic surfactants include the cationic surfactants described in Paragraph “0554” in JP2012-208494A (“0680” in the specification of the corresponding US2012/0235099A) and the contents thereof can be incorporated into the specification of the present application by reference.

Specific examples of the anionic surfactants include W004, W005, W017 (manufactured by Yusho Co., Ltd.), and the like.

Examples of silicone-based surfactants include the silicone-based surfactants described in Paragraph “0556” in JP2012-208494A (“0682” in the specification of the corresponding US2012/0235099A) and the contents thereof can be incorporated into the specification of the present application by reference. In addition, examples thereof also include “TORAY SILICONE SF8410”, TORAY SILICONE SF8427″, TORAY SILICONE SF8400″, “ST8OPA”, “ST83PA”, “ST86PA” all manufactured by Dow Corning Toray Co., Ltd., “TSF-400”, “TSF-401”, “TSF-410”, “TSF-4446” manufactured by Momentive Performance Materials Worldwide Inc., “KP321”, “KP323”, “KP324”, “KP340” manufactured by Shin-Etsu Chemical Co., Ltd. and the like.

<Polymerization Initiator>

The composition of the present invention may include a polymerization initiator. The number of the polymerization initiators included may be one or more and, in a case in which the composition includes two or more polymerization initiators, the total amount thereof falls into the above-described range. For example, the content of the polymerization initiator is preferably in a range of 0.01% by mass to 30% by mass, more preferably in a range of 0.1% by mass to 20% by mass, and still more preferably in a range of 0.1% by mass to 15% by mass of the solid content of the composition of the present invention.

The polymerization initiator is not particularly limited as long as the polymerization initiator has the capability of initiating the polymerization of the polymerizing compounds using either or both light and heat and can be appropriately selected depending on the purpose, but is preferably a photopolymerizing compound. In a case in which polymerization is initiated using light, the polymerization initiator preferably has photosensitivity to light rays in an ultraviolet to visible light range.

In addition, in a case in which polymerization is initiated using heat, a polymerization initiator that is decomposed at a temperature in a range of 150° C. to 250° C. is preferred.

The polymerization initiator that can be used in the present invention is preferably a compound having at least an aromatic group and examples thereof include acylphosphine compounds, acetophenone-based compounds, a-aminoketone compounds, benzophenone-based compounds, benzoin ether-based compounds, ketal derivative compounds, thioxanthone compounds, oxime compounds, hexaaryl biimidazole compounds, trihalomethyl compounds, azo compounds, organic peroxides, diazonium compounds, iodonium compounds, sulfonium compounds, azinium compounds, ketal derivative compounds, onium salt compounds such as metallocene compounds, organic boron salt compounds, disulfone compounds, and the like.

From the viewpoint of sensitivity, oxime compounds, acetophenone-based compounds, a-aminoketone compounds, trihalomethyl compounds, hexaaryl biimidazole compounds, and thiol compounds are preferred.

Regarding the acetophenone-based compounds, the trihalomethyl compounds, the hexaaryl biimidazole compounds, and the oxime compounds, specifically, the description in Paragraphs “0506” to “0510” in JP2012-208494A (“0622” to “0628” in the specification of the corresponding US2012/0235099A) and the like, can be referred to and the content thereof is incorporated into the specification of the present application.

The photopolymerization initiator is more preferably a compound selected from a group consisting of an oxime compound, an acetophenone-based compound, and an acylphosphine compound. More specifically, for example, it is also possible to use the aminoacetophenone-based initiators described in JP 1998-291969A (JP-H10-291969A), the acylphosphine oxide-based initiators described in JP4225898B, the above-described oxime-based initiators, and, furthermore, as the oxime-based initiators, the compounds described in JP2001-233842A.

As the oxime compound, it is possible to use a commercially available product IRGACURE-OXE01 (manufactured by BASF) or IRGACURE-OXE02 (manufactured by BASF). As the acetophenone-based initiator, it is possible to use commercially available products IRGACURE-907, IRGACURE-369, and IRGACURE-379 (trade name, all manufactured by BASF Japan). In addition, as the acylphosphine-based initiator, it is possible to use a commercially available product IRGACURE-819 or DAROCUR-TPO (trade name, manufactured by BASF Japan).

<Other Components>

In the composition of the present invention, in addition to the above-described essential components or the above-described additives, other components can be appropriately selected and used depending on the purpose as long as the effect of the present invention is not impaired.

Examples of other components that can be jointly used include a dispersing agent, a sensitizer, a cross-linking agent, a curing accelerator, a filler, a thermal curing accelerator, a thermopolymerization inhibitor, a plasticizer, and the like and, furthermore, an accelerator of adhesion to the surface of a base material and other auxiliary agents (for example, conductive particles, a filler, a defoamer, a flame retardant, a levelling agent, a peeling accelerator, an antioxidant, a fragrance, a surface tension adjuster, a chain transfer agent, and the like) may also be jointly used.

When the composition of the present invention appropriately includes the above-described components, it is possible to adjust properties such as stability and film properties of a target near-infrared-absorbing filter.

Regarding the above-described components, for example, the descriptions in Paragraphs “0183” and thereafter in JP2012-003225A (“0237” and thereafter in the specification of the corresponding US2013/0034812A), Paragraphs “0101” and “0102”, Paragraphs “0103” and “0104”, and Paragraphs “0107” to “0109” in JP2008-250074A, and the like can be referred to and the contents thereof can be incorporated into the specification of the present application.

The near-infrared-absorbing composition is preferably filtered using a filter for the purpose of removing a foreign substance or reducing defects. A filter can be used without any particular limitations as long as the filter has been used thus far for filtration use. Examples thereof include filters made of a fluorine resin such as polytetrafluoroethylene (PTFE), a polyamide-based resin such as nylon, a polyolefin resin (including a high density and a ultrahigh molecular weight) such as polyethylene or polypropylene (PP), or the like. Among these materials, polypropylene (including a high-density polypropylene) and nylon are preferred.

The pore diameter of the filter is preferably in a range of approximately 0.1 μm to 7.0 μm, more preferably in a range of approximately 0.2 μm to 2.5 μm, still more preferably in a range of approximately 0.2 μm to 1.5 μm, and particularly preferably in a range of approximately 0.3 μm to 0.7 μm. When the pore diameter thereof is within the above-described range, it becomes possible to reliably remove fine foreign substances such as impurities or aggregated substances included in the near-infrared-absorbing composition while suppressing filter clogging.

When the filter is used, different filters may be combined together. At this time, the number of times of filtering using a first filter may be one or more. In a case in which filtering is performed multiple times using a combination of different filters, the pore diameter of a filter used for the first filtering is preferably identical to or larger than the pore diameter of a filter used for the second or later filtering. In addition, the first filters having different pore diameters within the above-described range may be combined together. Regarding the pore diameter, the nominal value by a filter maker can be referred to. As a commercially available filter, it is possible to select a filter from, for example, a variety of filters provided by Pall Corporation, Toyo Roshi Kaisha, Ltd., Nihon Entergris K.K. (formerly Mikolis Corporation), Kitz Microfilter Corporation, and the like.

As a second filter, it is possible to use a filter formed using the same material as for the above-described first filter. The pore diameter of the second filter is preferably in a range of approximately 0.2 μm to 10.0 μm, more preferably in a range of approximately 0.2 μm to 7.0 μm, and still more preferably in a range of approximately 0.3 μm to 6.0 μm. When the pore diameter is set in the above-described range, it is possible to more reliably remove a foreign substance mixed into the near-infrared-absorbing composition.

Since the composition of the present invention can be produced in a liquid form, a near-infrared cut filter can be easily produced by, for example, directly applying and drying the composition of the present invention, and it is possible to improve production suitability which has been insufficient in the above-described near-infrared cut filter of the related art.

In the near-infrared cut filter, the light transmittance thereof preferably satisfies at least one of the following conditions (1) to (9), more preferably satisfies all of the following conditions (1) to (8), and still more preferably satisfies all of the following conditions (1) to (9).

(1) The light transmittance at a wavelength of 400 nm is preferably 80% or higher, more preferably 90% or higher, still more preferably 92% or higher, and particularly preferably 95% or higher.

(2) The light transmittance at a wavelength of 450 nm is preferably 80% or higher, more preferably 90% or higher, still more preferably 92% or higher, and particularly preferably 95% or higher.

(3) The light transmittance at a wavelength of 500 nm is preferably 80% or higher, more preferably 90% or higher, still more preferably 92% or higher, and particularly preferably 95% or higher.

(4) The light transmittance at a wavelength of 550 nm is preferably 80% or higher, more preferably 90% or higher, still more preferably 92% or higher, and particularly preferably 95% or higher.

(5) The light transmittance at a wavelength of 700 nm is preferably 20% or lower, more preferably 15% or lower, still more preferably 10% or lower, and particularly preferably 5% or lower.

(6) The light transmittance at a wavelength of 750 nm is preferably 20% or lower, more preferably 15% or lower, still more preferably 10% or lower, and particularly preferably 5% or lower.

(7) The light transmittance at a wavelength of 800 nm is preferably 20% or lower, more preferably 15% or lower, still more preferably 10% or lower, and particularly preferably 5% or lower.

(8) The light transmittance at a wavelength of 850 nm is preferably 20% or lower, more preferably 15% or lower, still more preferably 10% or lower, and particularly preferably 5% or lower.

(9) The light transmittance at a wavelength of 900 nm is preferably 20% or lower, more preferably 15% or lower, still more preferably 10% or lower, and particularly preferably 5% or lower.

The film thickness of the near-infrared cut filter is preferably 500 μm or smaller, more preferably 300 μm or smaller, still more preferably 250 μm or smaller, and particularly preferably 200 μm. In addition, the film thickness thereof is preferably 1 μm or greater, more preferably 20 μm or greater, still more preferably 50 μm or greater, and particularly preferably 100 μm or greater. Particularly, the film thickness thereof is preferably in a range of 1 μm to 500 μm, more preferably in a range of 1 μm to 300 μm, and still more preferably in a range of 1 μm to 200 μm. In the present invention, even in a case in which a film has a thin thickness as described above, it is possible to maintain high near-infrared-shielding properties.

In the near-infrared cut filter of the present invention, the percentage of a change in absorbance at a wavelength of 400 nm and the percentage of a change in absorbance at a wavelength of 800 nm before and after heating of the near-infrared cut filter at 200° C. for five minutes are both preferably 7% or lower and particularly preferably 5% or lower.

In addition, in the near-infrared cut filter of the present invention, the percentages of a change in the absorbance ratio obtained from the following expression before and after the filter is left to stand for one hour at a high temperature and a high humidity which are 85° C. and a relative humidity of 85% are preferably 7% or lower, more preferably 4% or lower, and still more preferably 2% or lower respectively.

Percentage of change in absorbance ratio (%)=[(Absorbance ratio before test-absorbance ratio after test)/absorbance ratio before test]×100 (%)

Here, the absorbance ratio refers to (maximum absorbance at a wavelength in a range of 700 nm to 1400 nm/minimum absorbance at a wavelength in a range of 400 nm to 700 nm).

Examples of the use of the near-infrared-absorbing composition of the present invention include a near-infrared cut filter on the light-receiving side of a solid photographing element (for example, a near-infrared cut filter for a wafer-level lens or the like), a near-infrared cut filter on the rear surface side (the side opposite to the light-receiving side) of a solid photographing element, and the like. The near-infrared-absorbing composition of the present invention is preferably used for a light shielding film on the light-receiving side of a solid photographing element. Particularly, the near-infrared-absorbing composition of the present invention is preferably directly applied onto an imaging sensor for a solid photographing element so as to form a coated film.

In addition, in a case in which an infrared cut layer is formed through coating, the viscosity of the near-infrared-absorbing composition of the present invention is preferably in a range of 1 mPa·s to 3000 mPa·s, more preferably in a range of 10 mPa·s to 2000 mPa·s, and still more preferably in a range of 100 mPa·s to 1500 mPa·s.

In a case in which the near-infrared-absorbing composition of the present invention is for a near-infrared cut filter on a light-receiving side of a solid photographing element and forms an infrared cut layer through coating, from the viewpoint of a property for forming a thick film and uniform coatability, the viscosity of the near-infrared-absorbing composition is preferably in a range of 10 mPa·s to 3000 mPa·s, more preferably in a range of 500 mPa·s to 1500 mPa·s, and still more preferably in a range of 700 mPa·s to 1400 mPa·s.

The total solid content of the near-infrared-absorbing composition of the present invention is varied depending on a coating method, but is preferably 1% by mass or higher of the composition and more preferably 10% by mass or higher. Particularly, the total solid content thereof is preferably in a range of 1% by mass to 50% by mass of the composition, more preferably in a range of 1% by mass to 30% by mass, and still more preferably in a range of 10% by mass to 30% by mass.

The present invention may be a laminate including a near-infrared cut layer obtained by hardening the near-infrared-absorbing composition and a dielectric multilayer film. Examples of an aspect of the present invention include (i) an aspect in which a transparent support, the near-infrared cut layer, and the dielectric multilayer film are provided in the above-described order and (ii) an aspect in which the near-infrared cut layer, a transparent support, and the dielectric multilayer film are provided in the above-described order. The above-described transparent support may be a glass substrate or a transparent resin substrate.

The dielectric multilayer film is a film having a capability of reflecting and/or absorbing near-infrared rays.

As a material for the dielectric multilayer film, for example, a ceramic material can be used. Alternatively, a noble metal film absorbing light in the near-infrared range may be used in consideration of thickness and the number of layers so that the visible light transmittance of the near-infrared cut filter is not affected.

As the dielectric multilayer film, specifically, a constitution in which high-refractive-index material layers and low-refractive-index material layers are alternately laminated can be preferably used.

As a material for constituting the high-refractive-index material layer, a material having a refractive index of 1.7 or higher can be used, and a material having a refractive index generally in a range of 1.7 to 2.5 is selected.

Examples of the above-described material include titanium oxide (titania), zirconium oxide, tantalum pentoxide, niobium pentoxide, lanthanum oxide, yttrium oxide, zinc oxide, zinc sulfide, indium oxide, and a material containing the above-described oxide as a main component and a small amount of titanium oxide, tin oxide, and/or cerium oxide. Among these, titanium oxide (titania) is preferred.

As a material for constituting the low-refractive-index material layer, a material having a refractive index of 1.6 or lower can be used, and a material having a refractive index generally in a range of 1.2 to 1.6 is selected.

Examples of the above-described material include silica, alumina, lanthanum fluoride, magnesium fluoride, and sodium aluminum hexafluoride. Among these, silica is preferred.

The thickness of each of the high-refractive-index material layer and the low-refractive-index material layer is generally a thickness of 0.1λ to 0.5λ of the wavelength λ (nm) of an infrared ray to shield. When the thickness is outside the above-described range, the product (nxd) of the refractive index (n) and the film thickness (d) becomes significantly different from the optical film thickness computed from λ/4, and thus the relationship of optical characteristics such as reflection and refraction is destroyed, and there is a tendency that the control of shielding and permeation of a specific wavelength becomes difficult.

In addition, the number of layers laminated in the dielectric multilayer film is preferably in a range of 5 to 50 and more preferably in a range of 10 to 45.

The near-infrared cut filter is used for a lens (a camera lens in a digital camera, a mobile phone, an in-vehicle camera, or the like or an optical lens such as a f-O lens or a pickup lens) and an optical filter for a semiconductor light-receiving element which have a function of absorbing and cutting near-infrared rays, a near-infrared-absorbing film or a near-infrared-absorbing sheet which shields heat rays for energy saving, an agricultural coating agent which aims the selective use of sunlight, a recording medium which uses near-infrared-absorbing heat, a near-infrared filter for an electronic device or a photograph, protective glasses, sunglasses, a heat ray shielding film, an optical letter-reading record, the prevention of copying a confidential document, an electrophotographic photoreceptor, laser fusion, and the like. In addition, the near-infrared cut filter is also useful for a noise cut filter for a CCD camera and a filter for a CMOS image sensor.

<Process for Producing Near-Infrared Cut Filter>

A process for producing a near-infrared cut filter of the present invention preferably includes a step of applying the near-infrared-absorbing composition of the present invention onto a base material and a step of drying the near-infrared-absorbing composition applied onto the base material.

Examples of the method for applying the near-infrared-absorbing composition of the present invention onto a base material include dropwise addition, immersion, coating, and printing. Specifically, the method is preferably selected from drop casting, applicator application, dip coating, slit coating, screen printing, spray coating, and spin coating.

In the case of the dropwise addition method (drop casting), it is preferable to form a dropwise addition region for the near-infrared-absorbing composition including a photoresist as a partition wall on a support so that a uniform film can be obtained with a predetermined film thickness. A desired film thickness can be obtained by adjusting the amount of the near-infrared-absorbing composition added dropwise, the concentration of the solid content, and the area of the dropwise addition region to be desired values. The thickness of the dried film is not particularly limited and can be appropriately selected depending on the purposes.

A support may be a transparent substrate made of glass or the like, a solid photographing element, another substrate (for example, a glass substrate 30 described below) provided on the light-receiving side of the solid photographing element, or a layer such as a flattened layer provided on the light-receiving side of the solid photographing element.

In addition, the conditions for drying the coated film vary depending on the kind and proportions of individual components and a solvent; however, generally, the coated film is dried at a temperature in a range of 60° C. to 200° C. for approximately 30 seconds to 15 minutes.

A method for foiming a near-infrared cut filter using the near-infrared-absorbing composition of the present invention may include other steps. The other steps are not particularly limited and can be appropriately selected depending on the purpose. Examples thereof include a surface treatment step of the base material, a pretreatment step (prebaking step), a curing treatment step, a post heating step (post baking step), and the like.

<Preheating step and post heating step>The heating temperatures in the preheating step and the post heating step are generally in a range of 80° C. to 200° C. and preferably in a range of 90° C. to 180° C.

The heating times in the preheating step and the post heating step are generally in a range of 30 seconds to 400 seconds and preferably in a range of 60 seconds to 300 seconds.

<Curing Treatment Step>

The curing treatment step refers to a step of carrying out a curing treatment on the formed film as necessary and the curing treatment improves the mechanical strength of the near-infrared cut filter.

The curing treatment step is not particularly limited and can be appropriately selected depending on the purpose and preferred examples thereof include a full-surface exposure treatment, a full-surface thermal treatment, and the like. In the present invention, the meaning of “exposure” includes the irradiation of the surface with radioactive rays such as electron beams or X rays as well as light rays having a variety of wavelengths.

The exposure is preferably carried out through irradiation with radioactive rays and, as the radioactive rays that can be used in the exposure, particularly, ultraviolet rays such as electron beams, KrF, ArF, g-rays, h-rays, or i-rays or visible light are preferably used. Preferably, KrF, g-rays, h-rays, or i-rays are preferred.

Examples of the exposure method include stepper exposure, exposure using a high-pressure mercury lamp, and the like.

The exposure amount is preferably in a range of 5 J/cm² to 3000 mJ/cm², more preferably in a range of 10 J/cm² to 2000 mJ/cm², and particularly preferably in a range of 50 J/cm² to 1000 mJ/cm².

Examples of a method for the full-surface exposure treatment include a method in which the full surface of the above-described formed film is exposed. In a case in which the near-infrared-absorbing composition includes the polymerizing compound, the full-surface exposure accelerates the curing of a polymerizing component in the film formed of the composition, makes the film cured to a greater extent, and improves the mechanical strength and the durability.

An apparatus for carrying out the full-surface exposure is not particularly limited and can be appropriately selected depending on the purpose, and preferred examples thereof include UV steppers such as ultrahigh-pressure mercury lamps.

In addition, examples of the method for the full-surface thermal treatment include a method in which the full surface of the above-described formed film is heated. The heating of the full surface increases the film strength of a pattern.

The heating temperature during the full-surface heating is preferably in a range of 120° C. to 250° C. When the heating temperature is 120° C. or higher, the film strength is improved by the heating treatment and, when the heating temperature is 250° C. or lower, components in the film are decomposed and it is possible to prevent the film from becoming weak and brittle.

The heating time in the full-surface heating is preferably in a range of 3 minutes to 180 minutes and more preferably in a range of 5 minutes to 120 minutes.

An apparatus for carrying out the full-surface heating is not particularly limited and can be appropriately selected from well-known apparatuses depending on the purpose, and examples thereof include a drying oven, a hot plate, an IR heater, and the like.

<Camera Module and Process for Producing Camera Module>

In addition, the present invention also relates to a camera module having a solid photographing element and a near-infrared cut filter disposed on the light-receiving side of the solid photographing element, in which the near-infrared cut filter is the near-infrared cut filter of the present invention.

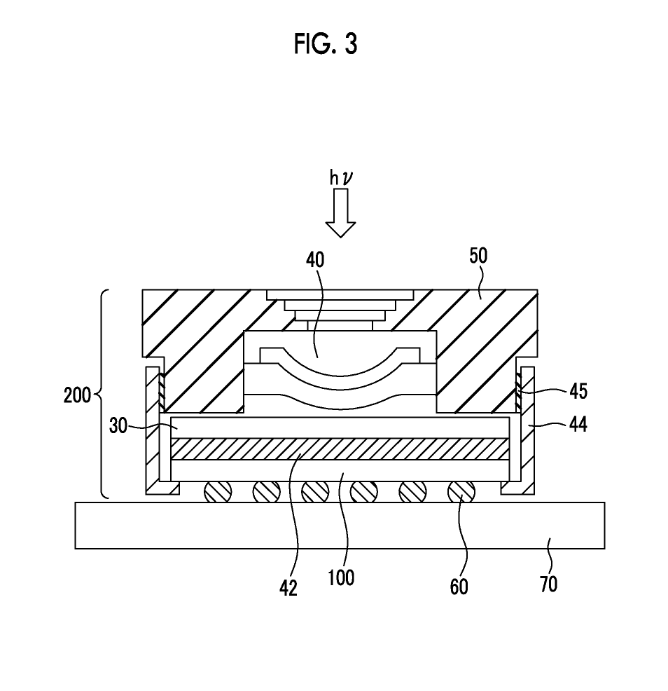

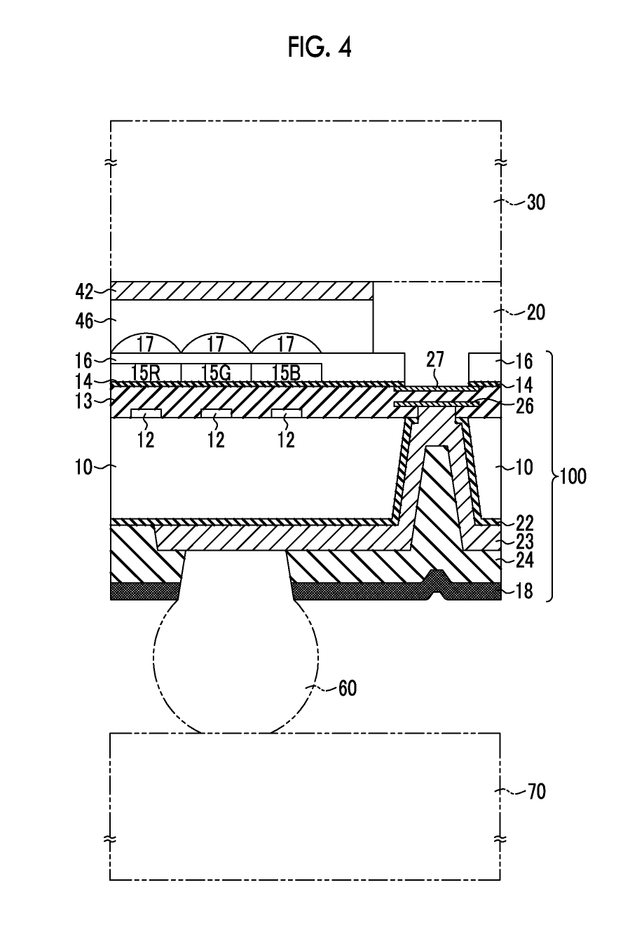

Hereinafter, a camera module according to an embodiment of the present invention will be described with reference to FIGS. 3 and 4, but the present invention is not limited to the following specific example.

Meanwhile, in FIGS. 3 and 4, common reference signs will be given to common portions.

In addition, in the description, “up”, “upward”, and “upside” indicate a side far from a silicon substrate 10, and “down”, “downward”, and “downside” indicate a side close to the silicon substrate 10.

FIG. 3 is a schematic sectional view illustrating the constitution of a camera module including a solid photographing element.

A camera module 200 illustrated in FIG. 3 is connected to a circuit board 70, which is a mounting substrate, through solder balls 60 which is a connection member.

In detail, the camera module 200 includes a solid photographing element (solid photographing element substrate) 100 including photodiodes on a first main surface of the silicon substrate, a flattening layer (not illustrated in FIG. 3) provided on the first main surface side (light-receiving side) of the solid photographing element 100, a near-infrared cut filter 42 provided on the flattening layer, a lens holder 50 which is disposed above the near-infrared cut filter 42 and includes an imaging lens 40 in an inner space, and a light and electromagnetic shield 44 disposed so as to cover the surrounding of the solid photographing element 100 and the glass substrate 30. Meanwhile, the glass substrate 30 (light-permeable substrate) may be provided on the flattening layer. The respective members are adhered together using an adhesive 45.

The present invention relates to a process of producing a camera module including the solid photographing element 100 and the near-infrared cut filter 42 disposed on the light-receiving side of the solid photographing element, including a step of forming the near-infrared cut filter 42 by applying the near-infrared-absorbing composition of the present invention to the light-receiving side of the solid photographing element. In the camera module according to the present embodiment, the near-infrared cut filter 42 can be formed on the flattening layer by, for example, applying (for example, coating) the near-infrared-absorbing composition of the present invention. The method for applying the near-infrared-absorbing composition onto the base material is as described above.

In the camera module 200, incidence ray hu from the outside sequentially permeates the imaging lens 40, the near-infrared cut filter 42, the glass substrate 30, and the flattening layer, and then reaches the imaging element portion in the solid photographing element 100.

The camera module 200 includes the near-infrared cut filter directly provided on the flattening layer, but the near-infrared cut filter may be directly provided on a micro lens without the flattening layer, or the near-infrared cut filter may be provided on the glass substrate 30, or the glass substrate 30 provided with the near-infrared cut filter may be adhered to the camera module.

FIG. 4 is an enlarged sectional view of the solid photographing element 100 in FIG. 3.

The solid photographing element 100 includes the imaging element portions 12 on the first main surface of the silicon substrate 10, which is a substrate, an interlayer insulating film 13, a base layer 14, a color filter 15, an overcoat 16, and micro lenses 17 in this order. A red color filter 15R, a green color filter 15G, and a blue color filter 15B (hereinafter, these will be collectively referred to as “color filter 15”) or the micro lenses 17 are respectively disposed so as to correspond to the imaging element portions 12. A light shielding film 18, an insulating film 22, a metallic electrode 23, a solder resist layer 24, an inner electrode 26, and an element surface electrode 27 are provided on a second main surface which is on a side opposite to the first main surface of the silicon substrate 10. The respective members are adhered together using an adhesive 20.

A flattening layer 46 and the near-infrared cut filter 42 are provided on the micro lenses 17. The near-infrared cut filter 42 may be provided on the micro lenses 17 and between the base layer 14 and the color filter 15 or between the color filter 15 and the overcoat 16 instead of being provided on the flattening layer 46. Particularly, the near-infrared cut filter is preferably provided at a position 2 mm or less (more preferably 1 mm or less) away from the surfaces of the micro lenses 17. When the near-infrared cut filter is provided at this position, it is possible to simplify the step of forming the near-infrared cut filter and to sufficiently cut unnecessary near-infrared rays travelling toward the micro lenses, and thus the near-infrared-shielding properties can be further enhanced.

Regarding the solid photographing element 100, the description of Paragraph “0245” (Paragraph “0407” in the specification of the corresponding US2012/068292A) of JP2012-068418A can be referred to, and the content thereof is incorporated into the present specification.

The near-infrared cut filter can be subjected to a solder reflow step. When the camera module is produced through the solder reflow step, the automatic mounting of an electronic component-mounted substrate or the like which requires soldering becomes possible, and it is possible to significantly improve the productivity compared with a case in which the solder reflow step is not used. Furthermore, since the solder reflow step is automatically carried out, it is also possible to reduce the cost. In a case in which the near-infrared cut filter is subjected to the solder reflow step, the near-infrared cut filter is exposed to a temperature in a range of approximately 250° C. to 270° C., and thus the near-infrared cut filter is preferably heat-resistant enough to withstand the solder reflow step (hereinafter, also referred to as “solder reflowability”).

In the present specification, “having solder reflowability” means that the near-infrared cut filter maintains its characteristics before and after being heated at 200° C. for 10 minutes. More preferably, the infrared cut filter maintains its characteristics before and after being heated at 230° C. for 10 minutes. Still more preferably, the infrared cut filter maintains its characteristics before and after being heated at 250° C. for three minutes. In a case in which the near-infrared cut filter does not have solder reflowability, when being held under the above-described conditions, there are cases in which the near-infrared-absorbing function of the near-infrared cut filter degrades or the functions become insufficient for films.

In addition, the present invention also relates to a process for producing a camera module including a step of a reflow treatment. Even when the reflow step is provided, the near-infrared cut filter is capable of maintaining its near-infrared-absorbing function, and there are no cases in which the characteristics of the camera module having reduced size and weight and having improved performance are impaired.

FIGS. 5 to 7 are schematic sectional views illustrating examples of a periphery of a near-infrared cut filter in the camera module.

As illustrated in FIG. 5, the camera module may have the solid photographing element 100, the flattening layer 46, an ultraviolet and infrared light-reflecting film 80, a transparent base material 81, a near-infrared-absorbing layer 82, and an antireflection layer 83 in this order.

The ultraviolet and infrared light-reflecting film 80 has an effect of imparting and enhancing the functions of the near-infrared cut filter, and, for example, Paragraphs “0033” to “0039” in JP2013-68688A can be referred to, and the content thereof is incorporated into the present specification.

The transparent base material 81 transmits light having wavelengths in the visible light range, and, for example, Paragraphs “0026” to “0032” in JP2013-68688A can be referred to, and the content thereof is incorporated into the present specification.

The near-infrared-absorbing layer 82 is a layer formed by applying the above-described near-infrared-absorbing composition of the present invention.

The antireflection layer 83 has a function of preventing the reflection of light incident on the near-infrared cut filter so as to improve the transmittance and allowing efficient use of the incidence ray, and, for example, Paragraph “0040” in JP2013-68688A can be referred to, and the content thereof is incorporated into the present specification.

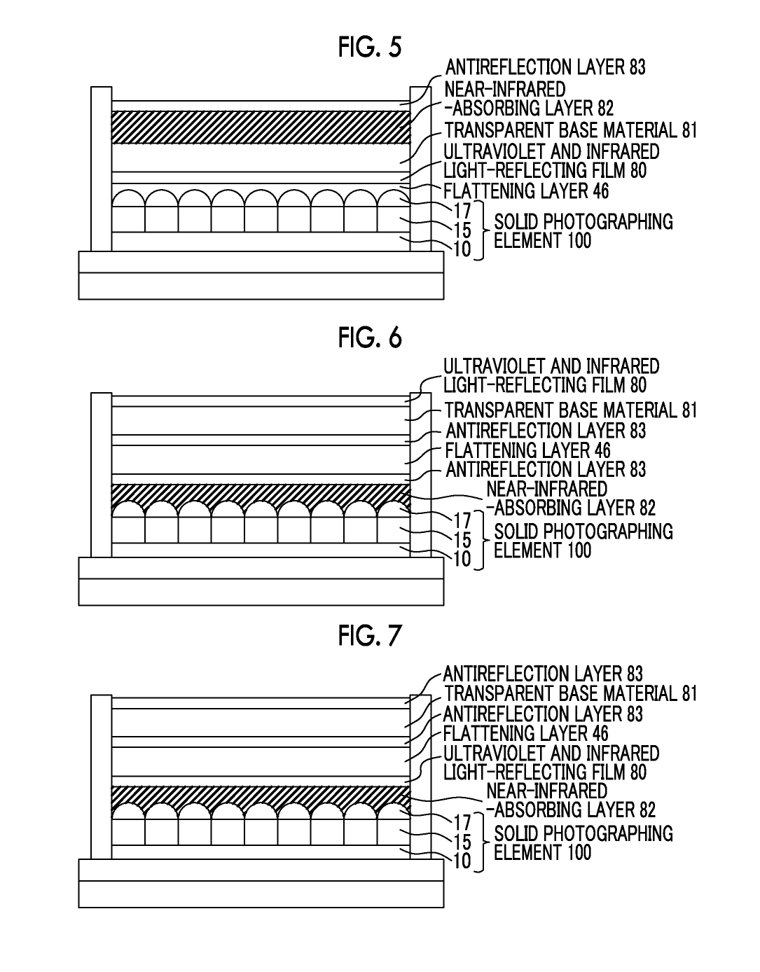

As illustrated in FIG. 6, the camera module may have the solid photographing element 100, the near-infrared-absorbing layer 82, the antireflection layer 83, the flattening layer 46, the antireflection layer 83, the transparent base material 81, and the ultraviolet and infrared light-reflecting film 80 in this order.

As illustrated in FIG. 7, the camera module may have the solid photographing element 100, the near-infrared-absorbing layer 82, the ultraviolet and infrared light-reflecting film 80, the flattening layer 46, the antireflection layer 83, the transparent base material 81, and the antireflection layer 83 in this order.

Thus far, the embodiment of the camera module has been described with reference to FIGS. 3 to 7, but the embodiment is not limited to the embodiment of FIGS. 3 to 7.

### EXAMPLES

Hereinafter, the present invention will be more specifically described using examples. Materials, amounts used, proportions, the contents of treatments, the orders of treatments, and the like described in the following examples can be appropriately changed within the scope of the gist of the present invention. Therefore, the scope of the present invention is not limited to specific examples described below.

### Synthesis Example 1

### synthesis of Near-Infrared-Absorbing Compound A-1

1,3-Propane disulfonic acid (55.1% by mass aqueous solution) (10 parts by mass), water (11.27 parts by mass), and furthermore, copper (II) hydroxide (2.63 parts by mass) were added to and stirred in an eggplant flask and were reacted with each other at 50° C. for one hour. After the reaction, the mixture was cooled to room temperature and was diluted using water, thereby obtaining a 25% by mass aqueous solution of a near-infrared-absorbing compound (A-1).

### Synthesis Examples 2 to 10

### Syntheses of Near-Infrared-Absorbing Compounds A-2 to A-10

25% by mass aqueous solutions of near-infrared-absorbing compounds (A-2 to A-10) were obtained in the same manner as in Synthesis Example 1 except for the fact that the kinds of acidic compounds used and the ratios between the coordination site equivalent (acid group equivalent) and the copper atom equivalent were changed as shown in Table 20 below.

### Synthesis Example 11

### Synthesis of Near-Infrared-Absorbing Compound A-11

25% by mass aqueous solution of a near-infrared-absorbing compound A-11 was obtained in the same manner as in Synthesis Example 1 except for the fact that a compound (L-1) below was used instead of 1,3-propane disulfonic acid in Synthesis Example 1. Meanwhile, the ratio (coordination site equivalent/copper atom equivalent) between the equivalent of all coordination sites in the compound (L-1) and the equivalent of copper atoms in copper acetate was 2:1.

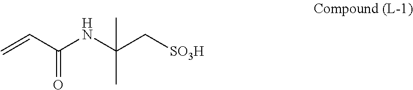

### Synthesis Example 12

### Synthesis of Near-Infrared-Absorbing Compound A-12

A 25% by mass aqueous solution of a near-infrared-absorbing compound A-12 was obtained in the same manner as in Synthesis Example 1 except for the fact that a compound (L-2) below was used instead of 1,3-propane disulfonic acid and copper methane sulfonate was used instead of copper (II) hydroxide in Synthesis Example 1. Meanwhile, the ratio (coordination site equivalent/copper atom equivalent) between the equivalent of all coordination sites in the compound (L-2) and the equivalent of copper atoms in copper acetate was 1:1.

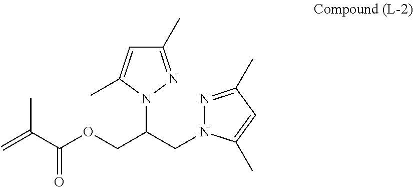 [SMILES: C=C(C)C(=O)OCC(Cn1nc(C)cc1C)n1nc(C)cc1C]

### Synthesis Example 13

### Synthesis of Near-Infrared-Absorbing Compound A-13

A 25% by mass aqueous solution of a near-infrared-absorbing compound A-13 was obtained in the same manner as in Synthesis Example 1 except for the fact that a compound (L-3) below was used instead of 1,3-propane disulfonic acid and copper acetate was used instead of copper (II) hydroxide in Synthesis Example 1. Meanwhile, the ratio (coordination site equivalent/copper atom equivalent) between the equivalent of all coordination sites in the compound (L-3) and the equivalent of copper atoms in copper acetate was 2:1.

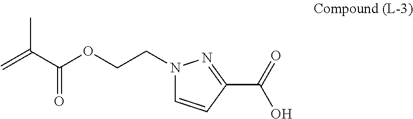 [SMILES: C=C(C)C(=O)OCCn1ccc(C(=O)O)n1]

TABLE 20

| | | | Content proportion |
|---|---|---|---|
| | | Coordination site | of copper in |
| Near-infrared- | | equivalent/copper | solid contents |
| absorbing compound | Low-molecular-weight compound used | atom equivalent | (% by mass) |
| A-1 | 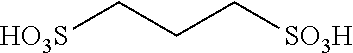 [SMILES: O=S(=O)(O)CCCS(=O)(=O)O] | 2.0/1.0 | 23.9 |
| A-2 | 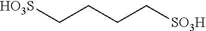 [SMILES: O=S(=O)(O)CCCCS(=O)(=O)O] | 2.0/1.0 | 22.7 |
| A-3 | 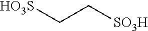 | 2.0/1.0 | 25.2 |
| A-4 | 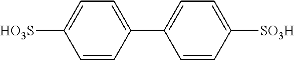 [SMILES: O=S(=O)(O)c1ccc(-c2ccc(S(=O)(=O)O)cc2)cc1] | 2.0/1.0 | 16.9 |
| A-5 | 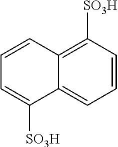 [SMILES: O=S(=O)(O)c1cccc2c(S(=O)(=O)O)cccc12] | 2.0/1.0 | 18.2 |
| A-6 | 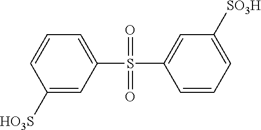 [SMILES: O=S(=O)(O)c1cccc(S(=O)(=O)c2cccc(S(=O)(=O)O)c2)c1] | 2.0/1.0 | 14.4 |
| A-7 | 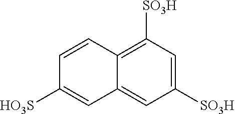 [SMILES: O=S(=O)(O)c1ccc2c(S(=O)(=O)O)cc(S(=O)(=O)O)cc2c1] | 2.0/1.0 | 20.7 |
| A-8 | 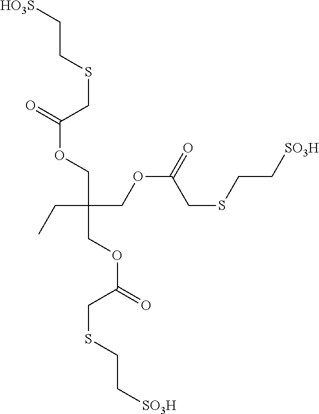 [SMILES: CCC(COC(=O)CSCCS(=O)(=O)O)(COC(=O)CSCCS(=O)(=O)O)COC(=O)CSCCS(=O)(=O)O] | 2.0/1.0 | 12.3 |
| A-9 | 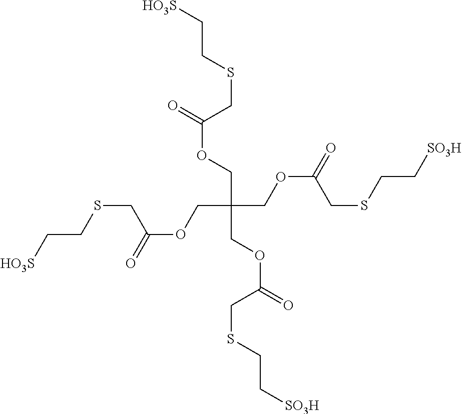 [SMILES: O=C(CSCCS(=O)(=O)O)OCC(COC(=O)CSCCS(=O)(=O)O)(COC(=O)CSCCS(=O)(=O)O)COC(=O)CSCCS(=O)(=O)O] | 2.0/1.0 | 12.9 |
| A-10 | 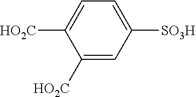 [SMILES: O=C(O)c1ccc(S(=O)(=O)O)cc1C(=O)O] | 2.0/0.7 | 20.7 |

### Synthesis Example 14

### Synthesis of Near-Infrared-Absorbing Compound B-1

Water (60 parts by mass) was put into a three-neck flask and was heated to 57° C. in a nitrogen atmosphere. A monomer solution (dropwise addition solution A) obtained by dissolving 2-acrylamide-2-methylpropanesulfonic acid (100 parts by mass) in water (160 parts by mass) and an initiator solution (dropwise addition solution B) obtained by dissolving VA-046B (water-soluble azo-based polymerization initiator, manufactured by Wako Pure Chemical Industries, Ltd., 1.164 parts by mass) in water (80 parts by mass) were prepared, the dropwise addition solution A and the dropwise addition solution B were added dropwise to water at the same time over two hours and were reacted with each other. After being reacted for two hours from the dropwise addition, the dropwise addition solution A and the dropwise addition solution B were heated to 65° C. and thus were further reacted with each other for two hours, thereby obtaining a 25% by mass aqueous solution of a polymer (P-1). The weight-average molecular weight was 100,000.

0.4 equivalents of copper (II) hydroxide (18.83 parts by mass) of the amount of an acid group in (P-1) was added to the obtained (P-1) solution, was stirred together at 50° C. for one hour, and then was diluted using water, thereby obtaining a 25% by mass aqueous solution of a near-infrared-absorbing compound (B-1).

### Synthesis Examples 15 to 23

### Ssyntheses of Near-Infrared-Absorbing Compounds B-2 to B-9

Aqueous solutions of near-infrared-absorbing compounds (B-2 to B-9) (B-2 to B-5 and B-7 to B-9 were 25% by mass aqueous solutions, and B-6 was a 20% by mass aqueous solution) were obtained in the same manner as in Synthesis Example 14 except for the fact that the kinds of polymers used and the ratios between the coordination site equivalent (acid group equivalent) and the copper atom equivalent were changed as shown in Table 21 below.

### Synthesis Example 24

<<Synthesis of polymer (P-24)>>

1-Methoxy-2-propanol (21 g) was put into a three-neck flask and was heated to 85° C. in a nitrogen atmosphere. Next, a solution obtained by dissolving 2-[2-(3,5-dimethyl-1H-pyrazoryl)]ethylmethacrylate (11.21 g), benzyl methacrylate (18.79 g), and V-601 (azo-based polymerization initiator manufactured by Wako Pure Chemical Industries, Ltd., 1.06 g) in 1-methoxy-2-propanol (49 g) was added dropwise thereto over two hours.

After the end of the dropwise addition, the components were stirred together for four hours, and a reaction was finished, thereby obtaining a polymer (P-24) below. The weight-average molecular weight of the polymer (P-24) was 20,000.

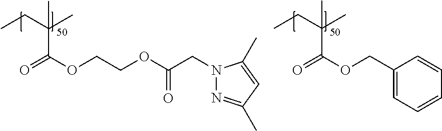

<<Synthesis of Near-Infrared-Absorbing Compound B-10>>

2,6-Pyridinedicarboxylic acid (17.82 g) and methanol (50 g) were put into an eggplant flask and were dissolved at room temperature. A solution obtained by dissolving copper acetate (19.37 g) in methanol (50 g) and water (20 g) was added thereto and was stirred at room temperature for 30 minutes, whereby generation of precipitation was confirmed. A 1-methoxy-2-propanol solution (100 g, 30% by mass) of the polymer (P-24) was added thereto and was stirred at room temperature for one hour, thereby obtaining a near-infrared-absorbing composition (B-10). Meanwhile, the ratio (coordination site equivalent/copper atom equivalent) between the equivalent of all coordination sites in the compound (P-24) and the equivalent of copper atoms in copper acetate was 2:1.

### Synthesis Example 25

### Near-Infrared-Absorbing Compound C-1

Methanesulfonic acid (24.8 parts by mass), water (100 parts by mass), and furthermore, copper (II) hydroxide (25.2 parts by mass) were added to an eggplant flask, stirred together, and were reacted with each other at 50° C. for one hour. After the reaction, the mixture was cooled to room temperature and was diluted using water, thereby obtaining a 25% by mass aqueous solution of a near-infrared-absorbing compound C-1.

TABLE 21

| | | | Content proportion |
|---|---|---|---|
| Near-infrared- | | Coordination site | of copper in |
| absorbing | | equivalent/copper | solid contents |
| compound | Polymer used | atom equivalent | (% by mass) |
| B-1 | 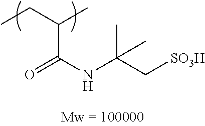 | 2.0/0.8 | 11.0 |
| B-2 | 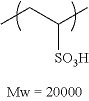 | 2.0/0.75 | 18.2 |
| B-3 | 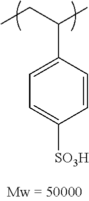 | 2.0/0.8 | 12.2 |
| B-4 | 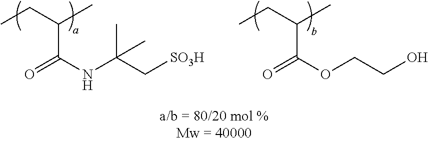 | 2.0/0.90 | 10.8 |
| B-5 | 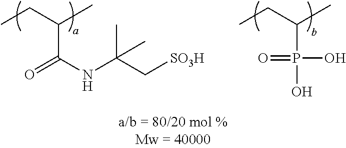 | 2.0/0.85 | 11.0 |
| B-6 | 20% Nation ® Dispersion Solution | 2.0/0.95 | 3.1 |
| | DE1021 CS type | | |
| | (manufactured by Wako Pure | | |
| | Chemical Industries, Ltd.) | | |
| B-7 | 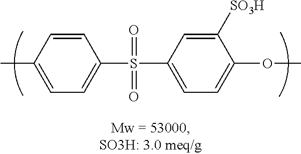 | 2.0/0.95 | 8.3 |
| B-8 | 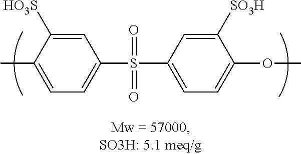 | 2.0/0.95 | 13.3 |
| B-9 | 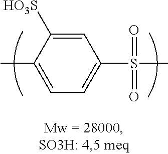 | 2.0/0.85 | 12.0 |
| C-1 | H₃C—SO₃H | 2.0/1.0 | 25.0 |

<Preparation of Near-Infrared-Absorbing Composition>

An aqueous solution of a near-infrared-absorbing compound was mixed in at mass ratios shown in Table 22, thereby preparing near-infrared-absorbing compositions 1 to 23 of Examples 1 to 32.

A near-infrared-absorbing composition 21 was prepared by stirring a compound A-11 (10 parts by mass), a compound B-1 (10 parts by mass), and water (83 parts by mass) at 50° C. for 12 hours. A near-infrared-absorbing composition 22 was prepared by stirring a compound A-12 (10 parts by mass), a compound B-8 (10 parts by mass), and water (83 parts by mass) at 50° C. for 12 hours. A near-infrared-absorbing composition 23 was prepared by stirring a compound A-13 (10 parts by mass), a compound B-10 (10 parts by mass), propylene glycol monomethyl ether (80 parts by mass), and water (3 parts by mass) at 50° C. for 12 hours.

TABLE 22

| | Near-infrared- | Near-infrared- | Near-infrared- | | |
|---|---|---|---|---|---|
| Near- | absorbing | absorbing | absorbing | | Content |
| infrared- | compound (A) | compound (B) | compound (C) | A/B/C | of copper |
| absorbing | (low-molecular- | (high-molecular- | (low-molecular- | (mass | (% by |
| composition | weight type) | weight type) | weight type) | ratio) | mass) |
| Composition 1 | A-8 | — | — | 100/0/0 | 12.3 |
| Composition 2 | A-9 | — | — | 100/0/0 | 12.9 |
| Composition 3 | A-3 | B-1 | — | 25/75/0 | 14.5 |
| Composition 4 | A-1 | B-2 | — | 5/95/0 | 18.5 |
| Composition 5 | A-2 | B-3 | — | 20/80/0 | 14.3 |
| Composition 6 | A-2 | B-4 | C-1 | 15/85/0 | 15.1 |
| Composition 7 | A-1 | B-5 | — | 25/75/0 | 14.2 |
| Composition 8 | A-8/A-3 | B-6 | C-1 | 35/40/25 | 14.1 |
| | (5/5) | | | | |
| Composition 9 | A-1 | B-7 | — | 35/65/0 | 13.8 |
| Composition 10 | A-4 | B-7 | C-1 | 10/60/30 | 14.2 |
| Composition 11 | A-7 | B-7 | C-1 | 30/55/15 | 14.5 |
| Composition 12 | A-9/A-3 | B-7 | — | 40/60/0 | 14.1 |
| | (2/8) | | | | |
| Composition 13 | A-10 | B-7 | — | 50/50/0 | 14.5 |
| Composition 14 | A-2 | B-8 | — | 10/90/0 | 14.3 |
| Composition 15 | A-5 | B-8 | — | 20/80/0 | 14.3 |
| Composition 16 | A-8 | B-8 | — | 5/95/0 | 13.3 |
| Composition 17 | A-10 | B-8 | — | 15/85/0 | 14.4 |
| Composition 18 | A-6 | B-8 | C-1 | 10/80/10 | 14.6 |
| Composition 19 | A-3 | B-9 | — | 15/85/0 | 14.0 |
| Composition 20 | A-6/A-1 | B-9 | — | 25/75/0 | 14.0 |
| | (4/6) | | | | |
| Composition 21 | A-11 | B-1 | — | 50/50/0 | 12.2 |
| Composition 22 | A-12 | B-8 | — | 50/50/0 | 12.2 |
| Composition 23 | A-13 | B-10 | — | 50/50/0 | 9.58 |

<<Production of Near-Infrared Cut Filter>>

Each of the near-infrared-absorbing compositions was coated on a glass substrate using dope casting (dropwise addition method), was heated on a hot plate in a stepwise manner of at 60° C. for 10 minutes, at 80° C. for 10 minutes, at 100° C. for 10 minutes, at 120° C. for 10 minutes, and at 140° C. for 10 minutes, thereby producing 100 μm-thick near-infrared cut filters.

<Evaluation of Near-Infrared-Absorbing Composition>

<<Evaluation of Near-Infrared-Shielding Properties>>

The transmittances at a wavelength of 800 nm of the near-infrared cut filters obtained as described above were measured using a spectrophotometer U-4100 (manufactured by Hitachi High-Technologies Corporation). The near-infrared-shielding properties were evaluated using the following standards.

A: Transmittance at 800 nm≦5%

B: 5%<Transmittance at 800 nm≦7%

C: 7%<Transmittance at 800 nm≦10%

D: 10%<Transmittance at 800 nm

<<Evaluation of Heat Resistance 1>>

The near-infrared cut filters obtained as described above were left to stand at 200° C. for five minutes. The maximum absorbance (Absλmax) at a wavelength in a range of 700 nm to 1400 nm and the minimum absorbance (Absλmin) at a wavelength in a range of 400 nm to 700 nm of each of the near-infrared cut filters were measured using a spectrophotometer U-4100 (manufactured by Hitachi High-Technologies Corporation) respectively before and after a heat resistance test, and the absorbance ratio represented by “Absλmax/Absλmin” was obtained. The percentage of a change in the absorbance ratio represented by |((absorbance ratio before test-absorbance ratio after test)/absorbance ratio before test)×100|(%) was evaluated using the following standards. The results are shown in the following table.

A: Percentage of change in absorbance ratio≦2%

B: 2%<Percentage of change in absorbance ratio≦4%

C: 4%<Percentage of change in absorbance ratio≦7%

D: 7%<Percentage of change in absorbance ratio

<<Evaluation of Heat Resistance 2>>

Heat resistance was evaluated in the same manner as in the evaluation of heat resistance 1 except for the fact that the heating temperature was changed from 200° C. to 245° C.

TABLE 23

| | | Near-infrared- | Evaluation of heat |
|---|---|---|---|
| | Composition used | shielding properties | resistance 1 |
| Example 1 | Composition 1 | B | B |
| Example 2 | Composition 2 | B | B |
| Example 3 | Composition 3 | A | A |
| Example 4 | Composition 4 | A | B |
| Example 5 | Composition 5 | A | B |
| Example 6 | Composition 6 | A | A |
| Example 7 | Composition 7 | A | B |
| Example 8 | Composition 8 | A | A |
| Example 9 | Composition 9 | A | A |
| Example 10 | Composition 10 | A | A |
| Example 11 | Composition 11 | A | A |
| Example 12 | Composition 12 | A | A |
| Example 13 | Composition 13 | A | A |
| Example 14 | Composition 14 | A | A |
| Example 15 | Composition 15 | A | A |
| Example 16 | Composition 16 | A | A |
| Example 17 | Composition 17 | A | A |
| Example 18 | Composition 18 | A | A |
| Example 19 | Composition 19 | A | A |
| Example 20 | Composition 20 | A | A |
| Example 33 | Composition 21 | A | A |
| Example 34 | Composition 22 | A | A |
| Example 35 | Composition 23 | A | A |

| | | Evaluation of heat |
|---|---|---|
| | Composition used | resistance 2 |
| Example 21 | Composition 9 | A |
| Example 22 | Composition 10 | A |
| Example 23 | Composition 11 | A |
| Example 24 | Composition 12 | A |
| Example 25 | Composition 13 | A |
| Example 26 | Composition 14 | A |
| Example 27 | Composition 15 | A |
| Example 28 | Composition 16 | A |
| Example 29 | Composition 17 | A |
| Example 30 | Composition 18 | A |
| Example 31 | Composition 19 | A |
| Example 32 | Composition 20 | A |

As is clear from Table 23, it was found that the near-infrared-absorbing composition of the present invention was capable of maintaining extremely high near-infrared-shielding properties when a cured film was produced. In addition, it was found that the near-infrared-absorbing composition of the present invention was also favorable in terms of heat resistance.

Particularly, it was found that, in a case in which a copper complex of an aromatic group-containing polymer was used as the near-infrared-absorbing compound (B: high-molecular-weight type), heat resistance was more favorable when a cured film was produced.

Even in a case in which a near-infrared cut filter was produced as described below using any one of the near-infrared-absorbing compositions 1 to 23, near-infrared cut filters can be similarly produced. A photoresist was applied onto a glass substrate, and a pattern was formed using lithography so as to form partition walls for the photoresist, thereby forming a dropwise addition region (2 cm×2 cm) for the near-infrared-absorbing composition. Each near-infrared-absorbing composition (200 μL) was added dropwise to the dropwise addition region, dried at 40° C. for one hour, and furthermore, the near-infrared-absorbing composition (200 μL) was added dropwise thereto, dried at 40° C. for one hour, and dried at 60° C. for one hour. After that, the near-infrared-absorbing composition was left to stand for 24 hours so as to be dried. The film thickness of the dried coated film was evaluated to be 200 μm. Meanwhile, even when the dropwise addition region was produced using Kapton tape as the partition wall, a near-infrared cut filter could be similarly produced.

In the near-infrared-absorbing composition 23 used in Example 35, even in a case in which propylene glycol monomethyl ether was changed to the equivalent amount of cyclopentanone, the same effects can be obtained.

In addition, even in a case in which filtration is carried out using a DFA4201NXEY (0.45 μm nylon filter) after the preparation of the near-infrared-absorbing compositions 1 to 23, the same effects can be obtained.

### EXPLANATION OF REFERENCES

1A, 1B: near-infrared-absorbing composition

2: copper ion

3: main chain having compound represented by Formula (II)

4: side chain having compound represented by Formula (II)

5: site at which copper is coordinated

6: monovalent group in compound represented by Formula (I)

7: monovalent group in compound represented by Formula (III)

8: site at which cross-linking group is crosslinked

10: silicon substrate

12: imaging element portion

13: interlayer insulating film

14: base layer

15: color filter

16: overcoat

17: micro lens

18: light shielding film

20: adhesive

22: insulating film

23: metallic electrode

24: solder resist layer

26: inner electrode

27: element surface electrode

30: glass substrate

40: imaging lens

42: near-infrared cut filter

44: light and electromagnetic shield

45: adhesive

46: flattening layer

50: lens holder

60: solder ball

70: circuit board

80: ultraviolet and infrared light-reflecting film

81: transparent base material

82: near-infrared-absorbing layer

83: antireflection layer

100: solid photographing element

What is claimed is:

1. A near-infrared-absorbing composition comprising:
a near-infrared-absorbing compound (A1) obtained from a reaction between a low-molecular-weight compound which has two or more coordination sites to a metal component or a coordination site to a metal component and a cross-linking group and has a molecular weight of 1800 or lower or a salt thereof and the metal component; and
a near-infrared-absorbing compound (B) obtained from a reaction between a high-molecular-weight compound having a repeating unit represented by Formula (II) below or a salt thereof and a metal component: 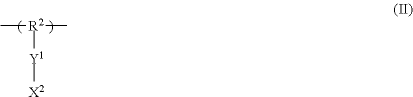
in Formula (II), R² represents an organic group, Y¹ represents a single bond or a divalent linking group, and X² represents the coordination site to the metal component.

2. A near-infrared-absorbing composition comprising:
a near-infrared-absorbing compound obtained from a reaction between a low-molecular-weight compound which has two or more coordination sites to a metal component or a coordination site to a metal component and a cross-linking group and has a molecular weight of 1800 or lower or a salt thereof, a high-molecular-weight compound having a repeating unit represented by Formula (II) below or a salt thereof, and a metal component: 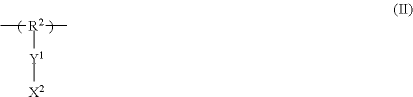
in Formula (II), R² represents an organic group, Y¹ represents a single bond or a divalent linking group, and X² represents the coordination site to the metal component.

3. The near-infrared-absorbing composition according to claim 1,
wherein the low-molecular-weight compound is a compound represented by Formula (I) below:
R¹(—X¹)ₙ₁ (I)
in Formula (I), R¹ represents an nl-valent group, X¹ represents the coordination site to the metal component, and n1 represents an integer from 2 to 6.

4. The near-infrared-absorbing composition according to claim 1,
wherein the low-molecular-weight compound is a compound represented by Formula (a1-i) below:
R¹⁰⁰-L¹⁰⁰-(X¹⁰⁰)ₙ (a1-i)
in Formula (a1-i), X¹⁰⁰ represents the coordination site to the metal component, n represents an integer from 1 to 6, L¹⁰⁰ represents a single bond or a linking group, and R¹⁰⁰ represents a cross-linking group.

5. The near-infrared-absorbing composition according to claim 1,
wherein a weight-average molecular weight of the high-molecular-weight compound having the repeating unit represented by Formula (II) or a salt thereof is in a range of 2,000 to 2,000,000.

6. A near-infrared-absorbing composition comprising:
a near-infrared-absorbing compound (A2) obtained from a reaction between a low-molecular-weight compound having a molecular weight of 1800 or lower which is represented by Formula (III) below or a salt thereof and a metal component:
R³(—X¹)ₙ₂ (III)
in Formula (III), R³ represents an n2-valent group, X¹ represents a coordination site to the metal component, and n2 represents an integer from 3 to 6.

7. The near-infrared-absorbing composition according to claim 1,
wherein the metal component is a copper component.

8. The near-infrared-absorbing composition according to claim 1,
wherein the coordination site to the metal component is an acid group.

9. The near-infrared-absorbing composition according to claim 1, comprising:
a near-infrared-absorbing compound (C) having a partial structure represented by Formula (IV) below: 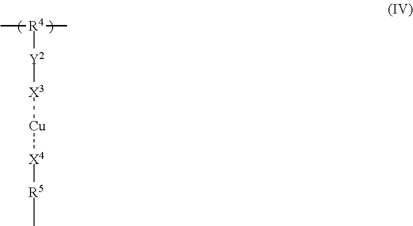
in Formula (IV), R⁴ represents an organic group, R⁵ represents a divalent group, Y² represents a single bond or a divalent linking group, each of X³ and X⁴ independently represents a site at which a coordinate bond is formed with copper, and Cu represents a copper ion.

10. The near-infrared-absorbing composition according to claim 9,
wherein the site at which a coordinate bond is formed with copper is an acid group ion site derived from an acid group.

11. The near-infrared-absorbing composition according to claim 1,
wherein a content of copper in the near-infrared-absorbing composition is in a range of 2% by mass to 50% by mass of a total amount of solid contents in the near-infrared-absorbing composition.

12. The near-infrared-absorbing composition according to claim 1, further comprising:
an organic solvent.

13. The near-infrared-absorbing composition according to claim 1, wherein the low-molecular-weight compound forms a structure which crosslinks side chains of the high-molecular-weight compound through a metal ion in the metal component.

14. The near-infrared-absorbing composition according to claim 1, wherein the mass ratio between the near-infrared-absorbing compound (A1) and the near-infrared-absorbing compound (B) is in a range of 3:97 to 70:30.

15. A near-infrared cut filter obtained using the near-infrared-absorbing composition according to claim 1.

16. The near-infrared cut filter according to claim 15,
wherein a percentage of a change in absorbance at a wavelength of 400 nm and a percentage of a change in absorbance at a wavelength of 800 nm before and after heating of the near-infrared cut filter at 200° C. for five minutes are both 7% or lower.

17. A process for producing a near-infrared cut filter, comprising:
forming a near-infrared cut filter by applying the near-infrared-absorbing composition according to claim 1 to a light-receiving side of a solid photographing element.

18. A solid photographing element comprising:
a near-infrared cut filter obtained using the near-infrared-absorbing composition according to claim 1.

19. A camera module comprising:
a solid photographing element; and
a near-infrared cut filter disposed on a light-receiving side of the solid photographing element, wherein the near-infrared cut filter according to claim 15 is used.

20. A process for producing a camera module including a solid photographing element and a near-infrared cut filter disposed on a light-receiving side of the solid photographing element, comprising:
forming a near-infrared cut filter by applying the near-infrared-absorbing composition according to claim 1 to the light-receiving side of the solid photographing element.
